(19) United States
(12) Patent Application Publication
(10) Pub. No.: US 2020/0216701 A1
(43) Pub. Date: Jul. 9, 2020

(54) INK SET, INK CARTRIDGE, INK JET PRINTER, AND INK JET RECORDING METHOD

(71) Applicant: FUJIFILM Corporation, Tokyo (JP)

(72) Inventors: Keiichi TATEISHI, Ashigarakami-gun (JP); Takashi SAITOU, Ashigarakami-gun (JP); Yusuke SAKAI, Ashigarakami-gun (JP); Yuta TAKASAKI, Ashigarakami-gun (JP)

(73) Assignee: FUJIFILM Corporation, Tokyo (JP)

(21) Appl. No.: 16/815,033

(22) Filed: Mar. 11, 2020

Related U.S. Application Data
(63) Continuation of application No. PCT/JP2018/035465, filed on Sep. 25, 2018.

(30) Foreign Application Priority Data
Sep. 29, 2017 (JP) 2017-191053
Feb. 23, 2018 (JP) 2018-031008

(51) Int. Cl. C09D 11/40; C09D 11/328; C09B 11/28; C09B 47/24; C09B 31/02; C09B 29/08; C09B 31/28; C09B 31/30; B41M 5/00

(52) U.S. Cl. CPC C09D 11/40; C09D 11/328; C09B 11/28; C09B 47/24; C08K 5/00; C09B 29/0803; C09B 31/28; C09B 31/30; B41M 5/0023; C09B 31/025

(57) ABSTRACT

An ink set includes a magenta ink composition; a cyan ink composition; a yellow ink composition; and a black ink composition, in which the magenta ink composition contains at least one compound represented by the general formula (1) as defined herein, the cyan ink composition contains at least one compound represented by the general formula (2) as defined herein, the yellow ink composition contains at least one compound selected from the group Y as defined herein, and the black ink composition contains at least one compound selected from the group BK as defined herein.

### CROSS REFERENCE TO RELATED APPLICATION

This is a continuation of International Application No. PCT/JP2018/035465 filed on Sep. 25, 2018, and claims priorities from Japanese Patent Application No. 2017-191053 filed on Sep. 29, 2017 and Japanese Patent Application No. 2018-031008 filed on Feb. 23, 2018, the entire disclosures of which are incorporated herein by reference.

### BACKGROUND OF THE INVENTION

### 1. Field of the Invention

The present invention relates to an ink set, an ink cartridge, an ink jet printer, and an ink jet recording method.

### 2. Description of the Related Art

In ink jet recording methods, one of three primary color inks, namely, magenta, cyan, and yellow inks is used, or three primary color inks are mixed with each other by changing the ratio of the amounts of the inks used to record a full-color image. Therefore, various performances of these inks need to be improved not only for single-color portions, but also for color mixture portions.

For example, JP2012-193311A discloses that the color development properties, gas resistance, and light resistance of a color mixture portion are improved by using specific color materials for magenta, cyan, and yellow inks.

### SUMMARY OF THE INVENTION

However, in recent years, higher-level performance has been required for images obtained by an ink jet recording method, and images having high light resistance, high ozone resistance, and high moisture resistance in color mixture portions and also having high contrast have been required.

That is, it is an object of the present invention to provide an ink set that includes a magenta ink composition, a cyan ink composition, a yellow ink composition, and a black ink composition, that achieves high optical density, reduced bronze luster, high ozone resistance, high light resistance, and high moisture resistance for single-color images, and that achieves high optical density, reduced bronze luster, high ozone resistance, high light resistance, high moisture resistance, and high contrast for mixed-color images, and an ink cartridge, an ink jet printer, and an ink jet recording method which use the ink set.

As a result of thorough studies, the present inventors have found that the above object can be achieved by using an ink set that includes a magenta ink composition, a cyan ink composition, a yellow ink composition, and a black ink composition each containing a compound having a specific structure.

A compound serving as a magenta dye and represented by general formula (1) exhibits high optical density derived from its xanthene skeleton. In particular, a certain number of sulfo groups and carboxy groups introduced to particular substitution positions in a xanthene dye molecule exhibit high light resistance, high ozone resistance, and high moisture resistance. In the related art, a typical magenta dye such as Acid Red 289 is generally used in combination to achieve high optical density, but the fastness is considerably poor. This loses the fading balance with yellow and cyan. In particular, the ozone resistance is low and the life of color images is dependent on magenta. Furthermore, such a magenta dye bleeds in a high-humidity environment.

A compound serving as a cyan dye and represented by general formula (2) exhibits high image fastness derived from its copper phthalocyanine skeleton and a functional group, but has a drawback of molecular design that facilitates high associativity of a copper phthalocyanine dye. That is, high optical density and high image fastness are in a trade-off relationship.

Furthermore, the choices of a yellow dye that imparts color balance with respect to the optical density (coloring power) and image fastness in single-color portions and color mixture portions (multicolor or full color), which is linked to achieving high image fastness of the magenta dye and the cyan dye, are also limited in reality in accordance with the attained level.

Furthermore, the black ink composition plays an important role from the viewpoint of achieving high contrast of an image. Therefore, the ink set needs to include a black ink composition.

By using the ink set according to an embodiment of the present invention, good balance of coloring power has been achieved in single-color portions and color mixture portions, and the light resistance, the ozone resistance, and the moisture resistance, in particular, the fading balance after exposure to highly oxidizing gas such as ozone gas have been highly improved in single-color portions and color mixture portions.

In the ink set according to an embodiment of the present invention, the above problems are believed to be solved because the yellow ink composition, the magenta ink composition, the cyan ink composition, and the black ink composition are each selected, the primary colors (single color: yellow, magenta, cyan) have a good balance, and a colorant on the longer wavelength side does not fade in an unbalanced manner (has a good balance) because of its filter effect (sacrifice) and the interaction (energy transfer) between colorants in formation of the secondary or tertiary color (mixed color: red, green, blue, black). Although the detailed mechanism is unclear, the above problems are believed to be solved by combining dyes used for the yellow ink composition, the magenta ink composition, the cyan ink composition, and the black ink composition in the ink set according to an embodiment of the present invention from the viewpoints of particular structure, physical properties, and controllability of interaction level.

That is, the above object has been achieved by the following means.

<1>

An ink set includes a magenta ink composition, a cyan ink composition, a yellow ink composition, and a black ink composition, wherein the magenta ink composition contains at least one compound represented by the following general formula (1), the cyan ink composition contains at least one compound represented by the following general formula (2), the yellow ink composition contains at least one compound selected from the following group Y, and the black ink composition contains at least one compound selected from the following group BK.

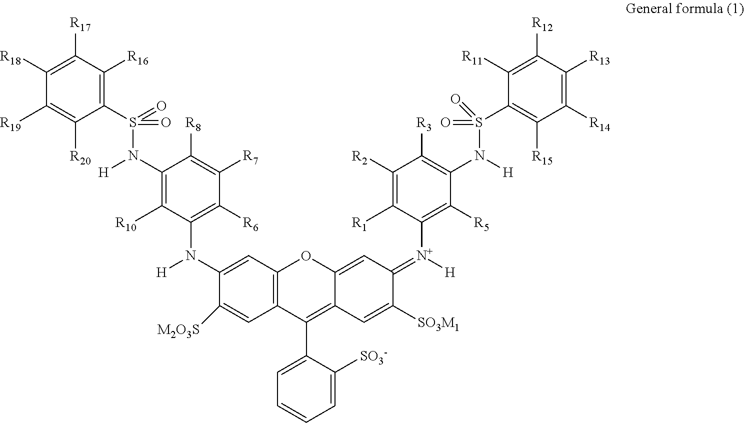

In the general formula (1), R₁, R₅, R₆, and R₁₀ each independently represent an alkyl group that may have a substituent, R₂, R₃, R₇, R₈, R₁₁, R₁₂, R₁₃, R₁₄, R₁₅, R₁₆, R₁₇, R₁₈, R₁₉, and R₂₀ each independently represent a hydrogen atom or a substituent, and M₁ and M₂ each independently represent a hydrogen atom, an alkali metal ion, or an ammonium ion.

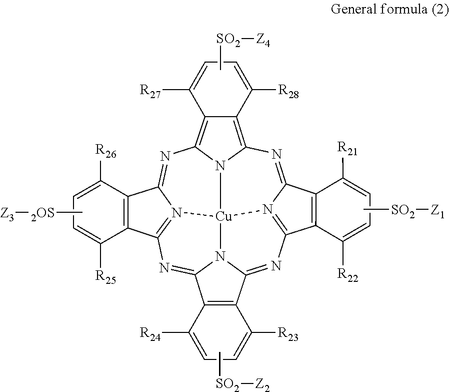

In the general formula (2), R₂₁, R₂₂, R₂₃, R₂₄, R₂₅, R₂₆, R₂₇, and R₂₈ each independently represent a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imide group, a heterocyclic thio group, a phosphoryl group, an acyl group, or an ionic hydrophilic group, which may further have a substituent, and Z₁, Z₂, Z₃, and Z₄ each independently represent a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group, where at least one of Z₁, Z₂, Z₃, or Z₄ has an ionic hydrophilic group as a substituent.

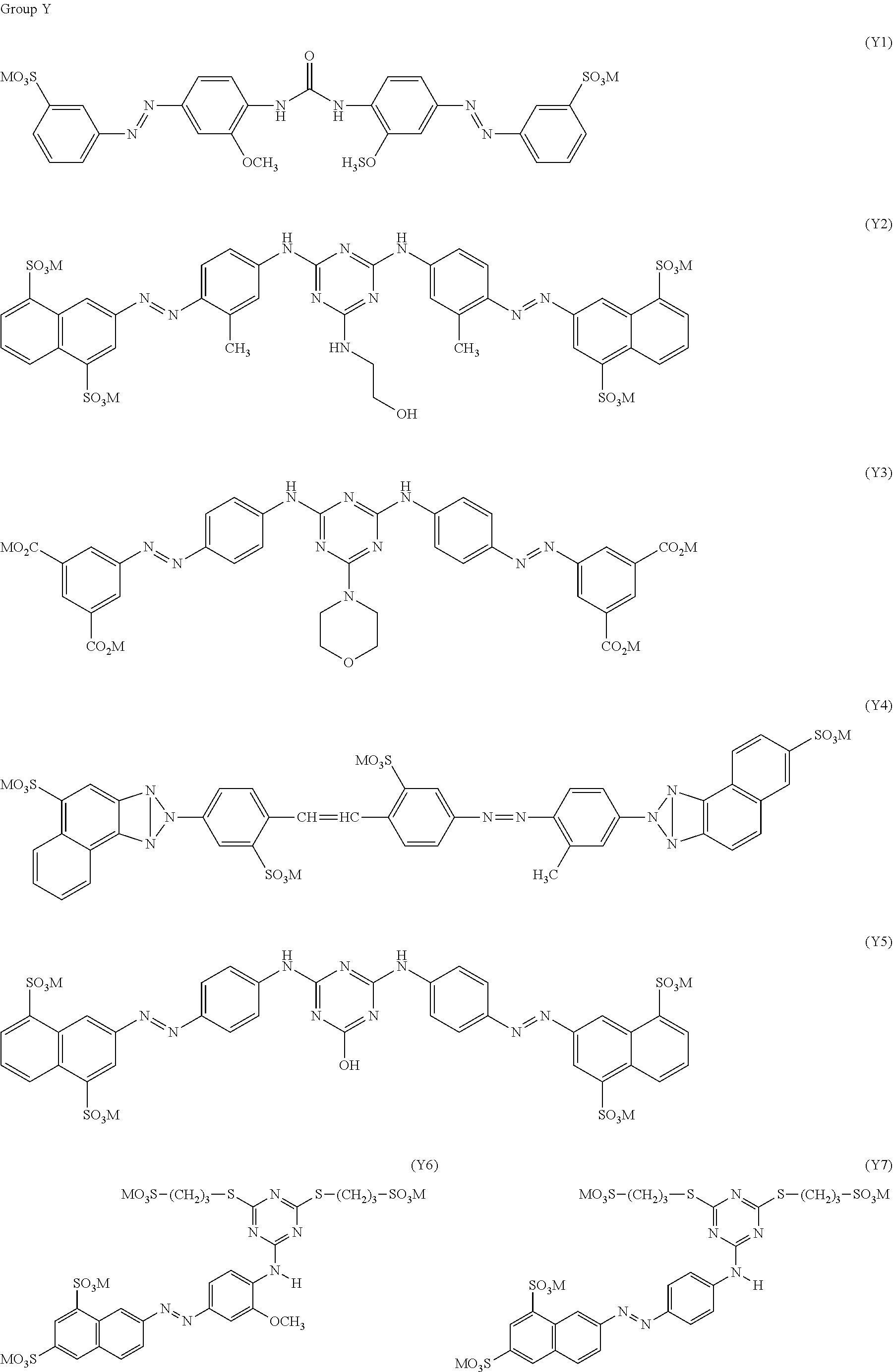

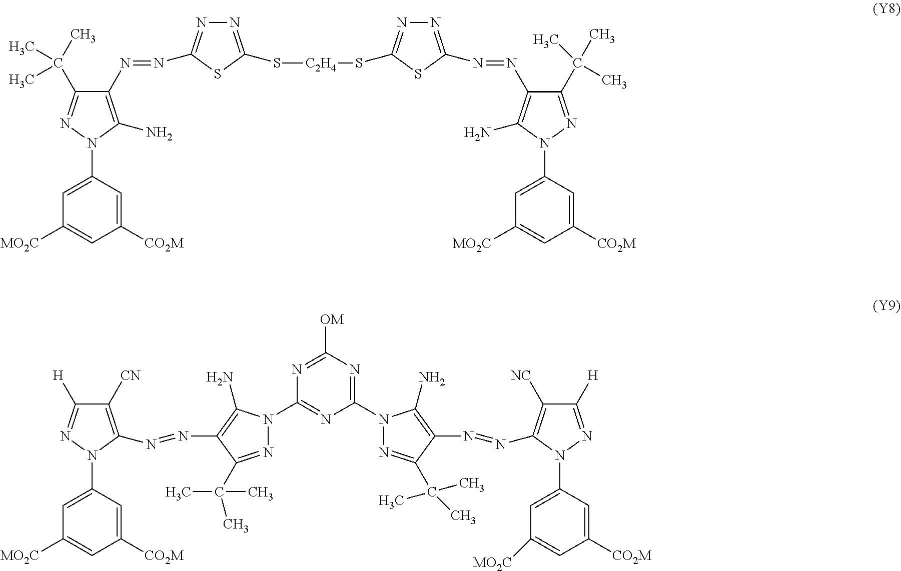

In the general formulae (Y1) to (Y9), each M independently represents a hydrogen atom, a lithium ion, a sodium ion, a potassium ion, or an ammonium ion.

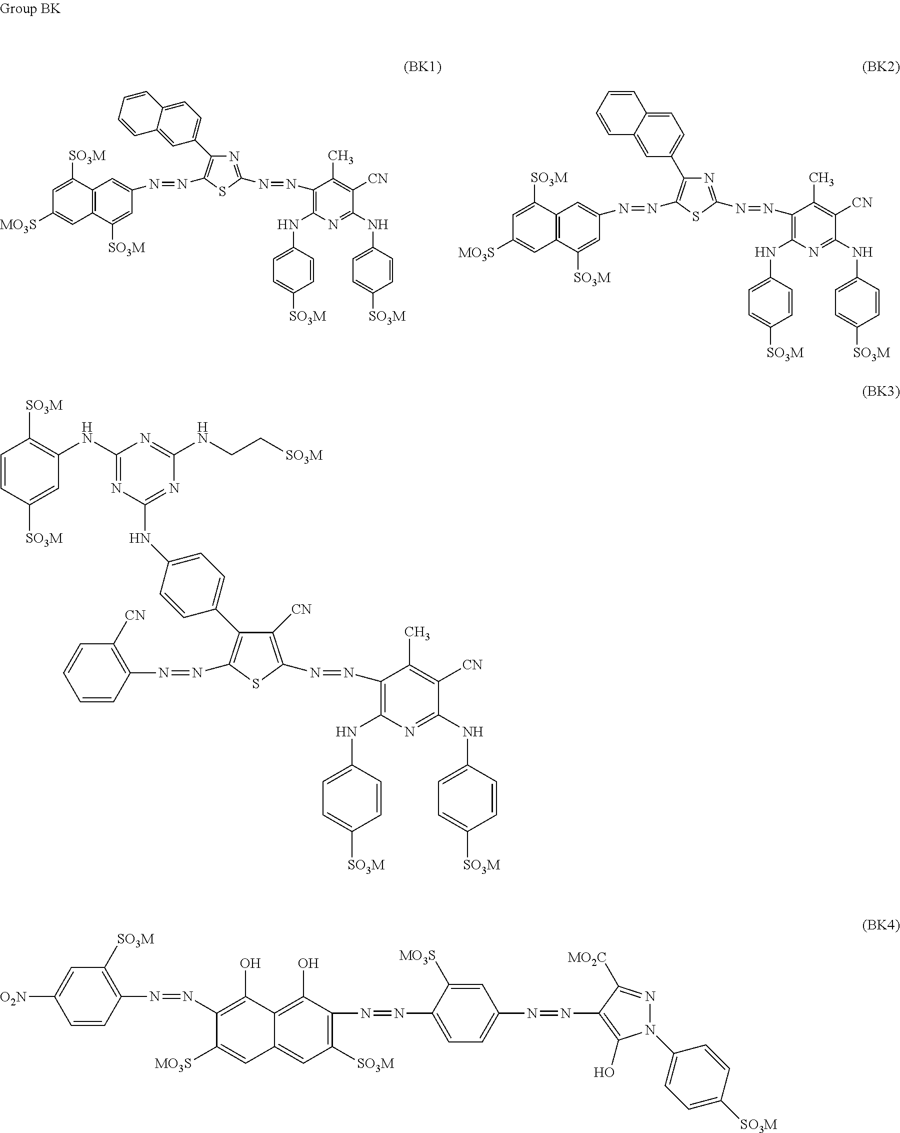

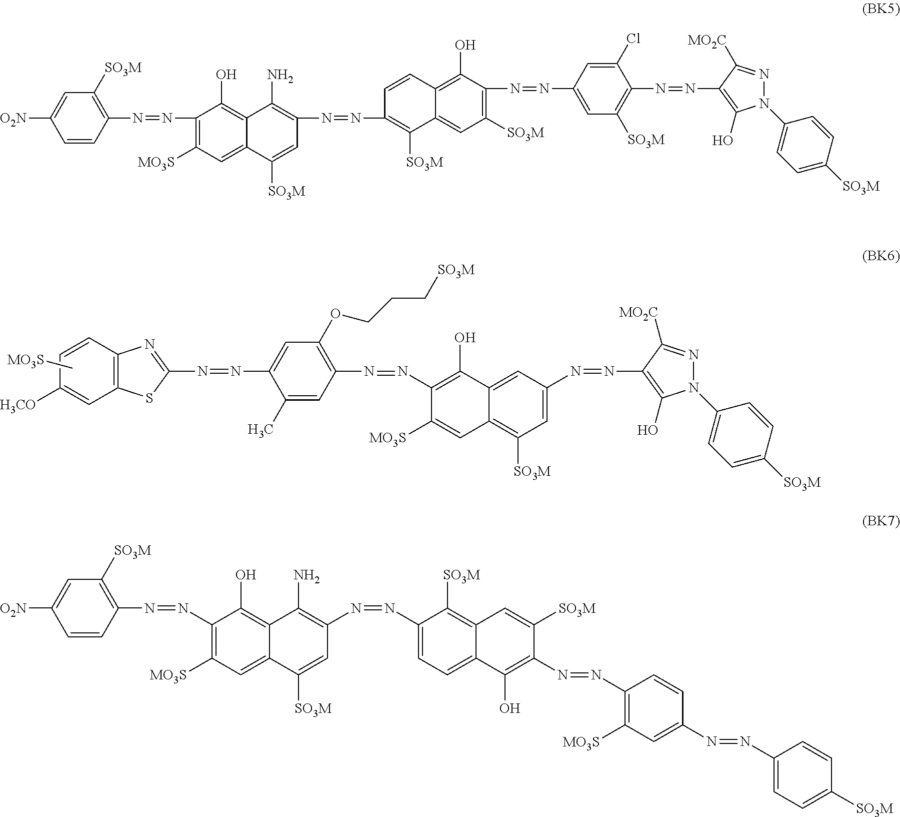

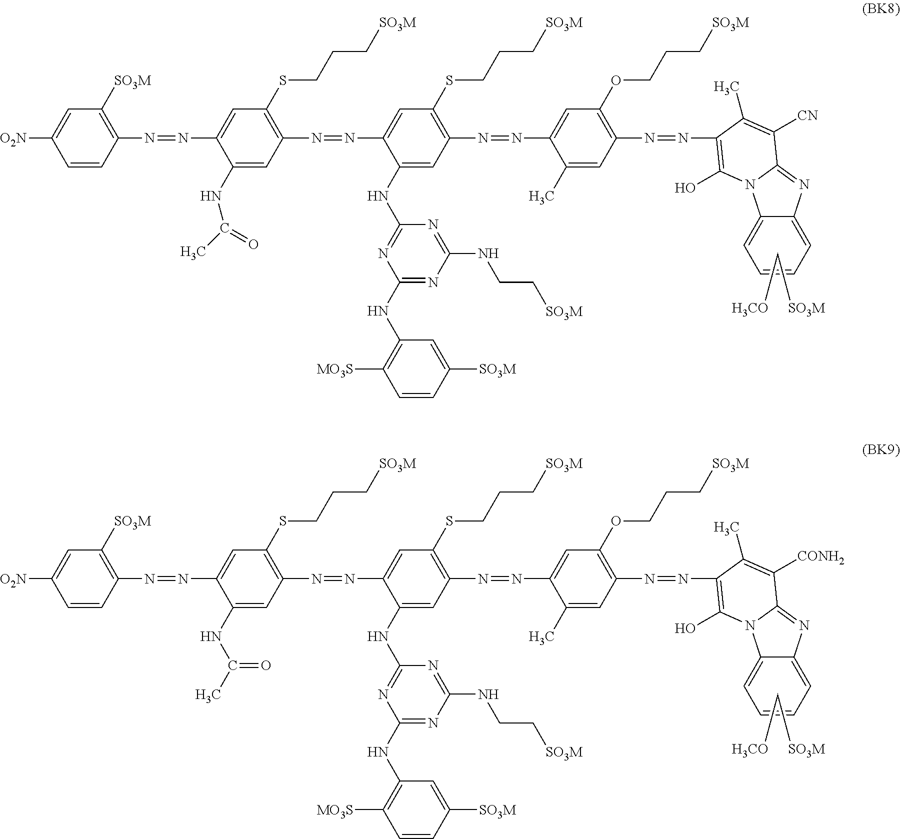

In the general formulae (BK1) to (BK9), each M independently represents a hydrogen atom, a lithium ion, a sodium ion, a potassium ion, or an ammonium ion.

<2>

In the ink set according to <1>, a total content of all colorants in the magenta ink composition is 2.3 mass % or more and 4.0 mass % or less with respect to a total mass of the magenta ink composition.

<3>

In the ink set according to <1> or <2>, a total content of all colorants in the cyan ink composition is 3.5 mass % or more and 5.5 mass % or less with respect to a total mass of the cyan ink composition.

<4>

In the ink set according to any one of <1> to <3>, a total content of all colorants in the yellow ink composition is 2.5 mass % or more and 4.5 mass % or less with respect to a total mass of the yellow ink composition.

<5>

In the ink set according to any one of <1> to <4>, a total content of all colorants in the black ink composition is 4.0 mass % or more and 6.0 mass % or less with respect to a total mass of the black ink composition.

<6>

In the ink set according to any one of <1> to <5>, a total content of all colorants in the magenta ink composition is 3.0 mass % or more and 4.0 mass % or less with respect to a total mass of the magenta ink composition.

<7>

An ink cartridge includes the ink set according to any one of <1> to <6>.

<8>

An ink jet printer includes the ink cartridge according to <7>.

<9>

An ink jet recording method includes performing recording by using the ink set according to any one of <1> to <6> or the ink cartridge according to <7>.

The present invention can provide an ink set that includes a magenta ink composition, a cyan ink composition, a yellow ink composition, and a black ink composition, that achieves high optical density, reduced bronze luster, high ozone resistance, high light resistance, and high moisture resistance for single-color images, and that achieves high optical density, reduced bronze luster, high ozone resistance, high light resistance, high moisture resistance, and high contrast for mixed-color images, and an ink cartridge, an ink jet printer, and an ink jet recording method which use the ink set.

### DESCRIPTION OF THE PREFERRED EMBODIMENTS

Hereafter, the present invention will be further described in detail based on preferred embodiments.

First, the specific examples of substituents in the present invention are defined as a substituent group A.

### Substituent Group A

Examples of the substituents include halogen atoms, alkyl groups, cycloalkyl groups, aralkyl groups, alkenyl groups, alkynyl groups, aryl groups, heterocyclic groups, cyano groups, hydroxy groups, nitro groups, alkoxy groups, aryloxy groups, silyloxy groups, heterocyclic oxy groups, acyloxy groups, carbamoyloxy groups, alkoxycarbonyloxy groups, aryloxycarbonyloxy groups, amino groups, acylamino groups, aminocarbonylamino groups, alkoxycarbonylamino groups, aryloxycarbonylamino groups, sulfamoylamino groups, alkylsulfonylamino groups, arylsulfonylamino groups, mercapto groups, alkylthio groups, arylthio groups, heterocyclic thio groups, sulfamoyl groups, alkyl sulfinyl groups, arylsulfinyl groups, alkyl sulfonyl groups, arylsulfonyl groups, acyl groups, aryloxycarbonyl groups, alkoxycarbonyl groups, carbamoyl groups, arylazo groups, heterocyclic azo groups, imide groups, phosphino groups, phosphinyl groups, phosphinyloxy groups, phosphinylamino groups, silyl groups, and ionic hydrophilic groups. These substituents may be further substituted. Such an additional substituent may be a group selected from the substituent group A described above.

Examples of the halogen atoms include a fluorine atom, a chlorine atom, a bromine atom, and an iodine atom.

The alkyl group is a linear or branched substituted or unsubstituted alkyl group. The same concept also applies to an alkyl group in substituents described below (e.g., an alkyl group in alkoxy groups or alkylthio groups).

The alkyl group is preferably an alkyl group having 1 to 30 carbon atoms, such as a methyl group, an ethyl group, a n-propyl group, an i-propyl group, a t-butyl group, a n-octyl group, an eicosyl group, a 2-chloroethyl group, a 2-cyanoethyl group, or a 2-ethylhexyl group.

The cycloalkyl group is a substituted or unsubstituted cycloalkyl group and preferably a substituted or unsubstituted cycloalkyl group having 3 to 30 carbon atoms, such as a cyclohexyl group, a cyclopentyl group, or a 4-n-dodecylcyclohexyl group. The bicycloalkyl group is preferably a substituted or unsubstituted bicycloalkyl group having 5 to 30 carbon atoms, that is, a monovalent group obtained by removing one hydrogen atom from a bicycloalkane having 5 to 30 carbon atoms, such as a bicyclo[1,2,2]heptan-2-yl group or a bicyclo[2,2,2]octan-3-yl group.

The aralkyl group is a substituted or unsubstituted aralkyl group. The substituted or unsubstituted aralkyl group is preferably an aralkyl group having 7 to 30 carbon atoms, such as a benzyl group or a 2-phenethyl group.

The alkenyl group is a linear, branched, or cyclic substituted or unsubstituted alkenyl group, which includes cycloalkenyl groups and bicycloalkenyl groups.

The alkenyl group is preferably a substituted or unsubstituted alkenyl group having 2 to 30 carbon atoms, such as a vinyl group, an allyl group, a prenyl group, a geranyl group, or an oleyl group. The cycloalkenyl group is preferably a substituted or unsubstituted cycloalkenyl group having 3 to 30 carbon atoms, that is, a monovalent group obtained by removing one hydrogen atom from a cycloalkene having 3 to 30 carbon atoms, such as a 2-cyclopenten-1-yl group or a 2-cyclohexen-1-yl group. The bicycloalkenyl group is a substituted or unsubstituted bicycloalkenyl group and is preferably a substituted or unsubstituted bicycloalkenyl group having 5 to 30 carbon atoms, that is, a monovalent group obtained by removing one hydrogen atom of a bicycloalkene having one double bond, such as a bicyclo[2,2,1]hept-2-en-1-yl group or a bicyclo[2,2,2]oct-2-en-4-yl group.

The alkynyl group is preferably a substituted or unsubstituted alkynyl group having 2 to 30 carbon atoms, such as an ethynyl group, a propargyl group, or a trimethylsilylethynyl group.

The aryl group is preferably a substituted or unsubstituted aryl group having 6 to 30 carbon atoms, such as a phenyl group, a p-tolyl group, a naphthyl group, a m-chlorophenyl group, or an o-hexadecanoylaminophenyl group.

The heterocyclic group is preferably a monovalent group obtained by removing one hydrogen atom from a five- or six-membered substituted or unsubstituted aromatic or non-aromatic heterocyclic compound and more preferably a five- or six-membered aromatic heterocyclic group having 3 to 30 carbon atoms, such as a 2-furyl group, a 2-thienyl group, a 2-pyrimidinyl group, or a 2-benzothiazolyl group. An example of the non-aromatic heterocyclic group is a morpholinyl group.

The alkoxy group is preferably a substituted or unsubstituted alkoxy group having 1 to 30 carbon atoms, such as a methoxy group, an ethoxy group, an isopropoxy group, a t-butoxy group, a n-octyloxy group, or a 2-methoxyethoxy group.

The aryloxy group is preferably a substituted or unsubstituted aryloxy group having 6 to 30 carbon atoms, such as a phenoxy group, a 2-methylphenoxy group, a 4-t-butylphenoxy group, a 3-nitrophenoxy group, or a 2-tetradecanoylaminophenoxy group.

The silyloxy group is preferably a substituted or unsubstituted silyloxy group having 0 to 20 carbon atoms, such as a trimethylsilyloxy group or a diphenylmethylsilyloxy group.

The heterocyclic oxy group is preferably a substituted or unsubstituted heterocyclic oxy group having 2 to 30 carbon atoms, such as a 1-phenyltetrazole-5-oxy group or a 2-tetrahydropyranyloxy group.

The acyloxy group is preferably a formyloxy group, a substituted or unsubstituted alkylcarbonyloxy group having 2 to 30 carbon atoms, or a substituted or unsubstituted arylcarbonyloxy group having 6 to 30 carbon atoms, such as an acetyloxy group, a pivaloyloxy group, a stearoyloxy group, a benzoyloxy group, or a p-methoxyphenylcarbonyloxy group.

The carbamoyloxy group is preferably a substituted or unsubstituted carbamoyloxy group having 1 to 30 carbon atoms, such as an N,N-dimethylcarbamoyloxy group, an N,N-diethylcarbamoyloxy group, a morpholinocarbonyloxy group, an N,N-di-n-octylaminocarbonyloxy group, or an N-n-octylcarbamoyloxy group.

The alkoxycarbonyloxy group is preferably a substituted or unsubstituted alkoxycarbonyloxy group having 2 to 30 carbon atoms, such as a methoxycarbonyloxy group, an ethoxycarbonyloxy group, a t-butoxycarbonyloxy group, or a n-octylcarbonyloxy group.

The aryloxycarbonyloxy group is preferably a substituted or unsubstituted aryloxycarbonyloxy group having 7 to 30 carbon atoms, such as a phenoxycarbonyloxy group, a p-methoxyphenoxycarbonyloxy group, or a p-n-hexadecyloxyphenoxycarbonyloxy group.

The amino group includes an alkylamino group, an arylamino group, and a heterocyclic amino group. The amino group is preferably an amino group, a substituted or unsubstituted alkylamino group having 1 to 30 carbon atoms, or a substituted or unsubstituted anilino group having 6 to 30 carbon atoms, such as a methylamino group, a dimethylamino group, an anilino group, an N-methyl-anilino group, a diphenylamino group, or a triazinylamino group.

The acylamino group is preferably a formylamino group, a substituted or unsubstituted alkylcarbonylamino group having 1 to 30 carbon atoms, or a substituted or unsubstituted arylcarbonylamino group having 6 to 30 carbon atoms, such as an acetylamino group, a pivaloylamino group, a lauroylamino group, a benzoylamino group, or a 3,4,5-tri-n-octyloxyphenylcarbonylamino group.

The aminocarbonylamino group is preferably a substituted or unsubstituted aminocarbonylamino group having 1 to 30 carbon atoms, such as a carbamoylamino group, an N,N-dimethylaminocarbonylamino group, an N,N-diethylaminocarbonylamino group, or a morpholinocarbonylamino group.

The alkoxycarbonylamino group is preferably a substituted or unsubstituted alkoxycarbonylamino group having 2 to 30 carbon atoms, such as a methoxycarbonylamino group, an ethoxycarbonylamino group, a t-butoxycarbonylamino group, a n-octadecyloxycarbonylamino group, or an N-methyl-methoxycarbonylamino group.

The aryloxycarbonylamino group is preferably a substituted or unsubstituted aryloxycarbonylamino group having 7 to 30 carbon atoms, such as a phenoxycarbonylamino group, a p-chlorophenoxycarbonylamino group, or a m-n-octyloxyphenoxycarbonylamino group.

The sulfamoylamino group is preferably a substituted or unsubstituted sulfamoylamino group having 0 to 30 carbon atoms, such as a sulfamoylamino group, an N,N-dimethylaminosulfonylamino group, or an N-n-octylaminosulfonylamino group.

The alkylsulfonylamino group or the arylsulfonylamino group is preferably a substituted or unsubstituted alkylsulfonylamino group having 1 to 30 carbon atoms or a substituted or unsubstituted arylsulfonylamino group having 6 to 30 carbon atoms, such as a methylsulfonylamino group, a butylsulfonylamino group, a phenylsulfonylamino group, a 2,3,5-trichlorophenylsulfonylamino group, or a p-methylphenylsulfonylamino group.

The alkylthio group is preferably a substituted or unsubstituted alkylthio group having 1 to 30 carbon atoms, such as a methylthio group, an ethylthio group, or a n-hexadecylthio group.

The arylthio group is preferably a substituted or unsubstituted arylthio group having 6 to 30 carbon atoms, such as a phenylthio group, a p-chlorophenylthio group, or a m-methoxyphenylthio group.

The heterocyclic thio group is preferably a substituted or unsubstituted heterocyclic thio group having 2 to 30 carbon atoms, such as a 2-benzothiazolylthio group or a 1-phenyltetrazol-5-ylthio group.

The sulfamoyl group is preferably a substituted or unsubstituted sulfamoyl group having 0 to 30 carbon atoms, such as an N-ethylsulfamoyl group, an N-(3-dodecyloxypropyl)sulfamoyl group, an N,N-dimethylsulfamoyl group, an N-acetylsulfamoyl group, an N-benzoylsulfamoyl group, or an N—(N′-phenylcarbamoyl)sulfamoyl group.

The alkylsulfinyl group or the arylsulfinyl group is preferably a substituted or unsubstituted alkylsulfinyl group having 1 to 30 carbon atoms or a substituted or unsubstituted arylsulfinyl group having 6 to 30 carbon atoms, such as a methylsulfinyl group, an ethylsulfinyl group, a phenylsulfinyl group, or a p-methylphenylsulfinyl group.

The alkylsulfonyl group or the arylsulfonyl group is preferably a substituted or unsubstituted alkylsulfonyl group having 1 to 30 carbon atoms or a substituted or unsubstituted arylsulfonyl group having 6 to 30 carbon atoms, such as a methylsulfonyl group, an ethylsulfonyl group, a phenylsulfonyl group, or a p-methylphenylsulfonyl group.

The acyl group is preferably a formyl group, a substituted or unsubstituted alkylcarbonyl group having 2 to 30 carbon atoms, a substituted or unsubstituted arylcarbonyl group having 7 to 30 carbon atoms, or a substituted or unsubstituted heterocyclic carbonyl group having 2 to 30 carbon atoms and having a carbon atom bonded to a carbonyl group, such as an acetyl group, a pivaloyl group, a 2-chloroacetyl group, a stearoyl group, a benzoyl group, a p-n-octyloxyphenylcarbonyl group, a 2-pyridylcarbonyl group, or a 2-furylcarbonyl group.

The aryloxycarbonyl group is preferably a substituted or unsubstituted aryloxycarbonyl group having 7 to 30 carbon atoms, such as a phenoxycarbonyl group, an o-chlorophenoxycarbonyl group, a m-nitrophenoxycarbonyl group, or a p-t-butylphenoxycarbonyl group.

The alkoxycarbonyl group is preferably a substituted or unsubstituted alkoxycarbonyl group having 2 to 30 carbon atoms, such as a methoxycarbonyl group, an ethoxycarbonyl group, a t-butoxycarbonyl group, or a n-octadecyloxycarbonyl group.

The carbamoyl group is preferably a substituted or unsubstituted carbamoyl group having 1 to 30 carbon atoms, such as a carbamoyl group, an N-methylcarbamoyl group, an N,N-dimethylcarbamoyl group, an N,N-di-n-octylcarbamoyl group, or an N-(methylsulfonyl)carbamoyl group.

The arylazo group or the heterocyclic azo group is preferably a substituted or unsubstituted arylazo group having 6 to 30 carbon atoms or a substituted or unsubstituted heterocyclic azo group having 3 to 30 carbon atoms, such as a phenylazo group, a p-chlorophenylazo group, or a 5-ethylthio-1,3,4-thiadiazol-2-ylazo group.

The imide group is preferably an N-succinimide group or an N-phthalimide group.

The phosphino group is preferably a substituted or unsubstituted phosphino group having 0 to 30 carbon atoms, such as a dimethylphosphino group, a diphenylphosphino group, or a methylphenoxyphosphino group.

The phosphinyl group is preferably a substituted or unsubstituted phosphinyl group having 0 to 30 carbon atoms, such as a phosphinyl group, a dioctyloxyphosphinyl group, or a diethoxyphosphinyl group.

The phosphinyloxy group is preferably a substituted or unsubstituted phosphinyloxy group having 0 to 30 carbon atoms, such as a diphenoxyphosphinyloxy group or a dioctyloxyphosphinyloxy group.

The phosphinylamino group is preferably a substituted or unsubstituted phosphinylamino group having 0 to 30 carbon atoms, such as a dimethoxyphosphinylamino group or a dimethylaminophosphinylamino group.

The silyl group is preferably a substituted or unsubstituted silyl group having 0 to 30 carbon atoms, such as a trimethylsilyl group, a t-butyldimethylsilyl group, or a phenyldimethylsilyl group.

The ionic hydrophilic group is, for example, a sulfo group, a carboxy group, a thiocarboxy group, a sulfino group, a phosphono group, a dihydroxyphosphino group, or a quaternary ammonium group and is particularly preferably a sulfo group or a carboxy group. The ionic hydrophilic group may include a cation or an anion. The state in which the ionic hydrophilic group includes a cation or an anion is referred to as a salt state. The carboxy group, the phosphono group, and the sulfo group may be in a salt state. Examples of the countercation for forming a salt include ammonium ions, alkali metal ions (e.g., a lithium ion, a sodium ion, and a potassium ion), and organic cations (e.g., a tetramethylammonium ion, a tetramethylguanidinium ion, and a tetramethylphosphonium). The salt is preferably a lithium salt, a sodium salt, a potassium salt, or an ammonium salt and particularly preferably a lithium salt or a sodium salt.

In the present invention, when the compound is a salt, the salt is dissociated in a water-soluble ink and is present in the form of ions.

### Ink Set

An ink set according to an embodiment of the present invention is an ink set including a magenta ink composition, a cyan ink composition, a yellow ink composition, and a black ink composition. The magenta ink composition contains at least one compound represented by general formula (1). The cyan ink composition contains at least one compound represented by general formula (2). The yellow ink composition contains at least one compound selected from the group Y. The black ink composition contains at least one compound selected from the group BK.

Hereafter, each ink composition constituting the ink set according to an embodiment of the present invention will be described.

### Magenta Ink Composition

The magenta ink composition constituting the ink set according to an embodiment of the present invention contains a compound represented by general formula (1) below. The compound represented by the general formula (1) below is a colorant and can be used as a magenta dye.

### Compound Represented by General Formula (1)

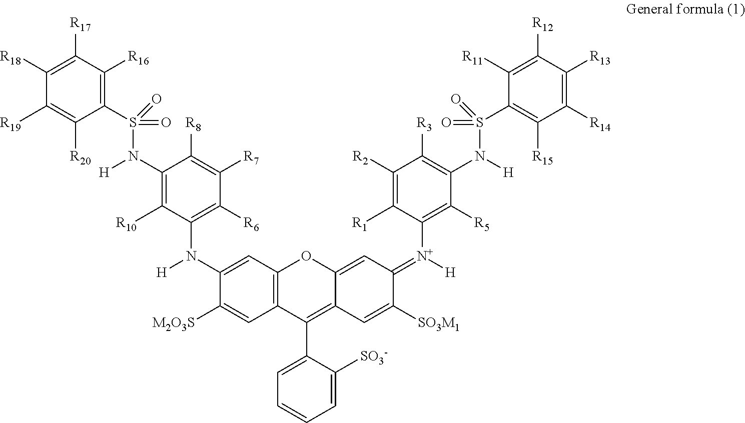

In the general formula (i), R₁, R₅, R₆, and R₁₀ each independently represent an alkyl group that may have a substituent. R₂, R₃, R₇, R₈, R₁₁, R₁₂, R₁₃, R₁₄, R₁₅, R₁₆, R₁₇, R₁₈, R₁₉, and R₂₀ each independently represent a hydrogen atom or a substituent. M₁ and M₂ each independently represent a hydrogen atom, an alkali metal ion, or an ammonium ion.

R₁, R₅, R₆, and R₁₀ in the general formula (1) each independently represent an alkyl group. From the viewpoints of availability of raw materials and ease of synthesis, the alkyl group is preferably an alkyl group having 1 to 6 carbon atoms, more preferably an alkyl group having 1 to 3 carbon atoms, further preferably a methyl group, an ethyl group, or an isopropyl group, and particularly preferably a methyl group.

The alkyl group represented by R₁, R₅, R₆, and R₁₀ may have a substituent. The substituent can be selected from the substituent group A.

When R₃ and R₈ in the general formula (1) represent a substituent, the substituent is selected from the substituent group A and is preferably an alkyl group. When R₃ and R₈ represent an alkyl group, the alkyl group is more preferably an alkyl group having 1 to 3 carbon atoms, further preferably a methyl group, an ethyl group, or an isopropyl group, and most preferably a methyl group from the viewpoints of availability of raw materials and ease of synthesis. R₃ and R₈ preferably represent a hydrogen atom or an alkyl group and more preferably an alkyl group.

When R₂ and R₇ in the general formula (1) represent a substituent, the substituent is selected from the substituent group A and is preferably an alkyl group.

R₂ and R₇ in the general formula (1) preferably each independently represent a hydrogen atom or an alkyl group, and more preferably each independently represent a hydrogen atom from the viewpoints of availability of raw materials and ease of synthesis.

When R₂, R₃, R₇, and R₈ in the general formula (1) represent an alkyl group, the alkyl group may have a substituent. The substituent is selected from the substituent group A.

R₁₁, R₁₂, R₁₃, R₁₄, R₁₅, R₁₆, R₁₇, R₁₈, R₁₉, and R₂₀ in the general formula (1) each independently represent a hydrogen atom or a substituent. The substituent is selected from the substituent group A.

R₁₁ and R₁₆ preferably each independently represent a hydrogen atom, a hydroxy group, a chlorine atom, or a methyl group, more preferably a hydrogen atom, a hydroxy group, or a methyl group, further preferably a hydrogen atom or a hydroxy group, particularly preferably a hydroxy group.

R₁₂, R₁₄, R₁₇, and R₁₉ preferably each independently represent a hydrogen atom or an ionic hydrophilic group, more preferably a hydrogen atom, a carboxy group, or a sulfo group, further preferably a hydrogen atom or a carboxy group, particularly preferably a carboxy group.

R₁₃ and R₁₈ preferably each independently represent a hydrogen atom or an ionic hydrophilic group, more preferably a hydrogen atom or a carboxy group, further preferably a hydrogen atom. In particular, both of R₁₃ and R₁₈ preferably represent a hydrogen atom.

The compound represented by the general formula (1) preferably satisfies at least one of conditions (i-1) and (i-2) below and more preferably satisfies both conditions (i-1) and (i-2) below.

Condition (i-1): At least one of R₁₁, R₁₂, R₁₃, R₁₄, or R₁₅ represents a carboxy group.

Condition (i-2): At least one of R₁₆, R₁₇, R₁₈, R₁₉, or R₂₀ represents a carboxy group.

The compound represented by the general formula (1) preferably satisfies at least one of conditions (ii-1) and (ii-2) and more preferably satisfies both conditions (ii-1) and (ii-2).

Condition (ii-1): At least one of R₁₁, R₁₂, R₁₃, R₁₄, or R₁₅ represents a hydroxy group and at least one of them represents a carboxy group.

Condition (ii-2): At least one of R₁₆, R₁₇, R₁₈, R₁₉, or R₂₀ represents a hydroxy group and at least one of them represents a carboxy group.

In the case where the condition (i-1) or (ii-1) is satisfied, two of R₁₁, R₁₂, R₁₃, R₁₄, and R₁₅ particularly preferably represent a carboxy group.

In the case where the condition (i-2) or (ii-2) is satisfied, two of R₁₆, R₁₇, R₁₈, R₁₉, and R₂₀ particularly preferably represent a carboxy group.

In particular, most preferably, R₁₁ represents a hydroxy group, R₁₂ and R₁₄ represent a carboxy group, R₁₃ and R₁₅ represent a hydrogen atom, R₁₆ represents a hydroxy group, R₁₇ and R₁₉ represent a carboxy group, and Rig and R₂₀ represent a hydrogen atom.

M₁ and M₂ in the general formula (1) each independently represent a hydrogen atom, an alkali metal ion, or an ammonium ion, preferably a hydrogen atom, a lithium ion (Li⁺), a sodium ion (Na⁺), a potassium ion (K⁺), or an ammonium ion (NH₄⁺), more preferably a lithium ion or a sodium ion, particularly preferably a sodium ion or a mixed ion mainly constituted by a sodium ion, most preferably a sodium ion.

The compound represented by the general formula (1) is preferably a compound represented by general formula (1A) below.

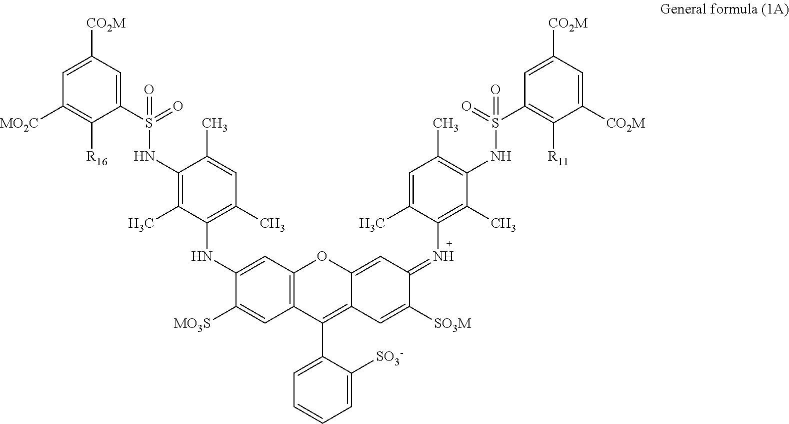

In the general formula (1A), R₁₁ and R₁₆ each independently represent a hydrogen atom, a halogen atom, a hydroxy group, or a methyl group. M represents a hydrogen atom, a lithium ion, a sodium ion, a potassium ion, or an ammonium ion.

When R₁₁ and R₁₆ in the general formula (1A) represent a halogen atom, the halogen atom is a fluorine atom, a chlorine atom, a bromine atom, or an iodine atom. In particular, the halogen atom is preferably a chlorine atom or a bromine atom and most preferably a chlorine atom.

R₁₁ and R₁₆ in the general formula (1A) preferably represent a hydrogen atom, a chlorine atom, a hydroxy group, or a methyl group, more preferably a hydrogen atom or a hydroxy group, most preferably a hydroxy group.

In the general formula (1A), M represents a hydrogen atom, a lithium ion, a sodium ion, a potassium ion, or an ammonium ion.

M preferably represents an alkali metal cation (a lithium ion, a sodium ion, or a potassium ion), particularly preferably a lithium ion or a sodium ion, most preferably a sodium ion.

The compound represented by the general formula (1) can be synthesized by a publicly known method (e.g., a method disclosed in WO2017/006939A).

Hereafter, the compound represented by the general formula (1) is specifically listed below, but is not limited thereto. Me represents a methyl group and Et represents an ethyl group.

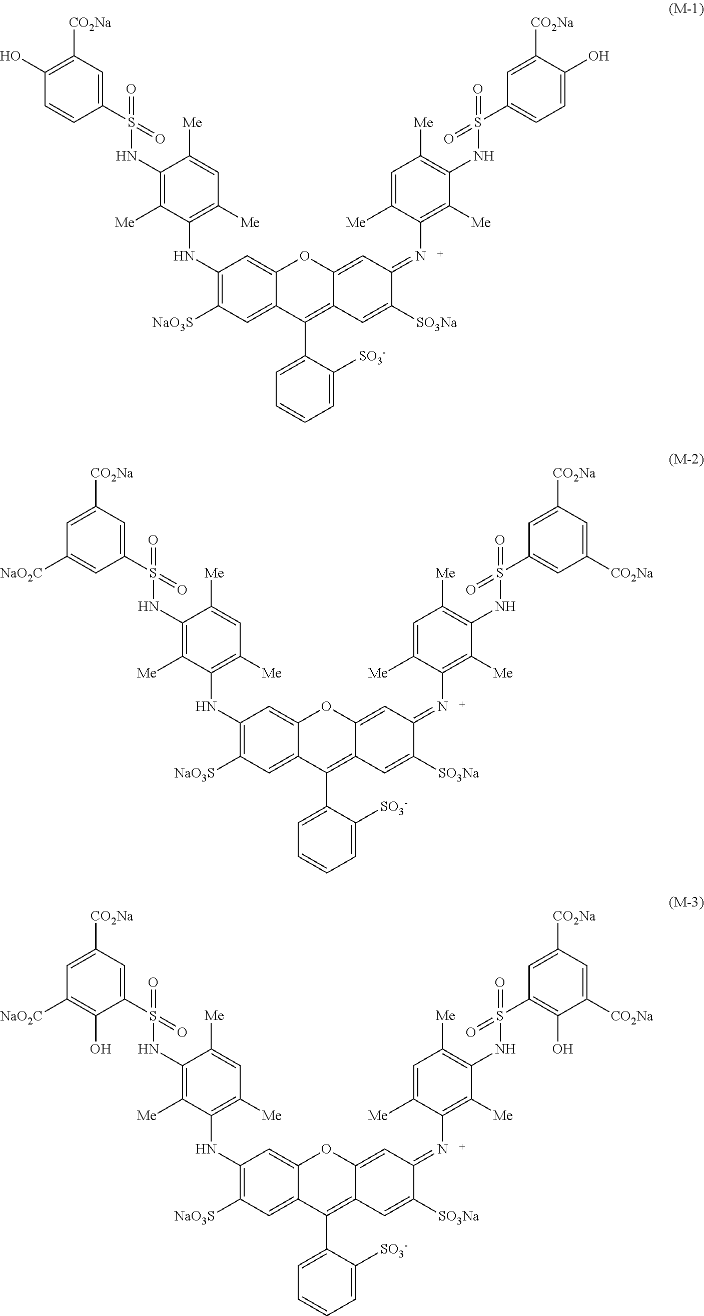

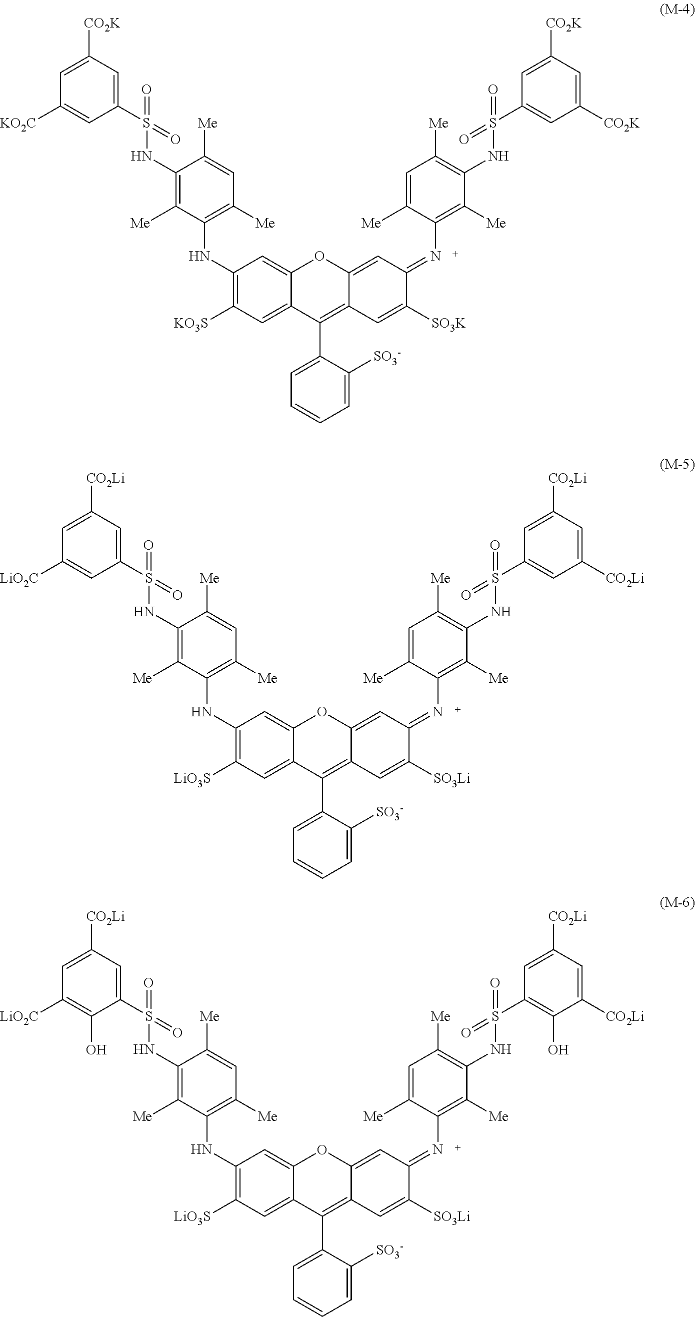

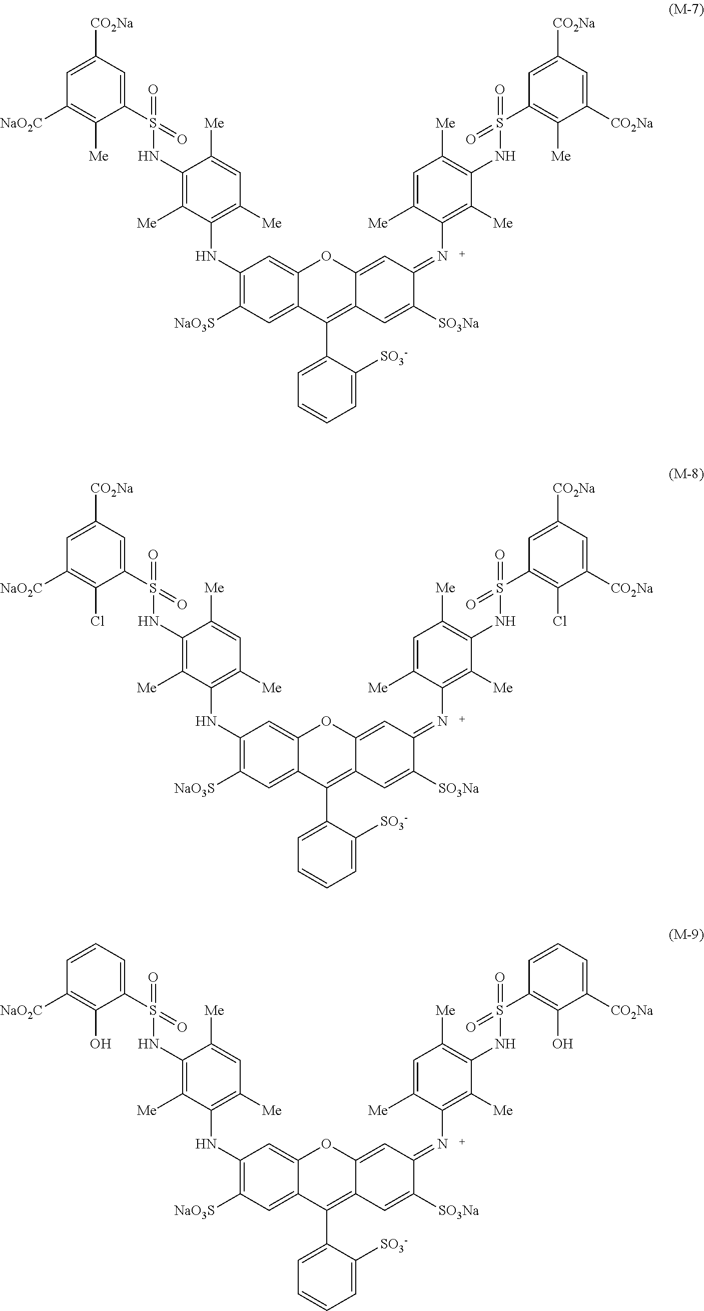

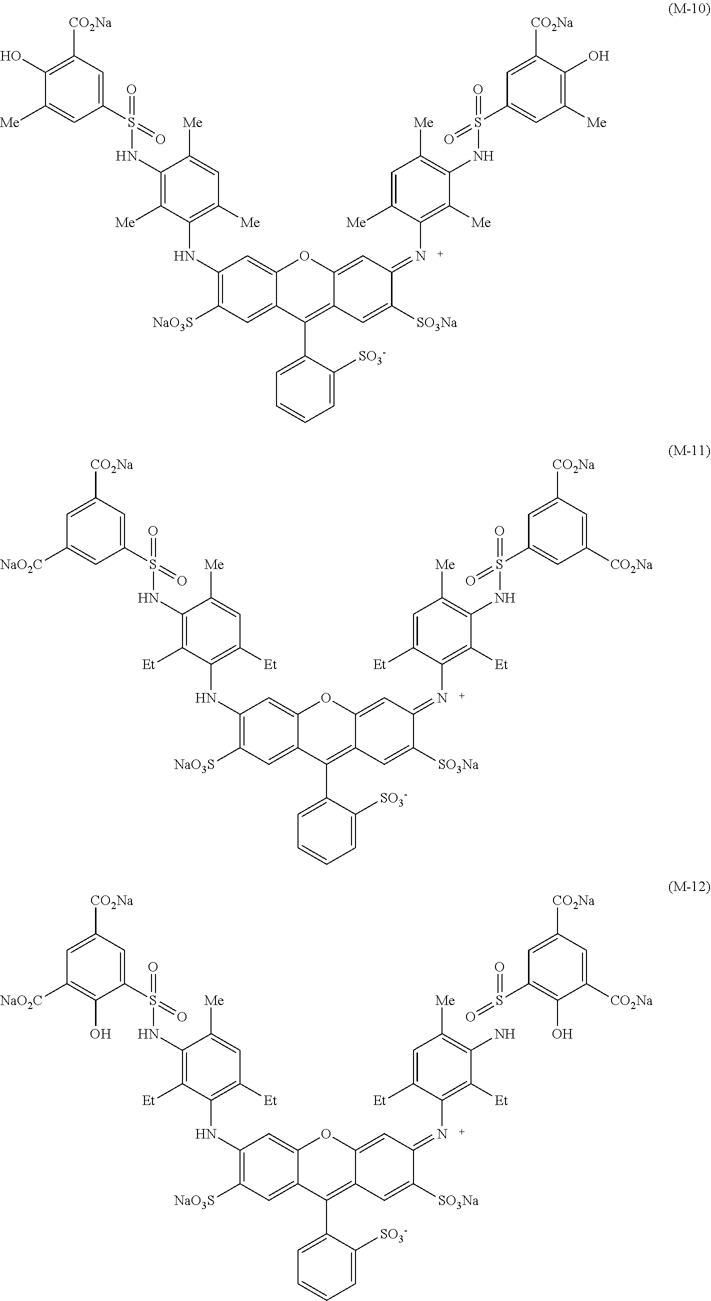

The magenta ink composition may further contain, in addition to the compound represented by the general formula (1), a colorant other than the compound represented by the general formula (1) as long as the advantageous effects of the present invention are not impaired.

The specific examples of the colorant other than the compound represented by the general formula (1) are listed below, but the colorant is not limited thereto.

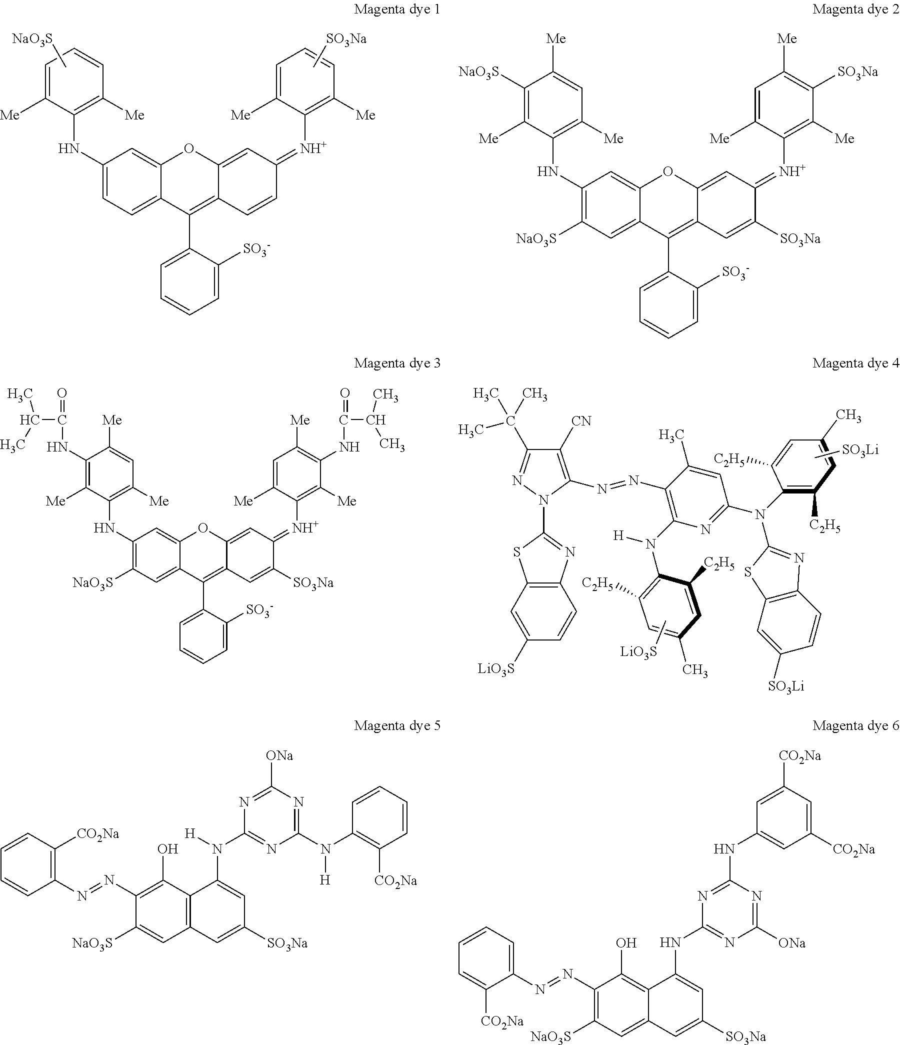

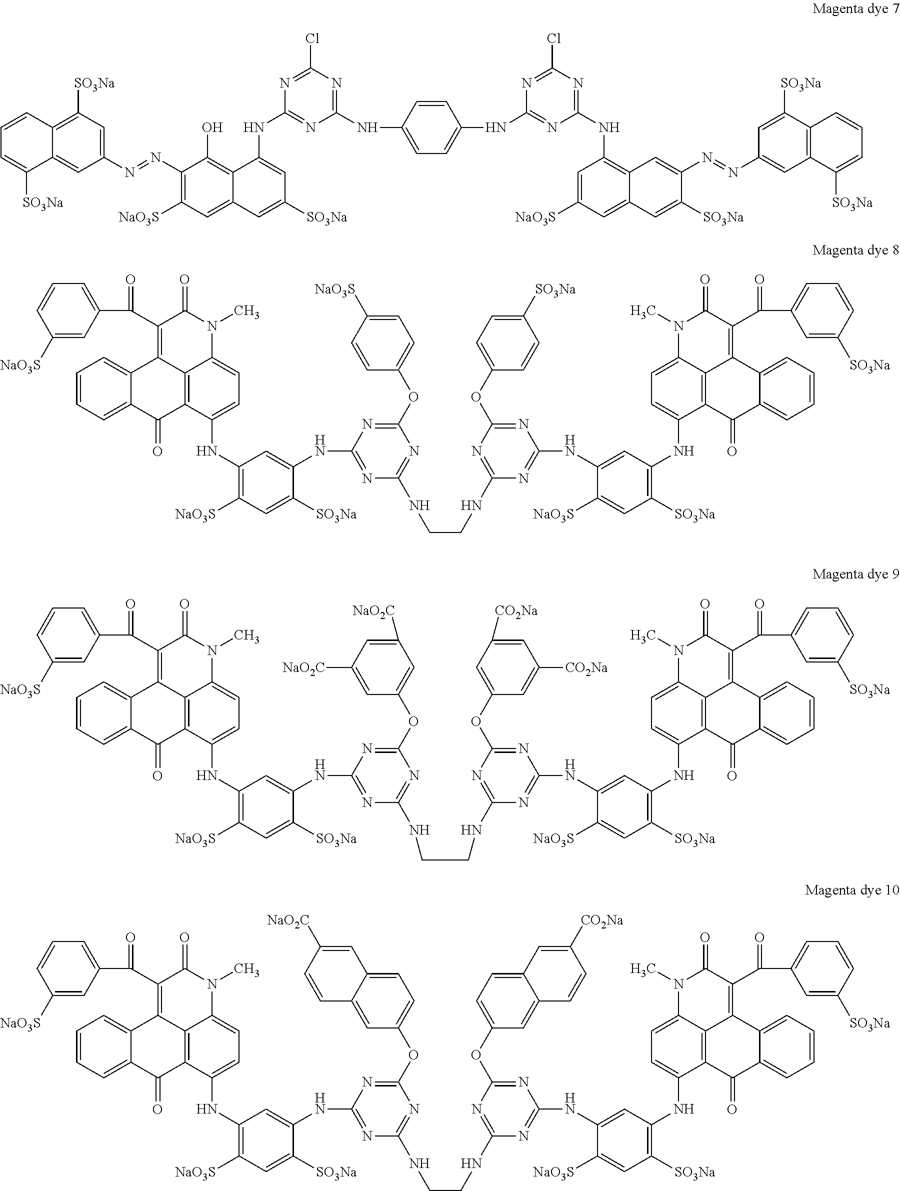

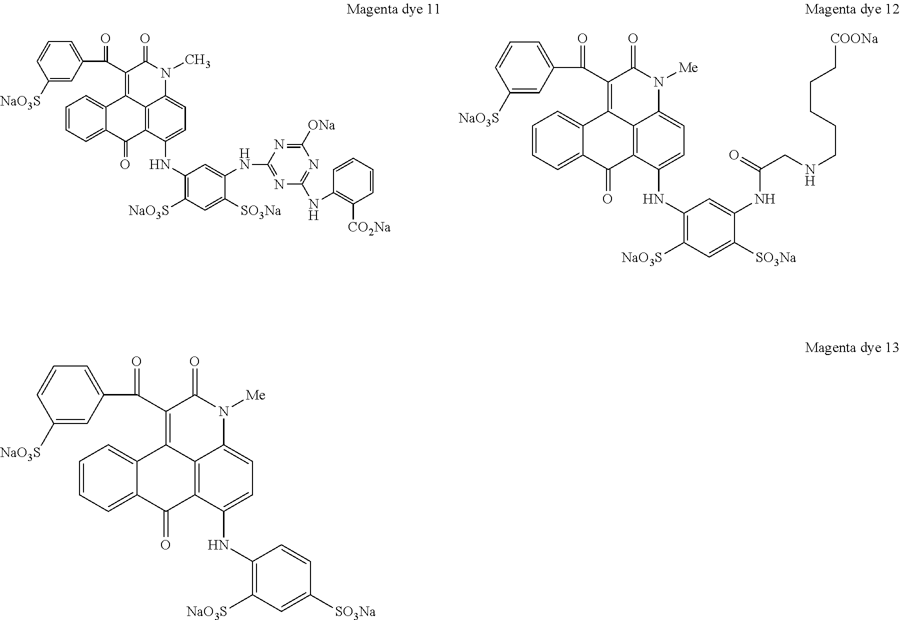

The content (mass %) of the compound represented by the general formula (1) in the magenta ink composition is preferably 1.0 mass % or more and 10.0 mass % or less, more preferably 1.0 mass % or more and 5.0 mass % or less, and further preferably 2.0 mass % or more and 4.0 mass % or less with respect to the total mass of the magenta ink composition.

When the magenta ink composition further contains, in addition to the compound represented by the general formula (1), a colorant other than the compound represented by the general formula (1), the total content (mass %) of all colorants in the magenta ink composition is preferably 1.0 mass % or more and 10.0 mass % or less, more preferably 1.0 mass % or more and 5.0 mass % or less, further preferably 2.0 mass % or more and 4.0 mass % or less, particularly preferably 2.3 mass % or more and 4.0 mass % or less, and most preferably 3.0 mass % or more and 4.0 mass % or less with respect to the total mass of the magenta ink composition.

### Cyan Ink Composition

The cyan ink composition constituting the ink set according to an embodiment of the present invention contains a compound represented by general formula (2) below. The compound represented by the general formula (2) below is a colorant and can be used as a cyan dye.

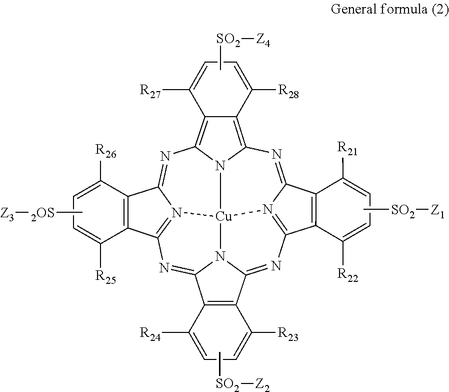

In the general formula (2), R₂₁, R₂₂, R₂₃, R₂₄, R₂₅, R₂₆, R₂₇, and R₂₈ each independently represent a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imide group, a heterocyclic thio group, a phosphoryl group, an acyl group, or an ionic hydrophilic group. These groups may further have a substituent. Z₁, Z₂, Z₃, and Z₄ each independently represent a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group. Note that at least one of Z₁, Z₂, Z₃, or Z₄ has an ionic hydrophilic group as a substituent.

The compound represented by the general formula (2) is a phthalocyanine dye in which substituted sulfonyl groups (—SO₂—Z₁, —SO₂—Z₂, —SO₂—Z₃, and —SO₂—Z₄) are introduced to β positions. In other words, —SO₂—Z₁, —SO₂—Z₂, —SO₂—Z₃, and —SO₂—Z₄ in the general formula (2) are substituted with hydrogen atoms at β positions and are not substituted with hydrogen atoms or substituents R₂₁, R₂₂, R₂₃, R₂₄, R₂₅, R₂₆, R₂₇, and R₂₈ at α positions.

The α positions and β positions in the phthalocyanine skeleton are illustrated in formula (a) below.

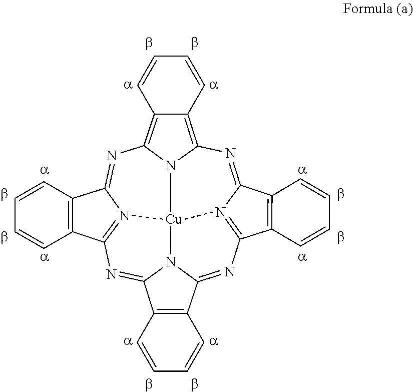

When R₂₁, R₂₂, R₂₃, R₂₄, R₂₅, R₂₆, R₂₇, and R₂₈ in the general formula (2) further have a substituent, the substituent is selected from the substituent group A.

In the general formula (2), R₂₁, R₂₂, R₂₃, R₂₄, R₂₅, R₂₆, R₂₇, and R₂₈ preferably each independently represent a hydrogen atom, a halogen atom, an alkyl group, an aryl group, a heterocyclic group, or an ionic hydrophilic group, more preferably a hydrogen atom, a halogen atom, an alkyl group, or an ionic hydrophilic group, further preferably a hydrogen atom, a halogen atom, an alkyl group, or an ionic hydrophilic group, most preferably a hydrogen atom.

In the general formula (2), Z₁, Z₂, Z₃, and Z₄ preferably each independently represent a substituted or unsubstituted alkyl group, a substituted or unsubstituted aryl group, or a substituted or unsubstituted heterocyclic group, more preferably a substituted or unsubstituted alkyl group or a substituted or unsubstituted aryl group, further preferably a substituted or unsubstituted alkyl group, most preferably a substituted alkyl group (an alkyl group having a substituent).

When the groups represented by Z₁, Z₂, Z₃, and Z₄ have a substituent, the substituent is selected from the substituent group A. The substituent is preferably a halogen atom, a hydroxy group, a substituted or unsubstituted alkoxy group, a substituted or unsubstituted aryloxy group, a substituted or unsubstituted amino group, a substituted or unsubstituted sulfamoyl group, an alkylsulfonyl group, an arylsulfonyl group, a substituted or unsubstituted carbamoyl group, or an ionic hydrophilic group, more preferably a hydroxy group, a substituted or unsubstituted amino group, a substituted or unsubstituted sulfamoyl group, an alkylsulfonyl group, an arylsulfonyl group, a substituted or unsubstituted carbamoyl group, or an ionic hydrophilic group, further preferably a substituted or unsubstituted sulfamoyl group, a substituted or unsubstituted carbamoyl group, or an ionic hydrophilic group, and particularly preferably a substituted or unsubstituted sulfamoyl group or an ionic hydrophilic group (in particular, a salt of a sulfo group or a carboxy group is preferred).

Preferred examples of Z₁, Z₂, Z₃, and Z₄ include —(CH₂)₃—SO₃M, —(CH₂)₅—SO₃M, —(CH₂)₃—CO₂M, —(CH₂)₅—CO₂M, —(CH₂)₃—SO₂NHCH₂CH(OH)CH₃, —(CH₂)₃—SO₂NHCH₂CH(OH)CH₂SO₃M, —(CH₂)₃—CONHCH₂CH(OH)CH₃, and —(CH₂)₃—CONHCH₂CH(OH)CH₂CH₂SO₃M. M represents a countercation for a salt of an ionic hydrophilic group (preferably a sulfo group or a carboxy group) and preferably represents an alkali metal ion (a lithium ion, a sodium ion, or a potassium ion) or an ammonium ion, more preferably a lithium ion, a sodium ion, or a potassium ion, particularly preferably a lithium ion or a sodium ion, most preferably a lithium ion.

At least one of Z₁, Z₂, Z₃, or Z₄ has an ionic hydrophilic group as a substituent.

The compound represented by the general formula (2) can be synthesized by a publicly known method (e.g., methods described in Examples of JP3949385B and JP4145153B).

Hereafter, the compound represented by the general formula (2) is specifically listed, but is not limited thereto. In the following structural formulae of specific compounds, each specific compound is a mixture of positional isomers (refer to (2A) to (2D) below) that vary depending on introduction positions (β positions) of particular substituents (R). Therefore, the introduction positions of substituents are not specified and are treated as the same positions. In the specific examples below, a substituted sulfonyl group is substituted with a hydrogen atom at any β position and is not substituted at positions “H” in each structural formula.

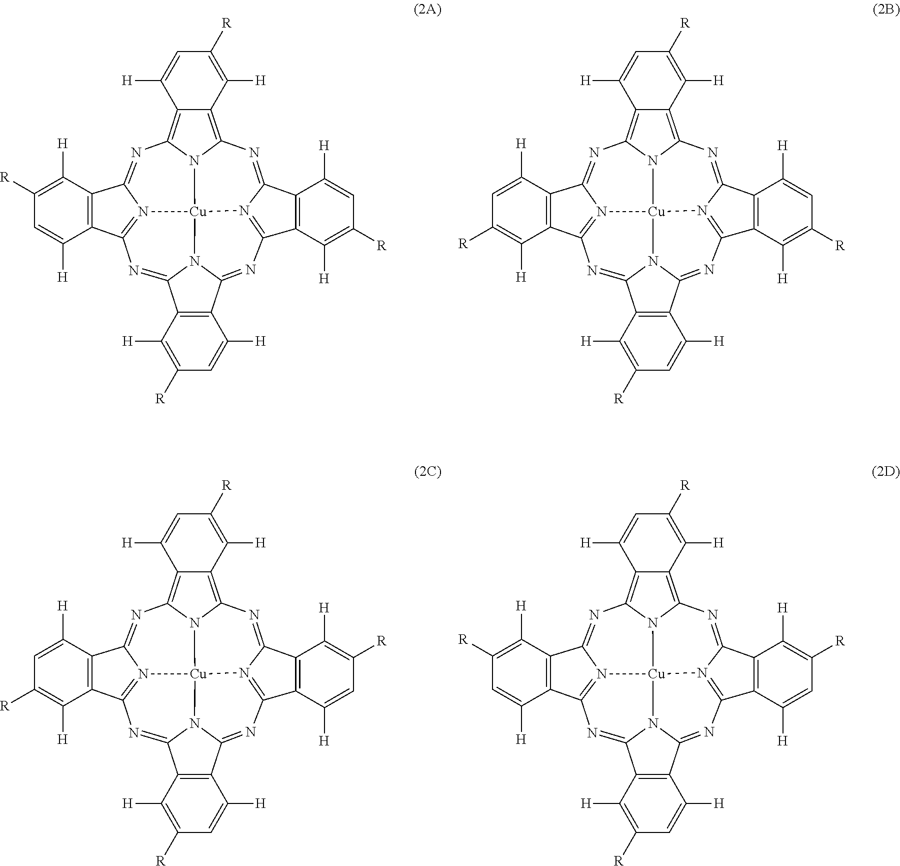

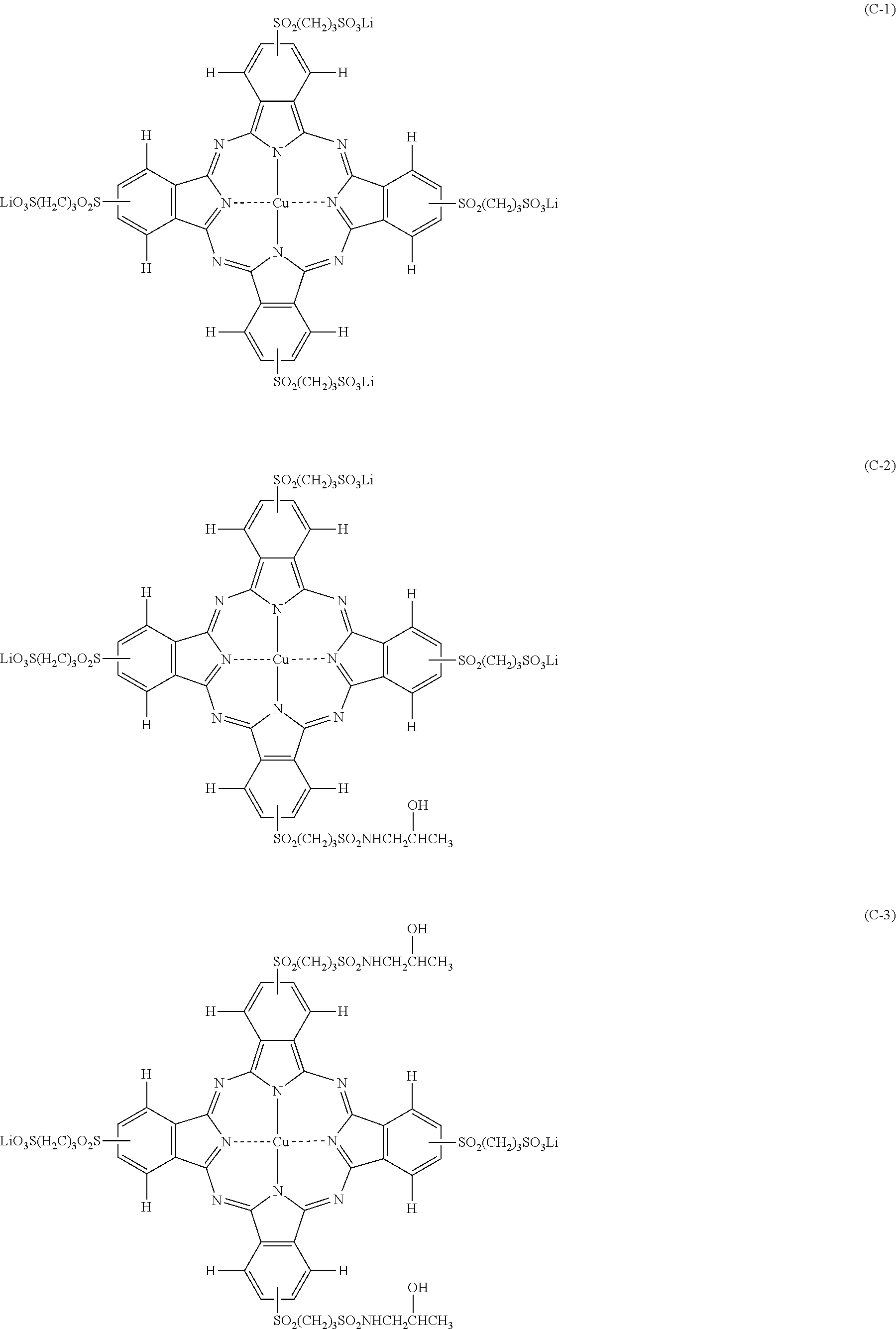

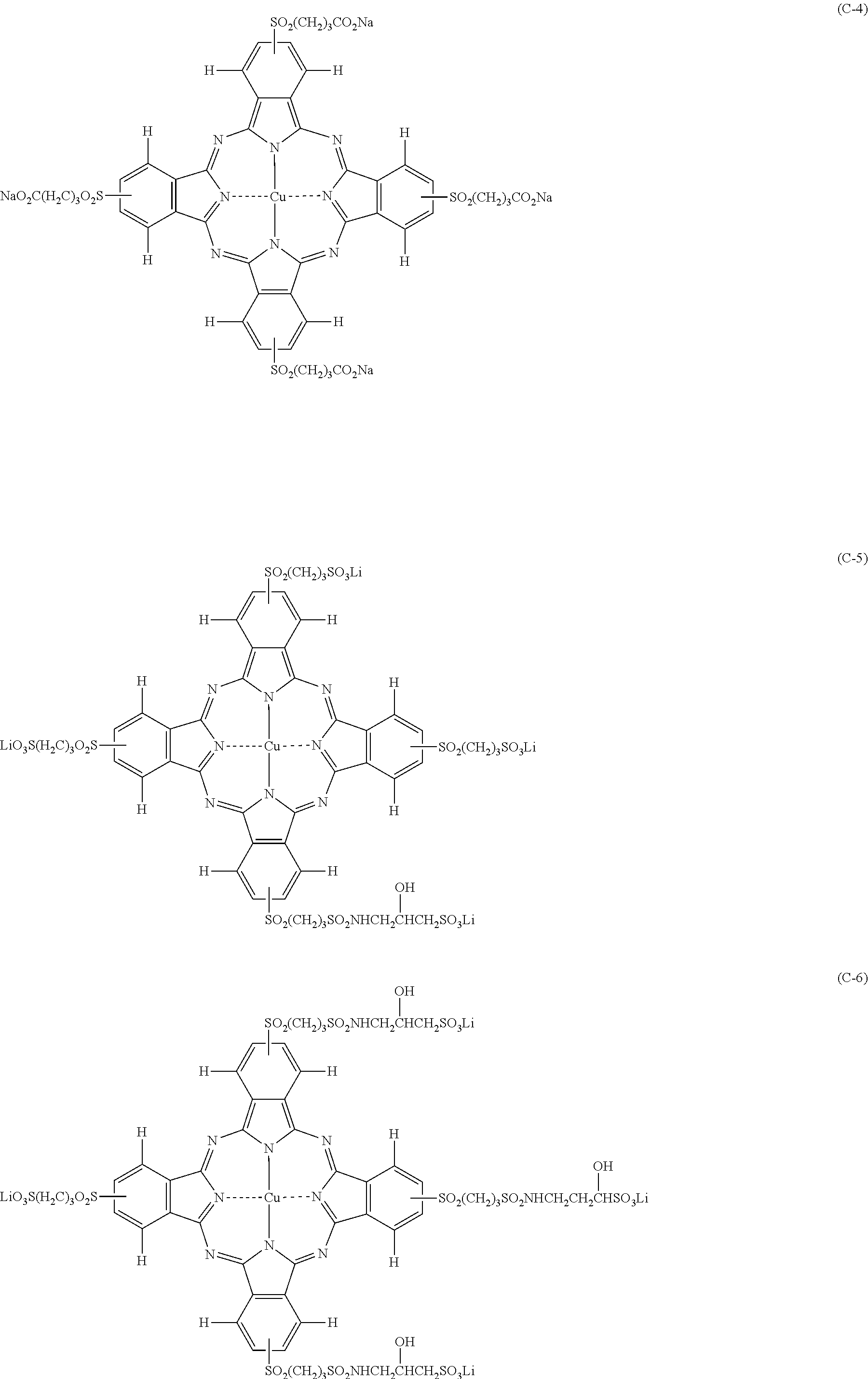

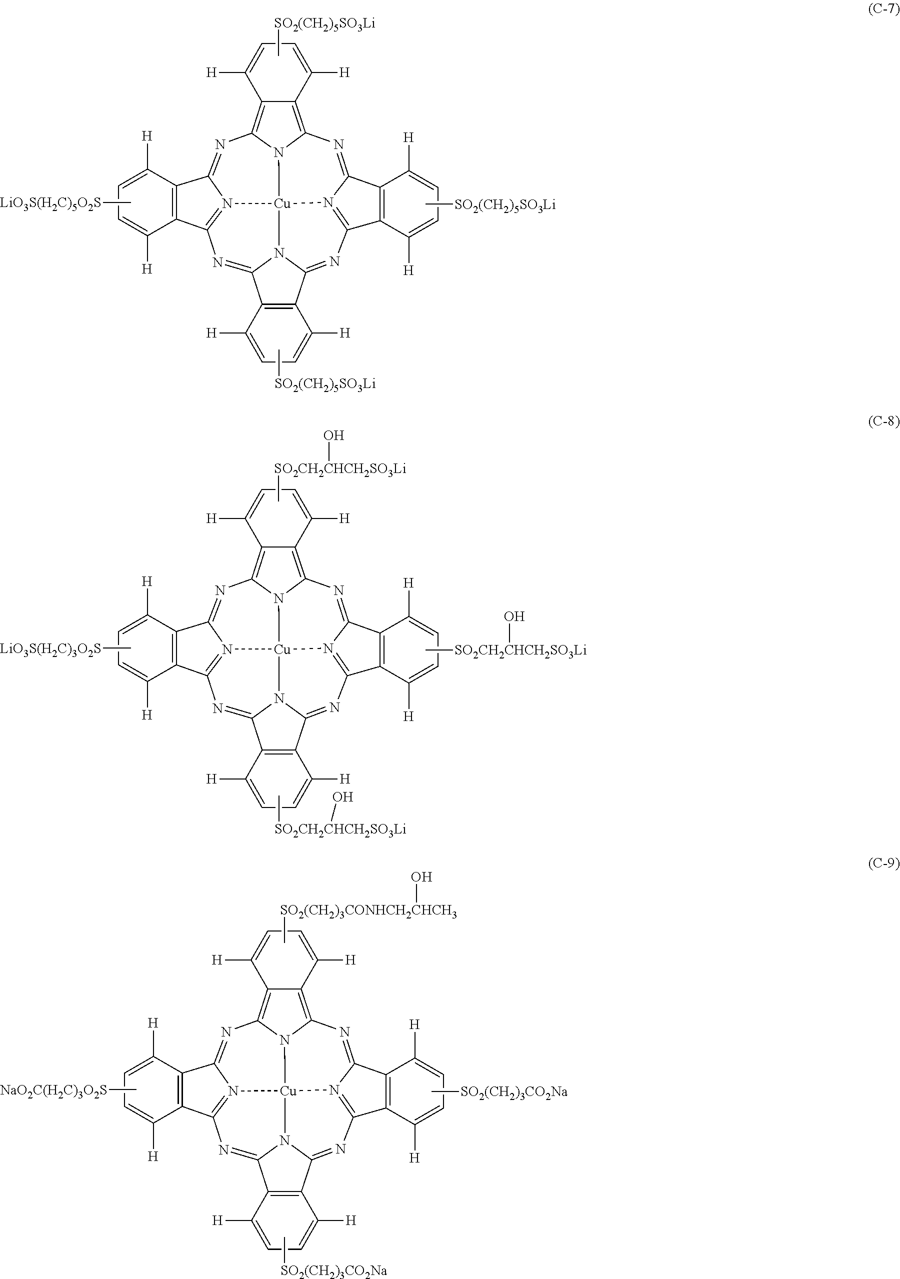

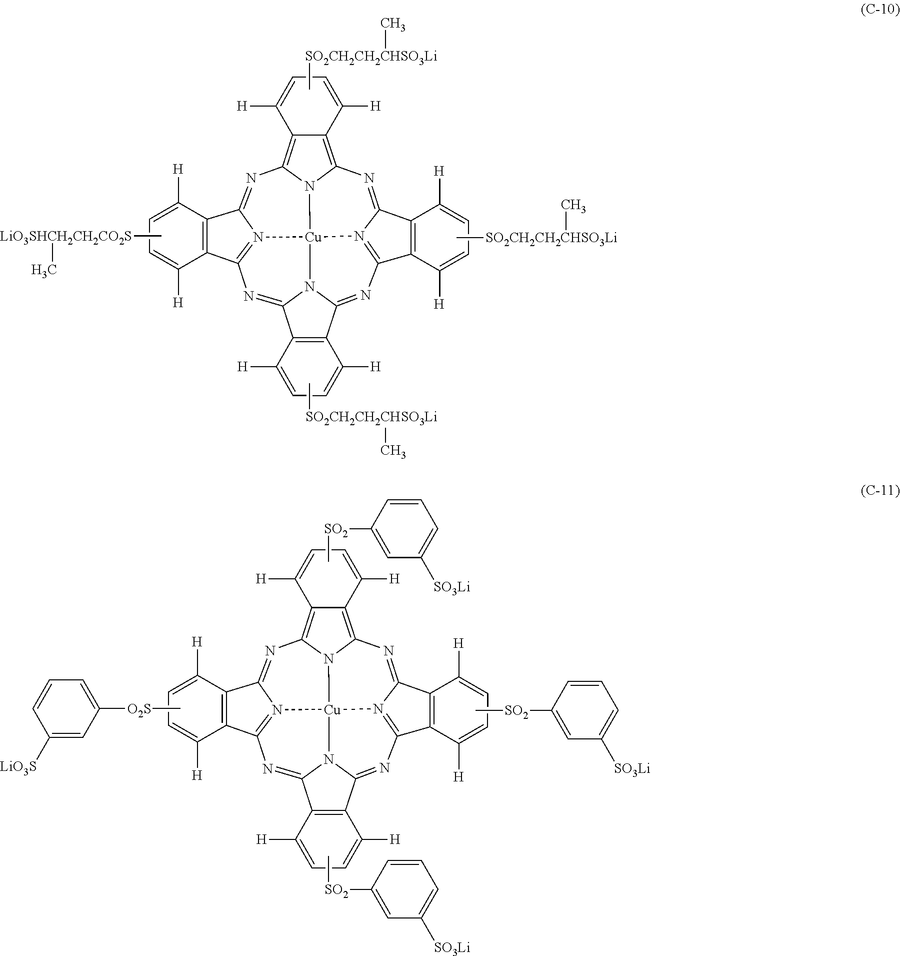

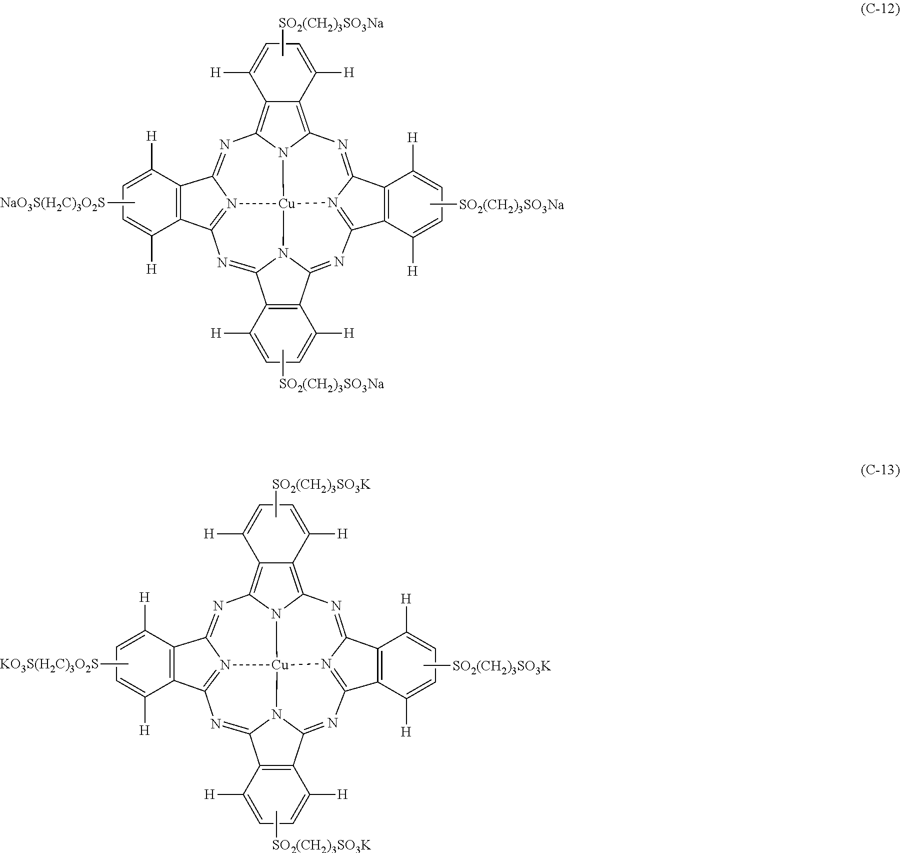

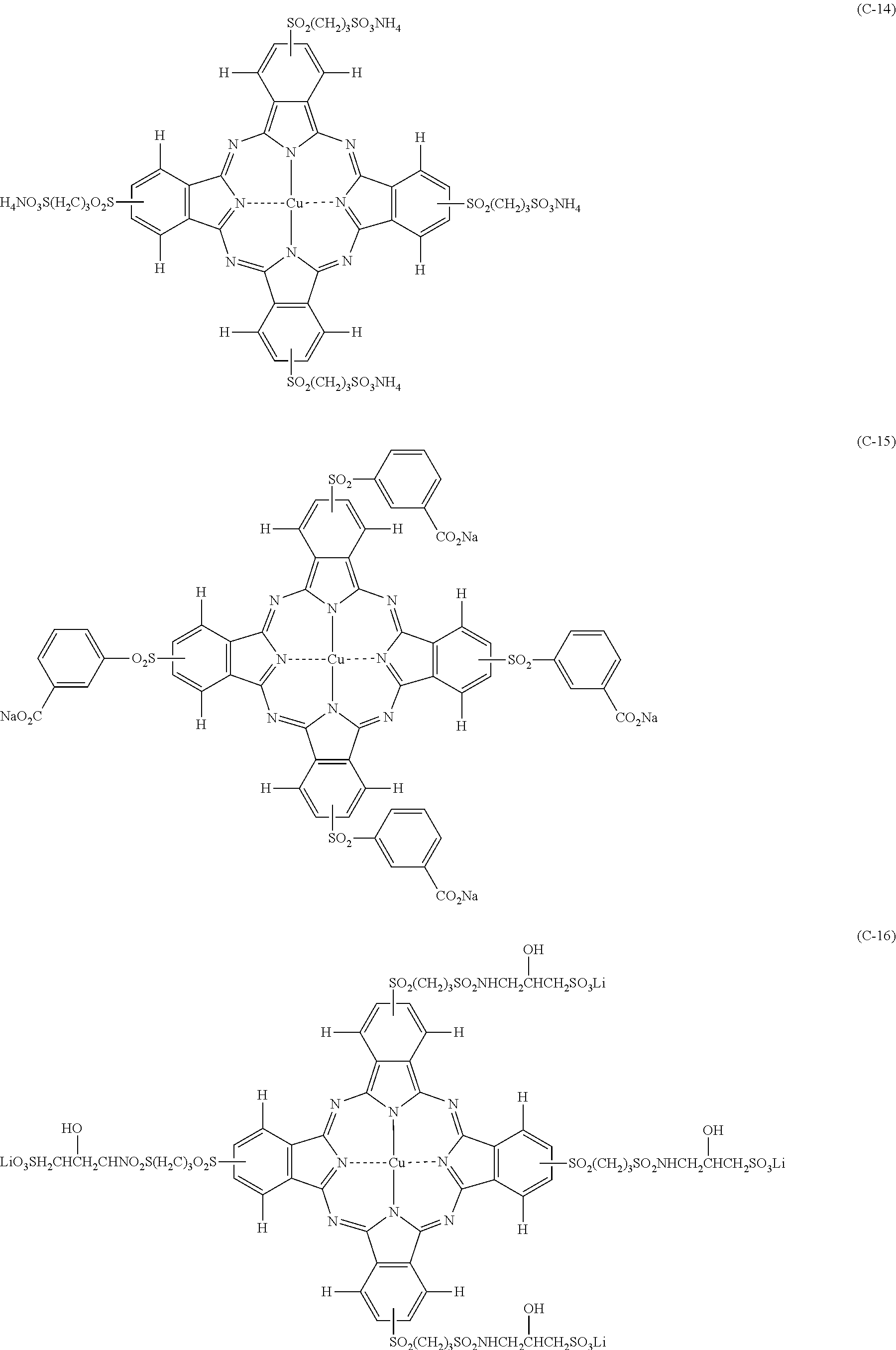

The cyan ink composition according to an embodiment of the present invention may further contain, in addition to the compound represented by the general formula (2), a colorant other than the compound represented by the general formula (2). The colorant other than the compound represented by the general formula (2) is preferably a compound represented by general formula (3) below.

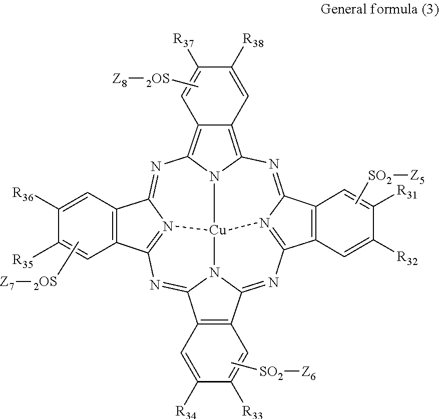

In the general formula (3), R₃₁, R₃₂, R₃₃, R₃₄, R₃₅, R₃₆, R₃₇, and R₃₈ each independently represent a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imide group, a heterocyclic thio group, a phosphoryl group, an acyl group, or an ionic hydrophilic group. These groups may further have a substituent. Z₅, Z₆, Z₇, and Z₈ each independently represent a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group. Note that at least one of Z₅, Z₆, Z₇, or Z₈ has an ionic hydrophilic group as a substituent.

The compound represented by the general formula (3) is a phthalocyanine dye in which substituted sulfonyl groups (—SO₂—Z₅, —SO₂—Z₆, —SO₂—Z₇, and —SO₂—Z₈) are introduced to α positions. In other words, —SO₂—Z₅, —SO₂—Z₆, —SO₂—Z₇, and —SO₂—Z₈ in the general formula (3) are substituted with hydrogen atoms at α positions and are not substituted with hydrogen atoms or substituents R₃₁, R₃₂, R₃₃, R₃₄, R₃₅, R₃₆, R₃₇, and R₃₈ at β positions.

R₃₁, R₃₂, R₃₃, R₃₄, R₃₅, R₃₆, R₃₇, and R₃₈ in the general formula (3) have the same meaning as R₂₁, R₂₂, R₂₃, R₂₄, R₂₅, R₂₆, R₂₇, and R₂₈ in the general formula (2), and the preferred examples are also the same.

Z₅, Z₆, Z₇, and Z₈ in the general formula (3) have the same meaning as Z₁, Z₂, Z₃, and Z₄ in the general formula (2), and the preferred examples are also the same.

The compound represented by the general formula (3) can be synthesized by a publicly known method (e.g., a method disclosed in JP3949385B).

Hereafter, the compound represented by the general formula (3) is specifically listed, but is not limited thereto. In the following structural formulae of specific compounds, each specific compound is a mixture of positional isomers (refer to (3A) to (3D) below) that vary depending on introduction positions (α positions) of particular substituents (R). Therefore, the introduction positions of substituents are not specified and are treated as the same positions. In the specific examples below, a substituted sulfonyl group is substituted with a hydrogen atom at any α position and is not substituted at positions “H” in each structural formula.

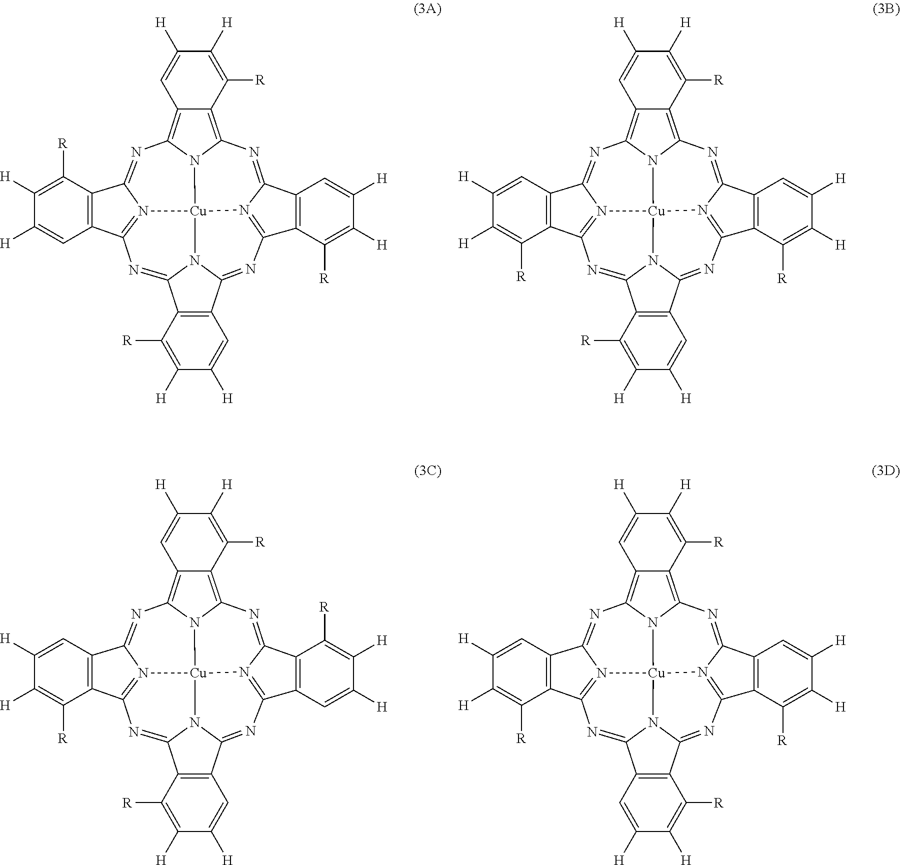

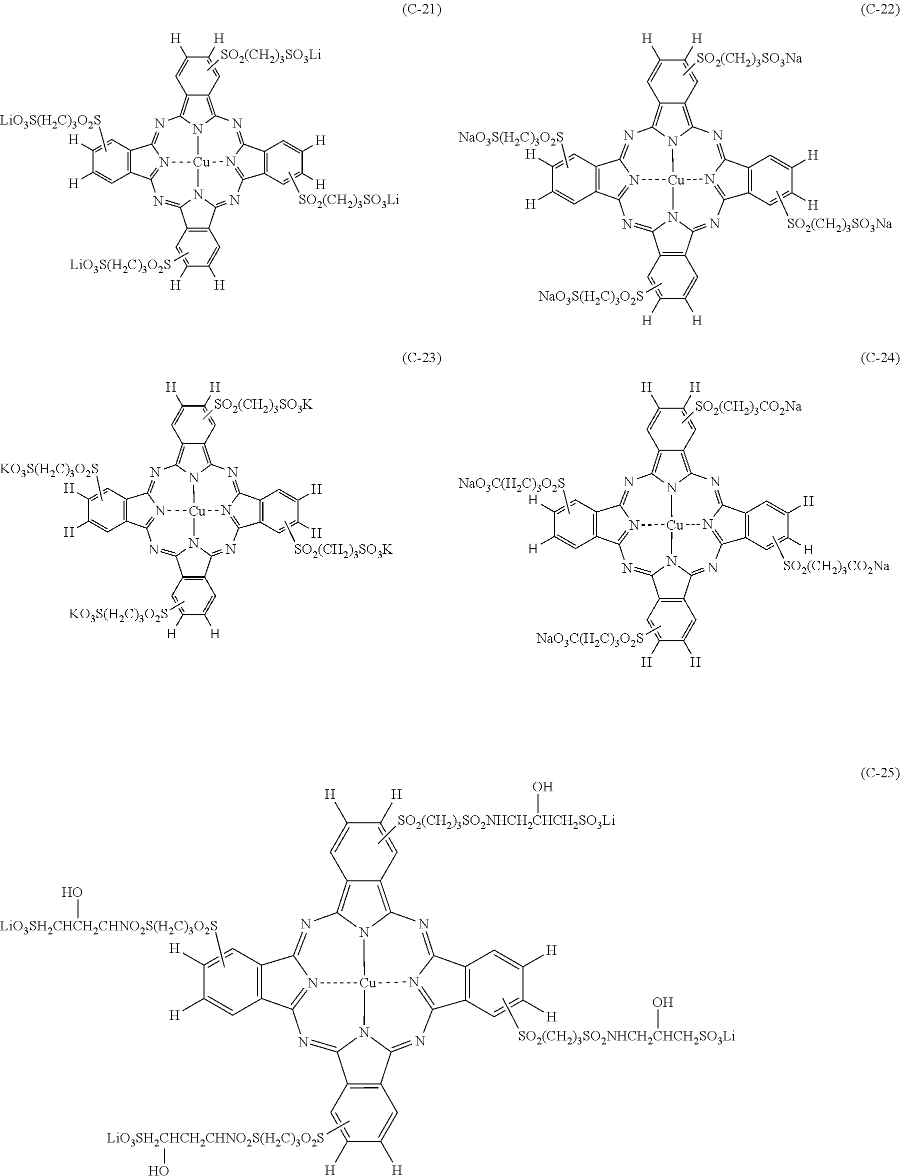

The case where the cyan ink composition according to an embodiment of the present invention contains the compound represented by the general formula (2) and the compound represented by the general formula (3) is also preferred.

The use of the β-position substituted compound represented by the general formula (2) and the α-position substituted compound represented by the general formula (3) enables the adjustment of the ratio of α-position substitution and β-position substitution between molecules, but not in a molecule. Consequently, both good fastness and high optical density can be achieved.

In the cyan ink composition, the mass ratio of the compound represented by the general formula (3) and the compound represented by the general formula (2) (compound represented by general formula (3)/compound represented by general formula (2)) is preferably 50/50 to 5/95, more preferably 40/60 to 5/95, further preferably 15/85 to 5/95, and most preferably 15/85 to 10/90. When the mass ratio of the dyes is within the above range, the ink has good temporal stability (e.g., change in viscosity or precipitation) at high concentration, and the sample obtained by printing an ink has a reduced bronze luster, high ozone resistance, and high optical density.

The cyan ink composition according to an embodiment of the present invention may further contain, in addition to the compound represented by the general formula (2), a colorant that is a compound other than the compound represented by the general formula (2) and the compound represented by the general formula (3). The colorant that is a compound other than the compound represented by the general formula (2) and the compound represented by the general formula (3) may be a phthalocyanine dye or a partial azaphthalocyanine dye or may be other dyes such as a triarylmethane dye.

For the colorant that is a compound other than the compound represented by the general formula (2) and the compound represented by the general formula (3), the central metal of the phthalocyanine dye or the partial azaphthalocyanine dye is preferably copper, aluminum, zinc, iron, or nickel. Furthermore, at least one of outermost aromatic rings of the phthalocyanine skeleton of the partial azaphthalocyanine dye is particularly preferably a nitrogen-containing aromatic ring (e.g., pyridine ring or pyrazine ring). The coloring agent having such a structure is preferred because the ozone resistance, moisture resistance, and light resistance of an image in a color mixture portion can be improved in a well-balanced manner.

Among colorants that are compounds other than the compound represented by the general formula (2) and the compound represented by the general formula (3), a phthalocyanine dye or a partial azaphthalocyanine dye that can be contained in the cyan ink composition as a colorant used in combination is listed below.

### Compound Represented by General Formula (PC1) Below (Compound Disclosed in JP2004-323605A)

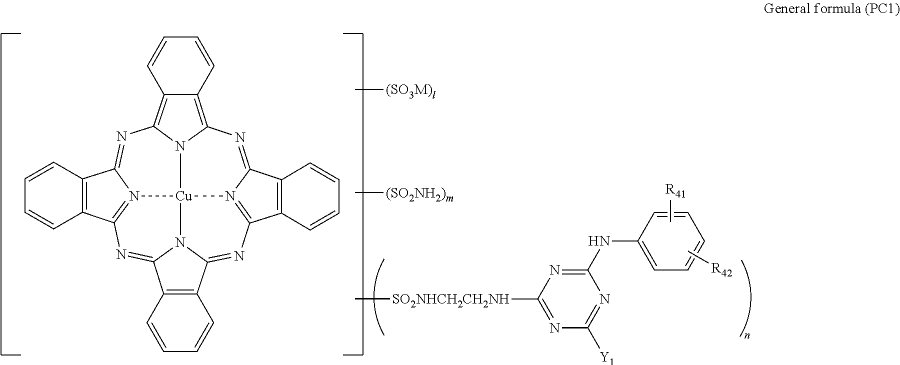

In the general formula (PC1), R₄₁ and R₄₂ each independently represent a hydrogen atom, a sulfo group, or a carboxy group, but R₄₁ and R₄₂ do not each represent a hydrogen atom. Y₁ represents a chlorine atom, a hydroxy group, an amino group, a monoalkylamino group, or a dialkylamino group. Each M independently represents a hydrogen atom, an alkali metal, an ammonium, or an organic ammonium. Herein, 1, m, and n satisfy 0≤1≤2.0, 1.0≤m≤3.0, 1.0≤n≤3.0, and 1+m+n=2.0 to 4.0.

Preferred specific examples of the compound represented by the general formula (PC1) include cyan dye 1 and cyan dye 2 below.

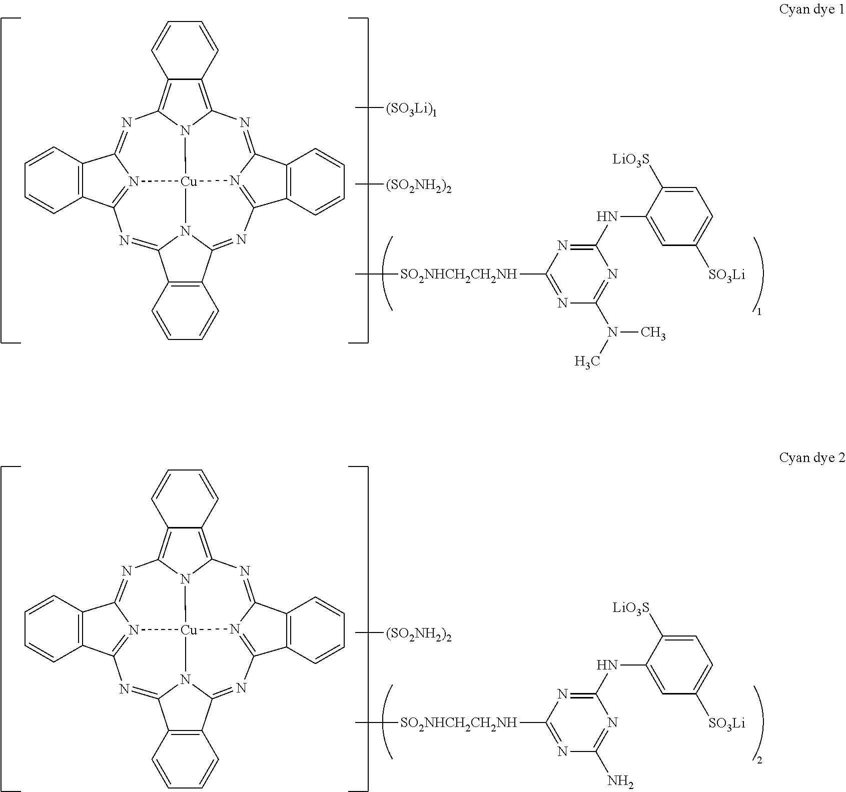

### Compound Represented by General Formula (PC2) Below (WO2007/091631A)

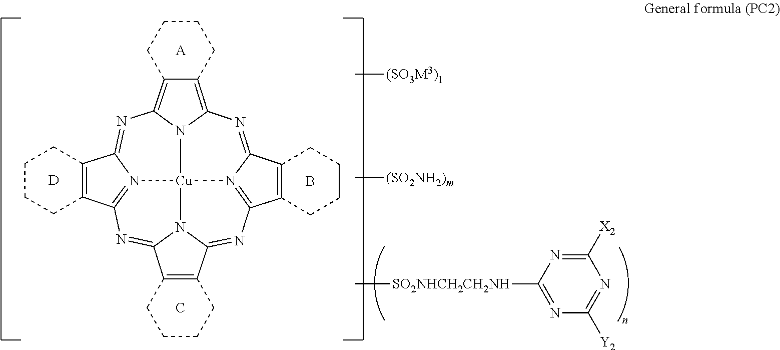

In the general formula (PC2), A, B, C, and D each independently represent a six-membered aromatic ring. Each M³ independently represents a hydrogen atom, an alkali metal, an ammonium, or an organic ammonium. X₂ represents a sulfo-substituted anilino group, a carboxy-substituted anilino group, or a phosphono-substituted anilino group. The substituted anilino group may further have 1 to 4 of substituents selected from the group consisting of a sulfo group, a carboxy group, a phosphono group, a sulfamoyl group, a carbamoyl group, a hydroxy group, an alkoxy group, an amino group, an alkylamino group, a dialkylamino group, an arylamino group, a diarylamino group, an acetylamino group, a ureido group, an alkyl group, a nitro group, a cyano group, a halogen, an alkylsulfonyl group, and an alkylthio group. Y₂ represents a hydroxy group or an amino group. Herein, 1, m, and n satisfy 0≤1≤2.0, 0≤m≤3.0, 1.0≤n≤3.0, and +m+n=1.0 to 3.0.

In the present invention, an image having high ozone resistance, high moisture resistance, and high light resistance is obtained and thus at least one of A to D in the general formula (PC2) preferably represents a pyridine ring or a pyrazine ring. In the general formula (PC2), X₂ preferably represents a sulfo-substituted anilino group and Y₂ preferably represents an amino group. Furthermore, 1=0, m=0.5 to 3.0, and n=0.1 to 1.0 are preferably satisfied.

Preferred specific examples of the compound represented by the general formula (PC2) include cyan dyes 3 to 8 below. In the cyan dyes 3 to 8 below, a sulfo group, a sulfamoyl group, or a substituted sulfamoyl group is substituted with a hydrogen atom at either of an a position or a p position of the benzene ring and is not substituted at positions “H” in each structural formula.

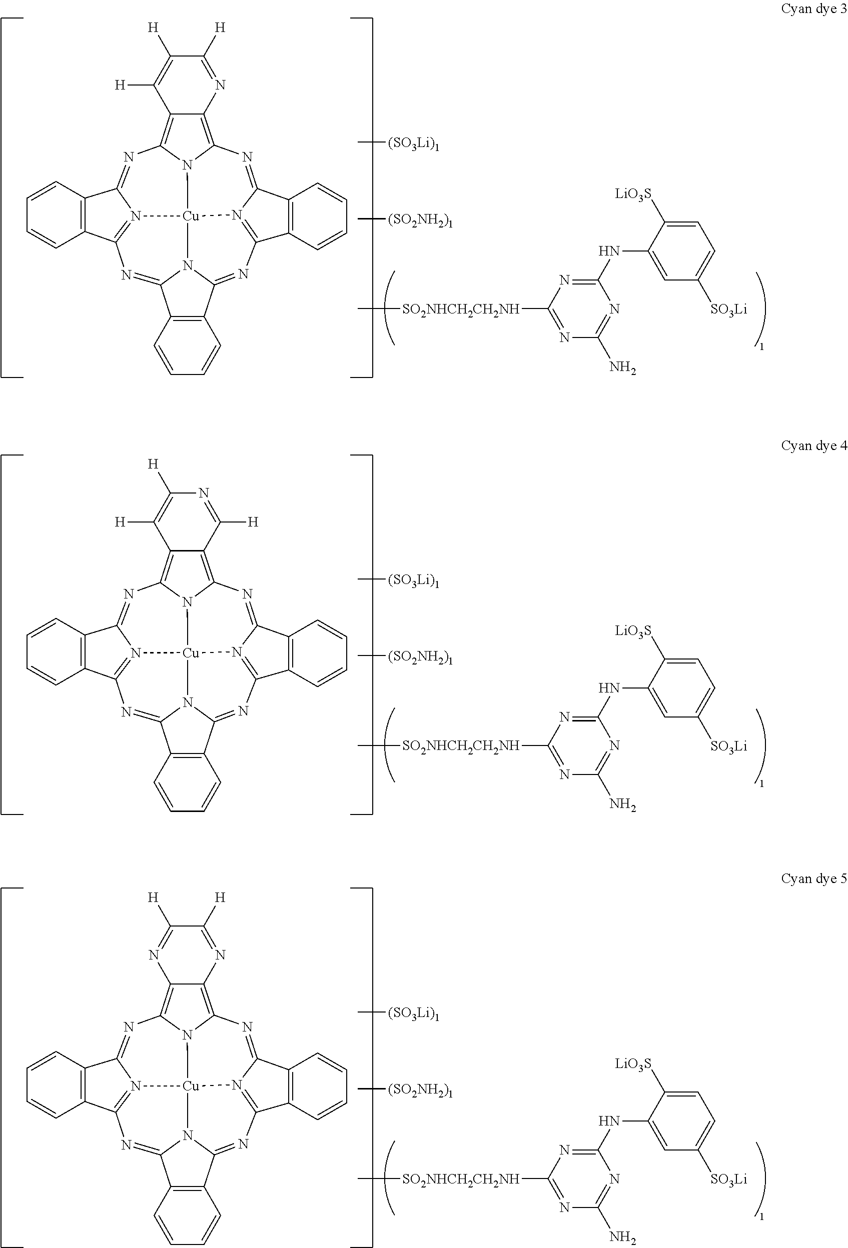

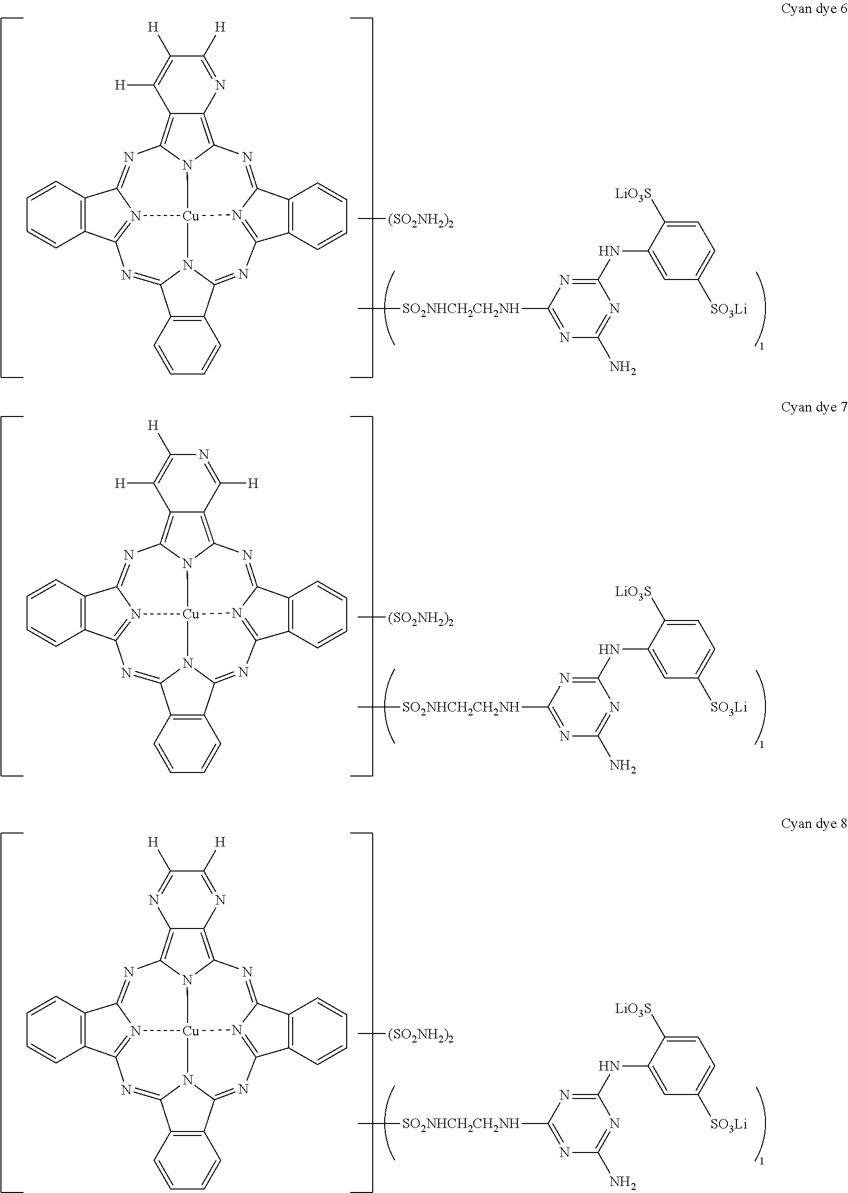

### Compound Represented by General Formula (PC3) Below (JP2005-179469A)

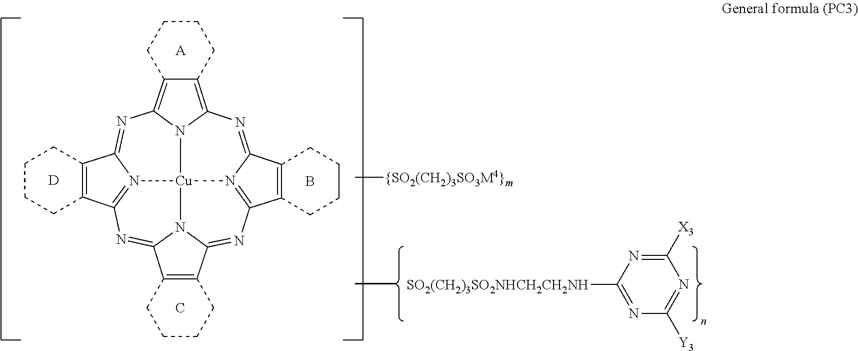

In the general formula (PC3), A, B, C, and D each independently represent a six-membered aromatic ring. Each M⁴ independently represents a hydrogen atom, an alkali metal, an ammonium, or an organic ammonium. X₃ represents a sulfo-substituted anilino group, a carboxy-substituted anilino group, or a phosphono-substituted anilino group. The substituted anilino group may further have 1 to 4 substituents selected from the group consisting of a sulfo group, a carboxy group, a phosphono group, a sulfamoyl group, a carbamoyl group, a hydroxy group, an alkoxy group, an amino group, an alkylamino group, a dialkylamino group, an arylamino group, a diarylamino group, an acetylamino group, a ureido group, an alkyl group, a nitro group, a cyano group, a halogen, an alkylsulfonyl group, and an alkylthio group. Y₃ represents a hydroxy group or an amino group. Herein, m and n satisfy 1.0≤m≤3.0, 0≤n≤3.0, and m+n=1.0 to 3.0.

In the present invention, an image having high ozone resistance, high moisture resistance, and high light resistance is obtained and thus at least one of A to D in the general formula (PC3) preferably represents a pyridine ring or a pyrazine ring. In the general formula (PC3), X₃ preferably represents a sulfo-substituted anilino group and Y₃ represents an amino group. Furthermore, m=1.0 to 3.0 and n=0.0 to 2.0 are preferably satisfied.

Preferred specific examples of the compound represented by the general formula (PC3) include cyan dyes 9 to 11 below. In the cyan dyes 9 to 11 below, the substituted sulfonyl group is substituted with a hydrogen atom at any β position of the benzene ring and is not substituted at positions “H” in each structural formula.

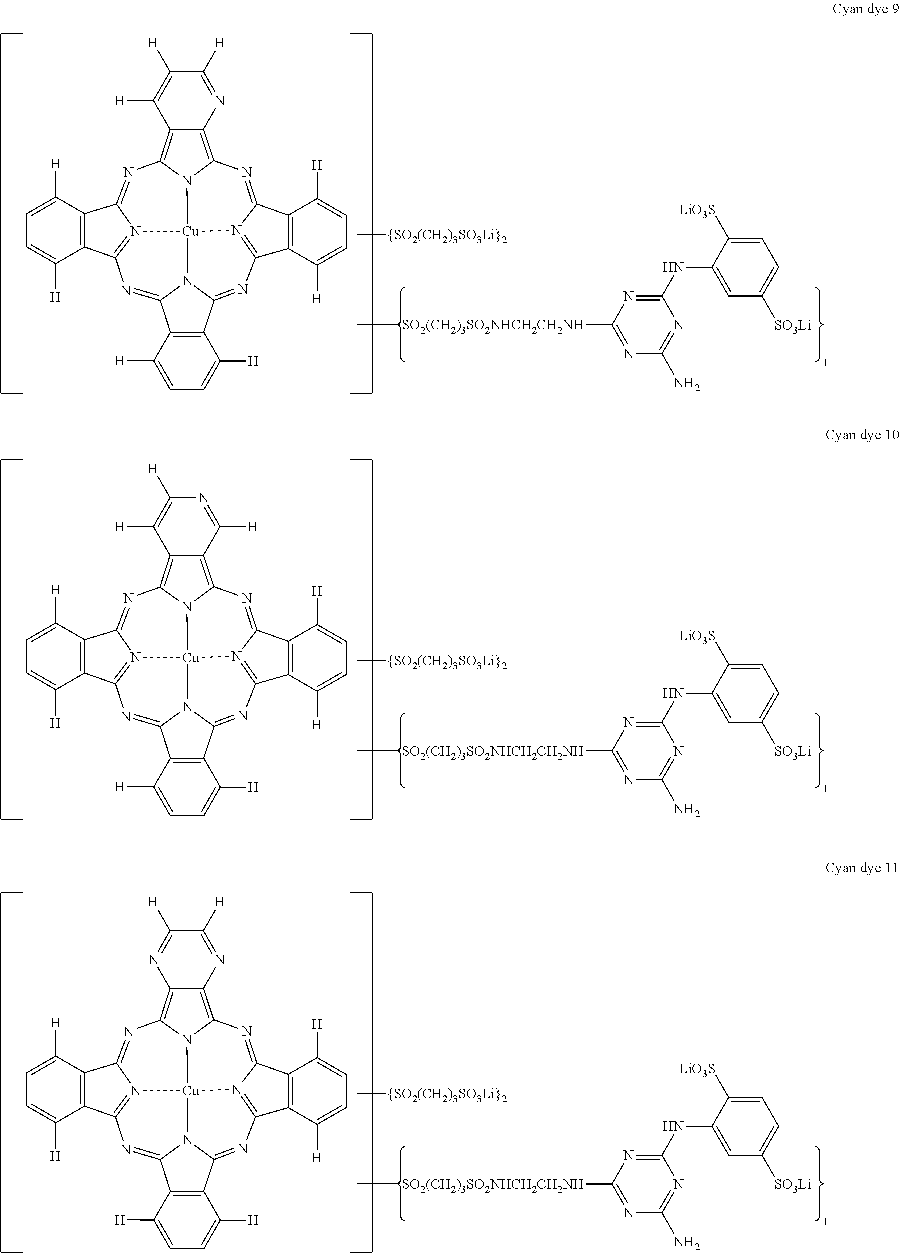

### Synthesis of Phthalocyanine Dye

A phthalocyanine derivative that can be used in the present invention can be synthesized by, for example, employing methods described or cited in Shirai; Kobayashi: “Phthalocyanine—Chemistry and Function—”; IPC; pp 1 to 62 and C. C. Leznoff; A. B. P. Lever: “Phthalocyanines—Properties and Applications”; VCH; pp 1 to 54, or by combining methods similar to the foregoing methods.

A compound other than the compound represented by the general formula (2) that can be contained in the cyan ink composition according to an embodiment of the present invention and other than the compound represented by the general formula (3) can be contained in the cyan ink composition as a colorant used in combination. Typical colorants are listed below as examples. Note that “C.I.” is an abbreviation of “color index”.
C.I. Direct Blue: 6, 22, 25, 71, 78, 86, 87, 90, 106, 189, 199, 262, 264, 276, 282, 314
C.I. Acid Blue: 9, 22, 40, 59, 93, 102, 104, 113, 117, 120, 167, 185, 197, 224, 228, 229, 234, 242, 243, 249, 254, 275, 279, 283, 310, 357

The content (mass %) of the compound represented by the general formula (2) in the cyan ink composition is preferably 1.0 mass % or more and 10.0 mass % or less, more preferably 2.0 mass % or more and 8.0 mass % or less, and further preferably 3.0 mass % or more and 6.0 mass % or less with respect to the total mass of the cyan ink composition.

When the cyan ink composition further contains, in addition to the compound represented by the general formula (2), a colorant other than the compound represented by the general formula (2), the total content (mass %) of all colorants in the cyan ink composition is preferably 1.0 mass % or more and 10.0 mass % or less, more preferably 2.0 mass % or more and 8.0 mass % or less, further preferably 3.0 mass % or more and 6.0 mass % or less, and most preferably 3.5 mass % or more and 5.5 mass % or less with respect to the total mass of the cyan ink composition.

In the ink set according to an embodiment of the present invention, preferably, the magenta ink composition contains the compound represented by the general formula (1) within the above-described preferred range, the cyan ink composition appropriately contains the compound represented by the general formula (2) and at least one of the compound represented by the general formula (3) or the cyan dyes 1 to 11 in combination, and a yellow ink composition described later is used. This can provide an image having a good color balance (optical density and mixed-color hue) and a printed matter having a good fading balance. Therefore, the image quality of the printed matter can be maintained for a longer time.

### Yellow Ink Composition

The yellow ink composition constituting the ink set according to an embodiment of the present invention contains at least one compound selected from the group Y below. The group Y is a group consisting of compounds represented by general formulae (Y1) to (Y9). Each of the compounds represented by the general formulae (Y1) to (Y9) is a colorant and can be used as a yellow dye.

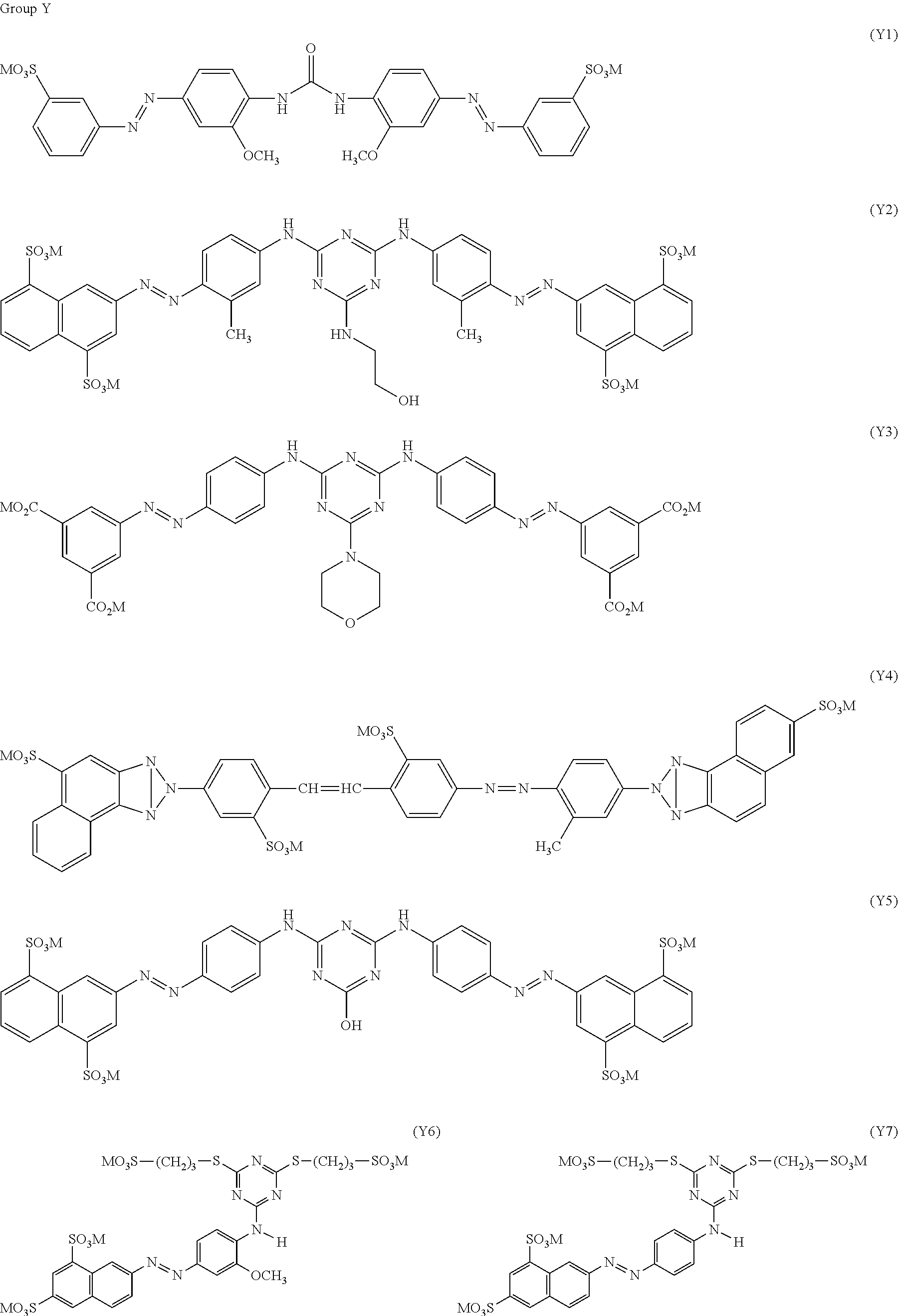

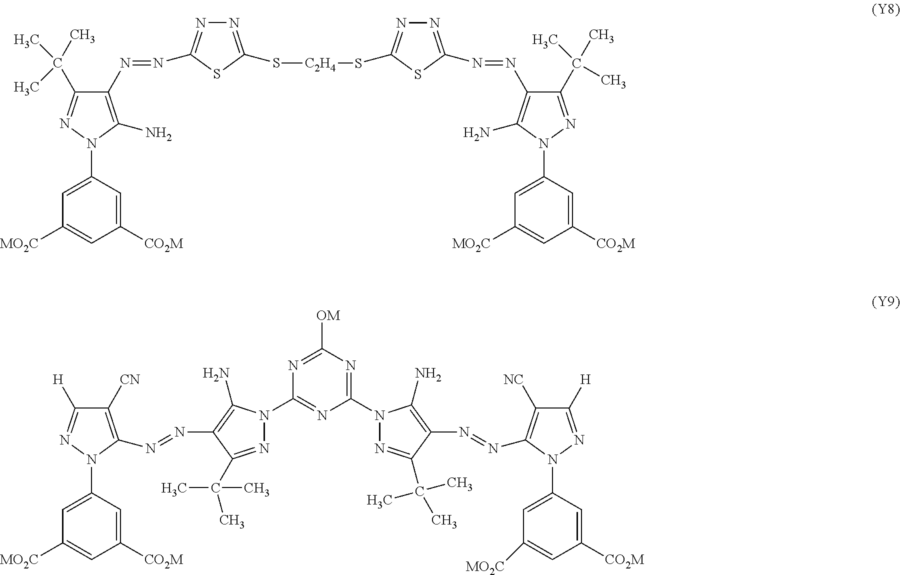

In the general formulae (Y1) to (Y9), each M independently represents a hydrogen atom, a lithium ion, a sodium ion, a potassium ion, or an ammonium ion.

The compound selected from the group Y is excellent in terms of hue, coloring power (optical density), and image fastness. One or more of compounds selected from the group Y may be used as long as the advantageous effects of the present invention are not impaired. The yellow ink composition may further contain, in addition to the compound selected from the group Y, a colorant other than the compound selected from the group Y.

The content (mass %) of the compound selected from the group Y in the yellow ink composition is preferably 1.0 mass % or more and 10.0 mass % or less, more preferably 2.0 mass % or more and 6.0 mass % or less, and further preferably 3.0 mass % or more and 5.0 mass % or less with respect to the total mass of the yellow ink composition.

When the yellow ink composition further contains, in addition to the compound selected from the group Y, a colorant other than the compound selected from the group Y, the total content (mass %) of all colorants in the yellow ink composition is preferably 1.0 mass % or more and 10.0 mass % or less, more preferably 2.0 mass % or more and 6.0 mass % or less, further preferably 2.5 mass % or more and 5.0 mass % or less, and most preferably 2.5 mass % or more and 4.5 mass % or less with respect to the total mass of the yellow ink composition.

A preferred specific example of the compound represented by the general formula (Y1) is a compound (YA1) below. A preferred specific example of the compound represented by the general formula (Y2) is a compound (YA2) below. A preferred specific example of the compound represented by the general formula (Y3) is a compound (YA3) below. A preferred specific example of the compound represented by the general formula (Y4) is a compound (YA4) below. A preferred specific example of the compound represented by the general formula (Y5) is a compound (YA5) below. A preferred specific example of the compound represented by the general formula (Y6) is a compound (YA6) below. A preferred specific example of the compound represented by the general formula (Y7) is a compound (YA7) below. A preferred specific example of the compound represented by the general formula (Y8) is a compound (YA8) below. Preferred specific examples of the compound represented by the general formula (Y9) include a compound (YA9-1) below and a compound (YA9-2) below.

The yellow ink composition preferably contains at least one of the compounds represented by the general formula (Y1), (Y2), (Y3), (Y5), (Y8), or (Y9) among the compounds selected from the group Y, particularly preferably contains at least one compound selected from the group consisting of compounds (YA1), (YA2), (YA3), (YA5), (YA8), (YA9-1), and (YA9-2) below, and most preferably contains at least one compound selected from the group consisting of compounds (YA8), (YA9-1), and (YA9-2) below.

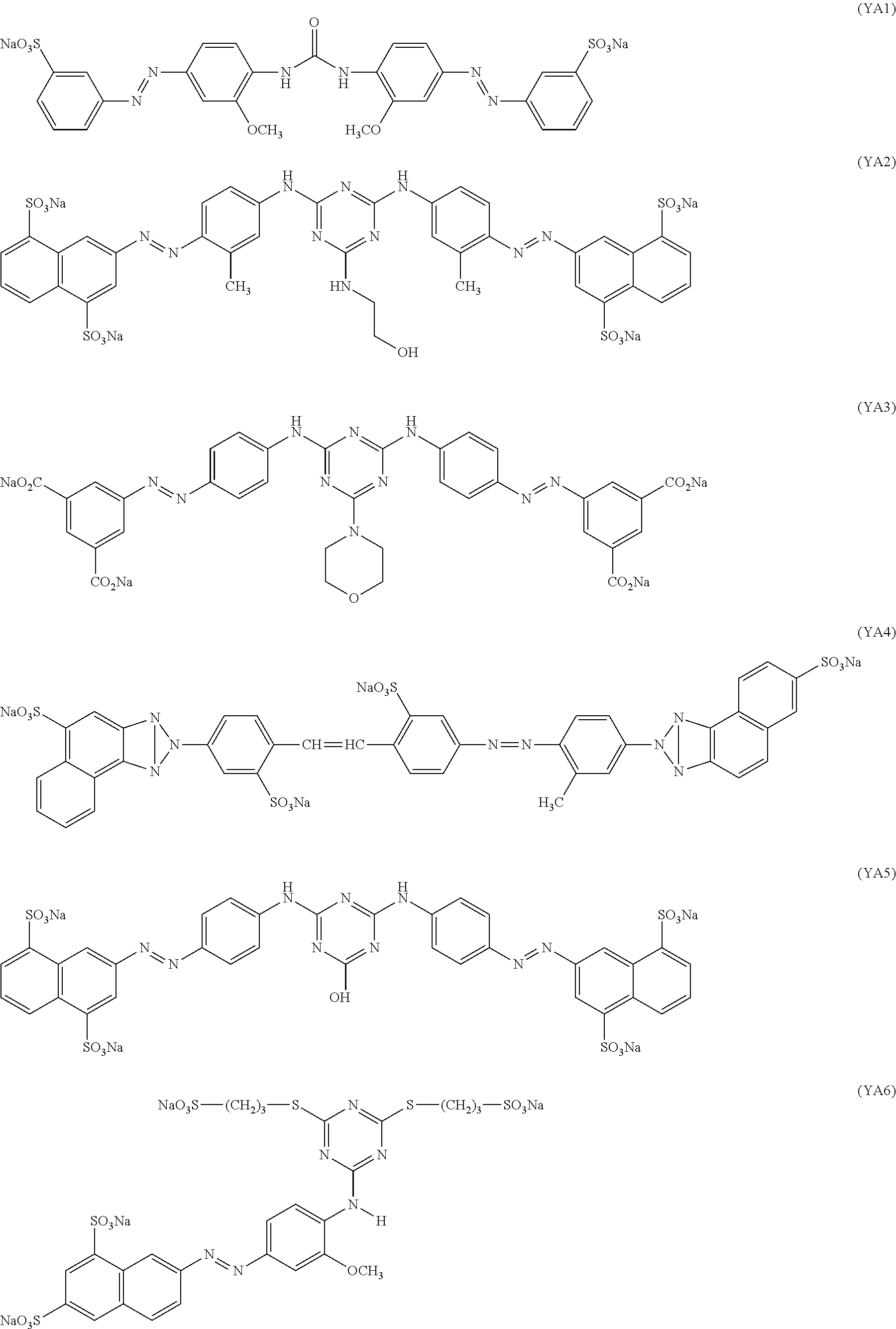

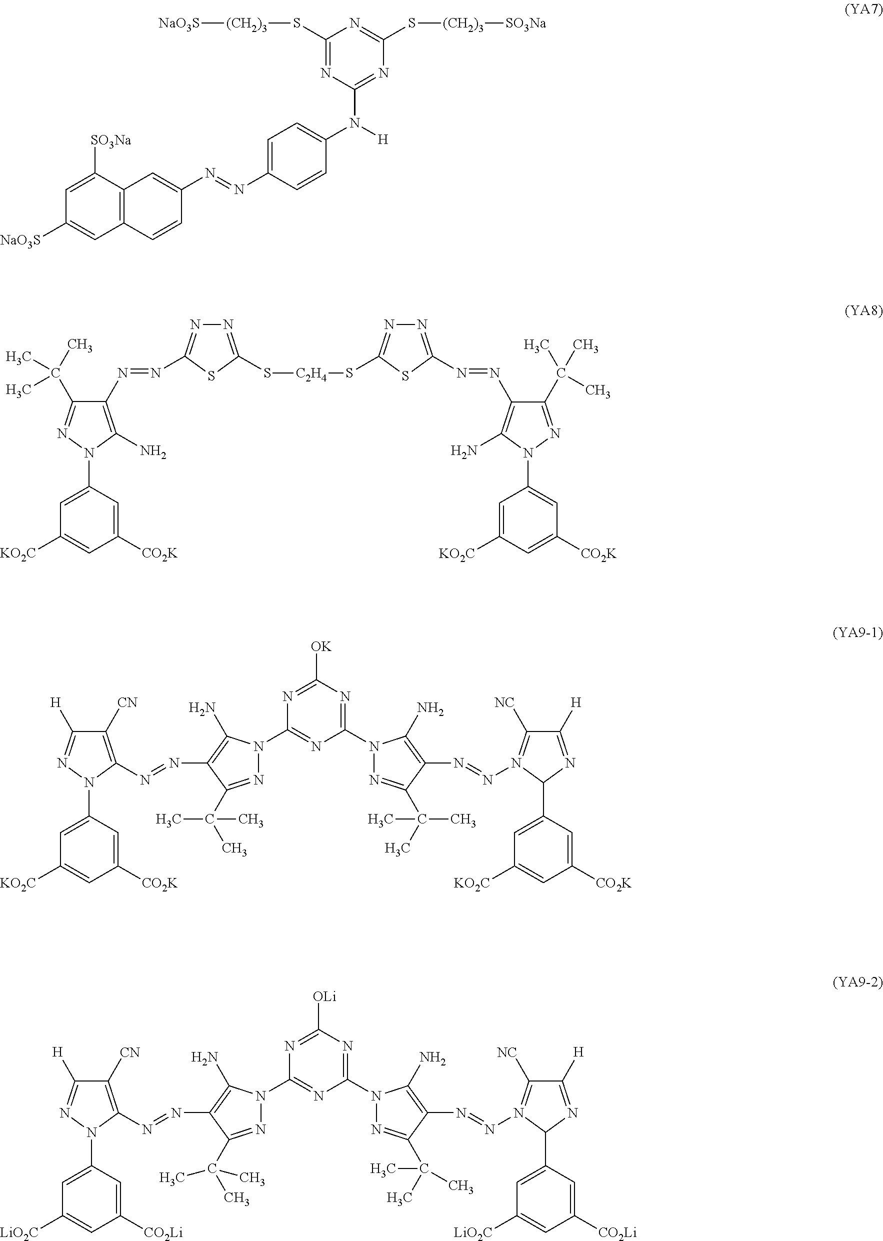

The at least one compound selected from the group consisting of the compounds (YA1), (YA2), (YA3), (YA5), (YA8), (YA9-1), and (YA9-2) particularly achieves high light resistance and high moisture resistance. Therefore, when the yellow ink composition containing at least one compound selected from the group consisting of the compounds (YA1), (YA2), (YA3), (YA5), (YA8), (YA9-1), and (YA9-2) is combined with the cyan ink composition, the magenta ink composition, and a black ink composition to obtain an ink set, the ozone resistance, the light resistance, and the moisture resistance of each color can be considerably improved, and good image quality can be maintained for a long time without losing a color balance of an image even after an ozone and light exposure test.

In particular, when the yellow ink composition contains at least one compound selected from the group consisting of the compounds (YA1), (YA2), (YA3), and (YA5) and at least one compound selected from the group consisting of the compounds (YA8), (YA9-1), and (YA9-2) in a combined manner, a better color balance of, for example, yellow, magenta, cyan, red, green, blue, and black can be achieved and thus good image quality of printed matter can be maintained for a longer time.

More preferably, at least one of the compounds (YA1) and (YA5) and at least one compound selected from the group consisting of the compounds (Y8), (YA8), (YA9-1), and (YA9-2) are combined with each other. Particularly preferably, the compound (YA1) and at least one compound selected from the group consisting of the compounds (YA8), (YA9-1), and (YA9-2) are combined with each other.

The yellow ink composition may further contain, in addition to the compound selected from the group Y, a colorant other than the compound selected from the group Y. The colorant other than the compound selected from the group Y is preferably a compound having an azo structure. The compound having an azo structure is preferably a compound having a disazo structure. The colorant having such a structure is particularly preferred because the ozone resistance, moisture resistance, and light resistance of an image in a color mixture portion can be improved in a well-balanced manner. In the present invention, the compound having an azo structure particularly preferably has a dimeric disazo structure in which two monoazo units having the same structure bond to each other through a linking group. The colorant having such a structure is particularly preferred because the coloring power in a single-color portion and a color mixture portion and the ozone resistance, moisture resistance, and light resistance of an image in a single-color portion and a color mixture portion can be improved in a well-balanced manner.

The following are specific examples of the compound having an azo structure, which is a colorant other than the compound selected from the group Y, that can be further contained, in addition to the compound selected from the group Y, in the yellow ink composition constituting the ink set according to an embodiment of the present invention.
C.I. Direct Yellow: 8, 12, 27, 33, 44, 50, 85, 86, 88, 89, 98, 100, 110, 132, 173
C.I. Acid Yellow: 11, 17, 23, 25, 29, 36, 38, 40, 42, 44, 76, 98

Furthermore, yellow dyes that can be further contained in the yellow ink composition in combination with the compound selected from the group Y are listed below, but are not limited thereto.
C.I. Direct Yellow: 9, 11, 28, 29, 35, 39, 41, 53, 59, 68, 87, 93, 95, 96, 106, 108, 109, 130, 142, 144, 161, 163
C.I. Acid Yellow: 19, 39, 49, 50, 61, 64, 79, 110, 127, 135, 143, 151, 159, 169, 174, 190, 195, 196, 197, 199, 218, 219, 222, 227
C.I. Reactive Yellow: 2, 3, 13, 14, 15, 17, 18, 23, 24, 25, 26, 27, 29, 35, 37, 41, 42
C.I. Basic Yellow: 1, 2, 4, 11, 13, 14, 15, 19, 21, 23, 24, 25, 28, 29, 32, 36, 39, 40

### Compound Represented by General Formula (4) (Compound Disclosed in JP2002-504613A)

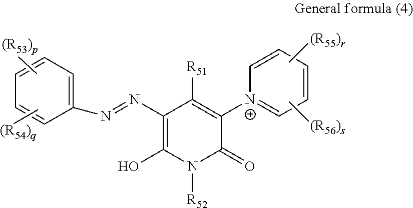

In the general formula (4), R₅₁ and R₅₂ each independently represent a hydrogen atom, a substituted or unsubstituted alkyl group, a substituted or unsubstituted aryl group, or a substituted or unsubstituted arylalkyl group. R₅₃ and R₅₅ each independently represent a carboxy group, a sulfo group, a phosphate group, or a salt thereof, or an alkyl group substituted with any of the foregoing groups. R₅₄ and R₅₆ each independently represent a group other than the groups defined in R₅₃ and R₅₅. Herein, p and r each independently represent an integer of 1 to 5, q and s each independently represent an integer of 0 to 4, and p+q≤5 and r+s≤5 are satisfied.

In the present invention, R₅₄ and R₅₆ in the general formula (4) preferably each independently represent a hydrogen atom, a halogen atom, or a substituted or unsubstituted alkyl group. When R₅₃ and R₅₅ represent a salt, examples of a cation for forming the salt include alkali metal ions such as a lithium ion, a potassium ion, and a sodium ion, ammonium ions, and organic ammonium ions.

A preferred specific example of the compound represented by the general formula (4) is a yellow dye 1 below.

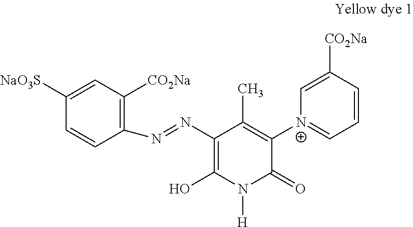

### Compound Represented by General Formula (5) (Compound Disclosed in WO2008/053776A)

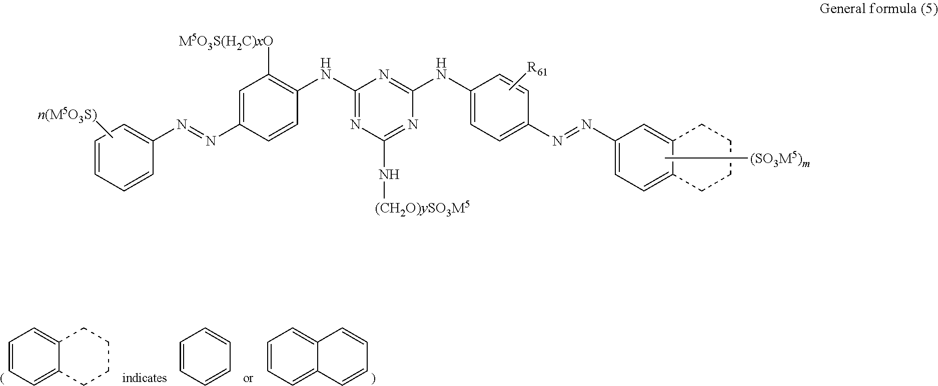

In the general formula (5), R₆₁ represents a hydrogen atom, an alkyl group having 1 to 4 carbon atoms, an alkoxy group having 1 to 4 carbon atoms, or a sulfo group. Herein, n represents an integer of 1 or 2, m represents an integer of 1 to 3, x represents an integer of 2 to 4, and y represents an integer of 1 to 3. Each M⁵ independently represents a hydrogen atom, an alkali metal, an ammonium, or an organic ammonium.

A preferred specific example of the compound represented by the general formula (5) is a yellow dye 2 below.

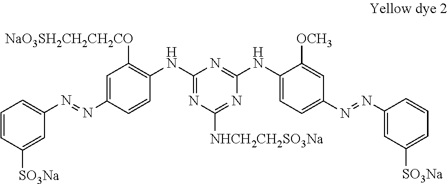

The content (the total content in the case where a plurality of colorants are used) of the colorant in the yellow ink composition can be appropriately determined in accordance with the color value of the compound (dye) used as a colorant. The content is preferably 1.0 to 6.0 mass % with respect to the total mass of the yellow ink composition. When the content of the colorant in the yellow ink composition is 1.0 mass % or more, good color development properties can be achieved. When the content of the colorant is 6.0 mass % or less, good characteristics, such as dischargeability from nozzles, that are required as an ink composition used for an ink jet recording method are achieved, which can prevent clogging of ink nozzles.

In particular, the content of the compound selected from the group Y in the yellow ink composition is preferably 1.5 to 5.5 mass % and more preferably 2.0 to 5.5 mass % with respect to the total mass of the yellow ink composition.

### Black Ink Composition

A black ink composition constituting the ink set according to an embodiment of the present invention will be described.

When the ink set contains the black ink composition, high optical density required for black images can be achieved and an image having high contrast can be obtained.

The black ink composition constituting the ink set according to an embodiment of the present invention contains at least one compound selected from the group BK below. The group BK is a group consisting of compounds represented by general formulae (BK1) to (BK9). Each of the compounds represented by the general formulae (BK1) to (BK9) is a colorant and can be used as a black dye.

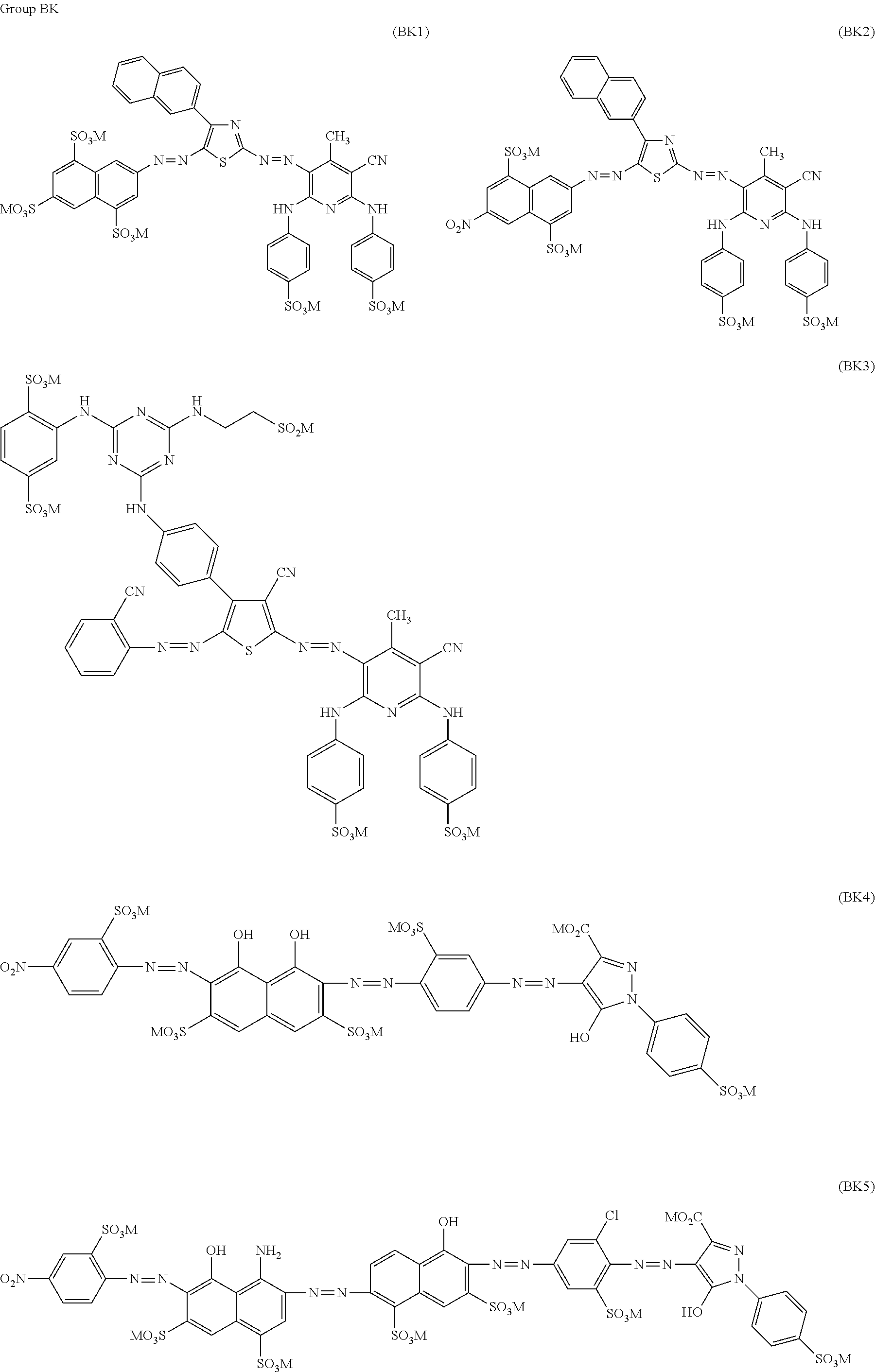

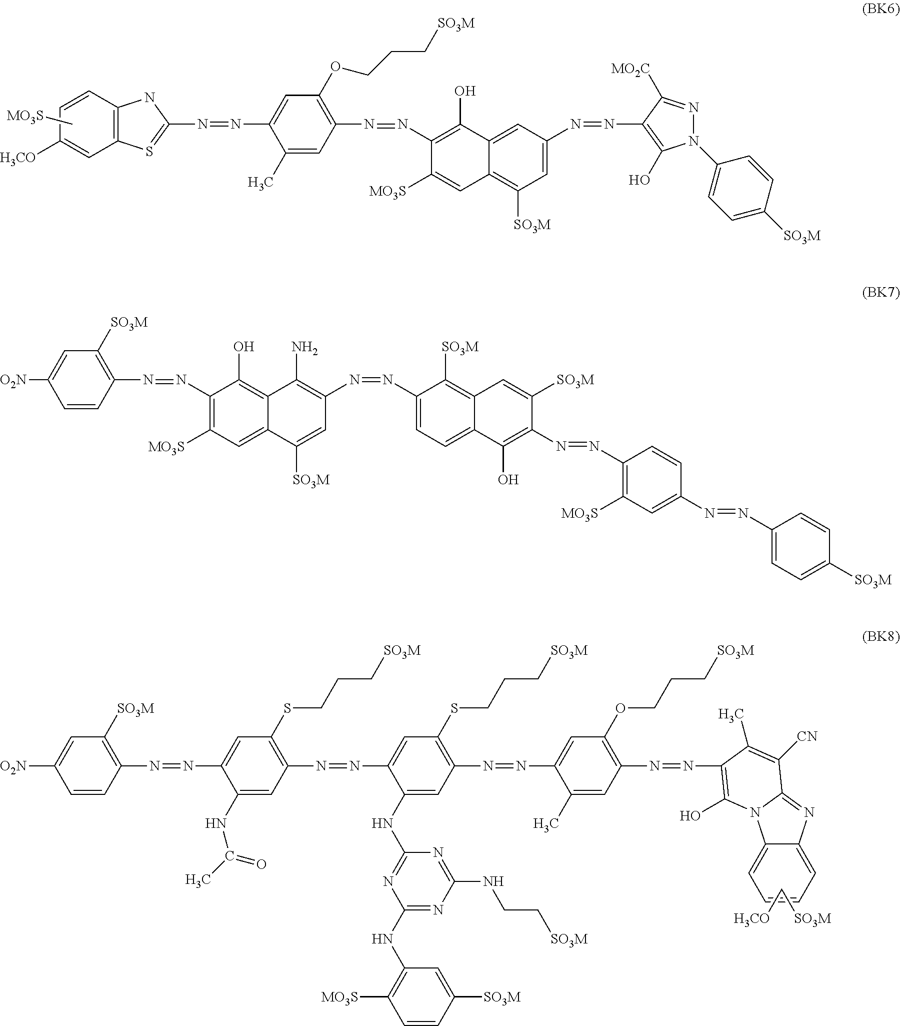

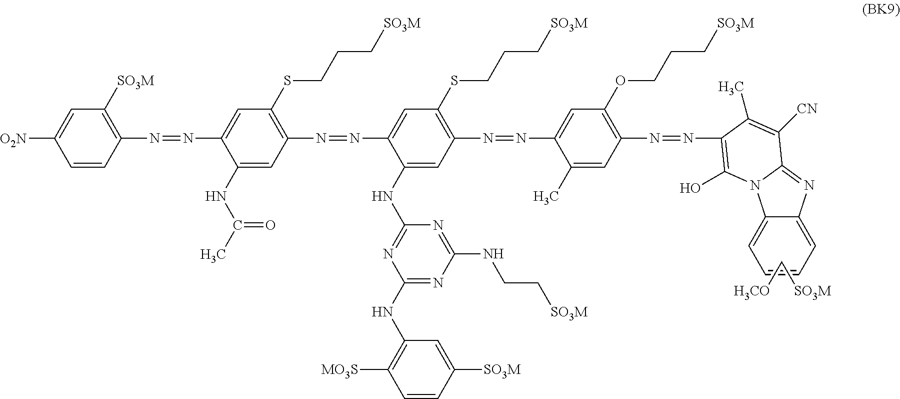

In the general formulae (BK1) to (BK9), each M independently represents a hydrogen atom, a lithium ion, a sodium ion, a potassium ion, or an ammonium ion.

In the general formulae (BK1) to (BK9), M preferably represents a lithium ion or a sodium ion.

The black ink composition particularly preferably includes at least one compound selected from the group BKA below. The group BKA is a group consisting of compounds (BKA1) to (BKA9).

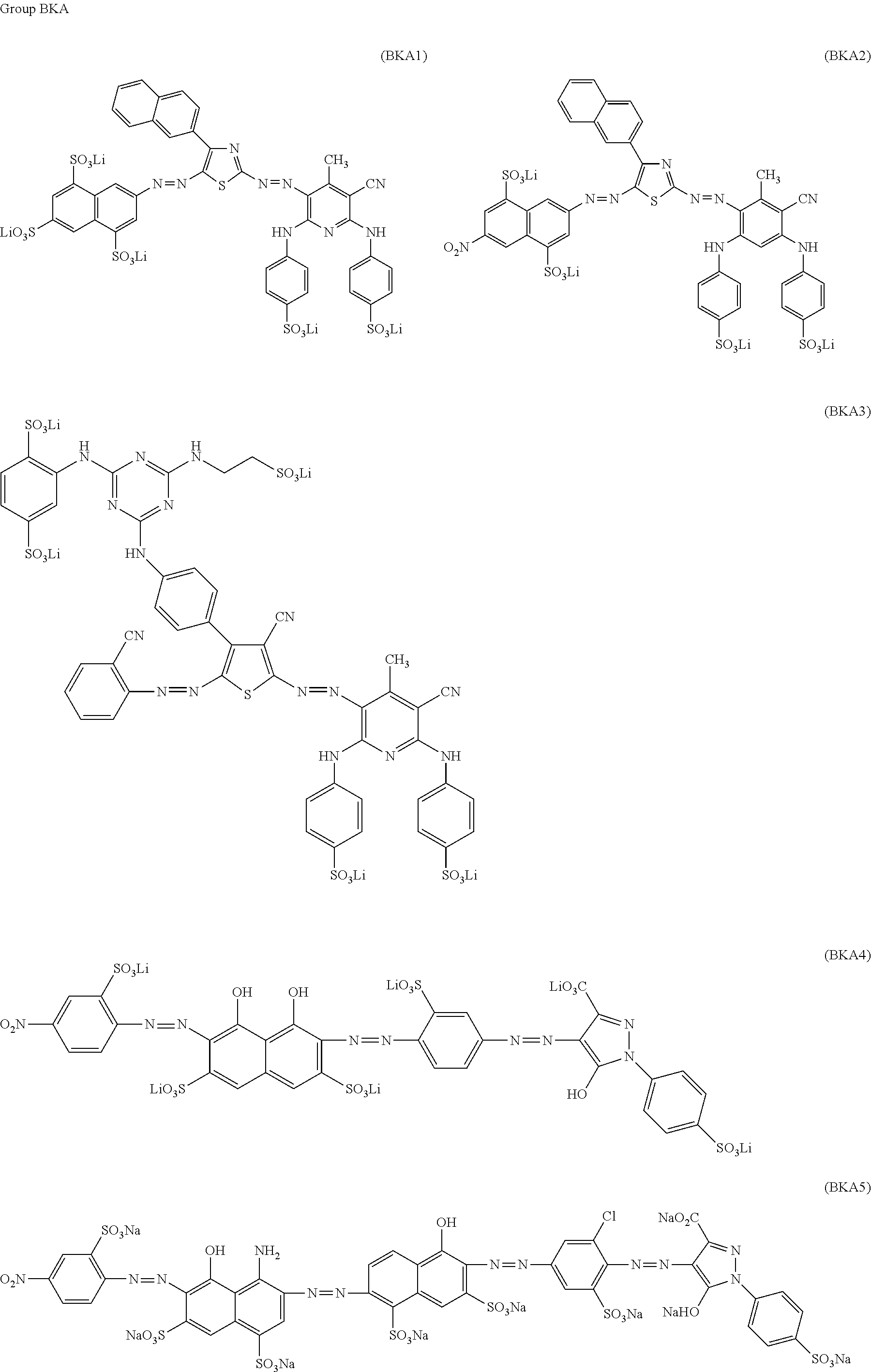

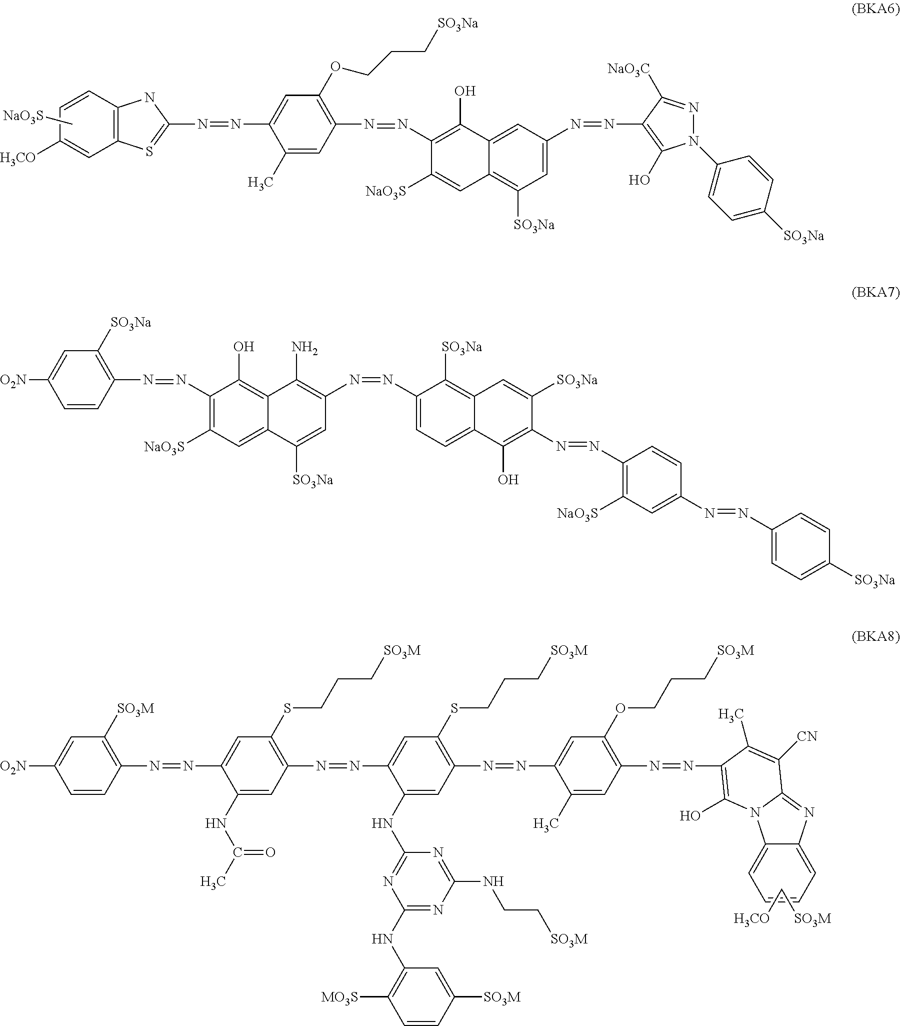

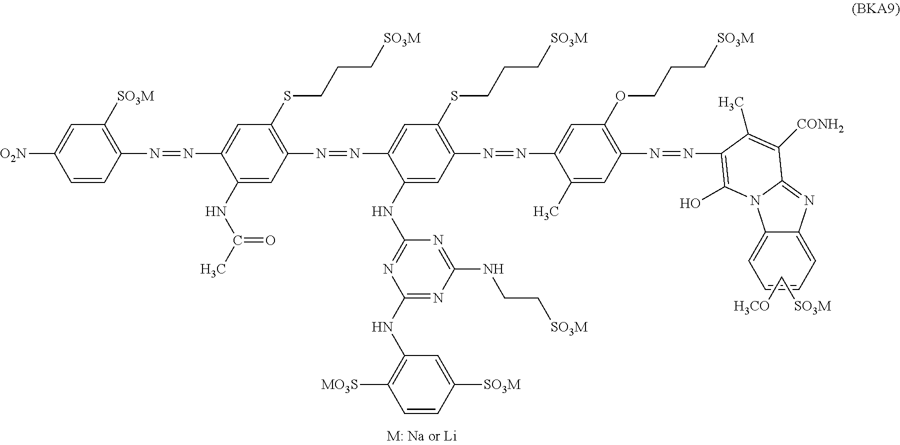

The black ink composition particularly preferably contains at least one compound selected from the compounds (BKA1), (BKA2), and (BKA3).

The black ink composition may further contain, in addition to the at least one compound (black dye) selected from the group BK, a yellow, orange, red, or violet dye as a toning dye in a combined manner from the viewpoints of the adjustment of a color tone or the color balance of a black image faded from neutral gray. The dye that can be used in combination for toning is preferably at least one dye selected from a toning dye 1, a toning dye 2, a toning dye 3, a toning dye 4, and a toning dye 5 having structures below from the viewpoints of the color tone as a black ink composition and the fading balance resulting from the combination with a black dye and particularly preferably at least one of the toning dye 1 or the toning dye 2.

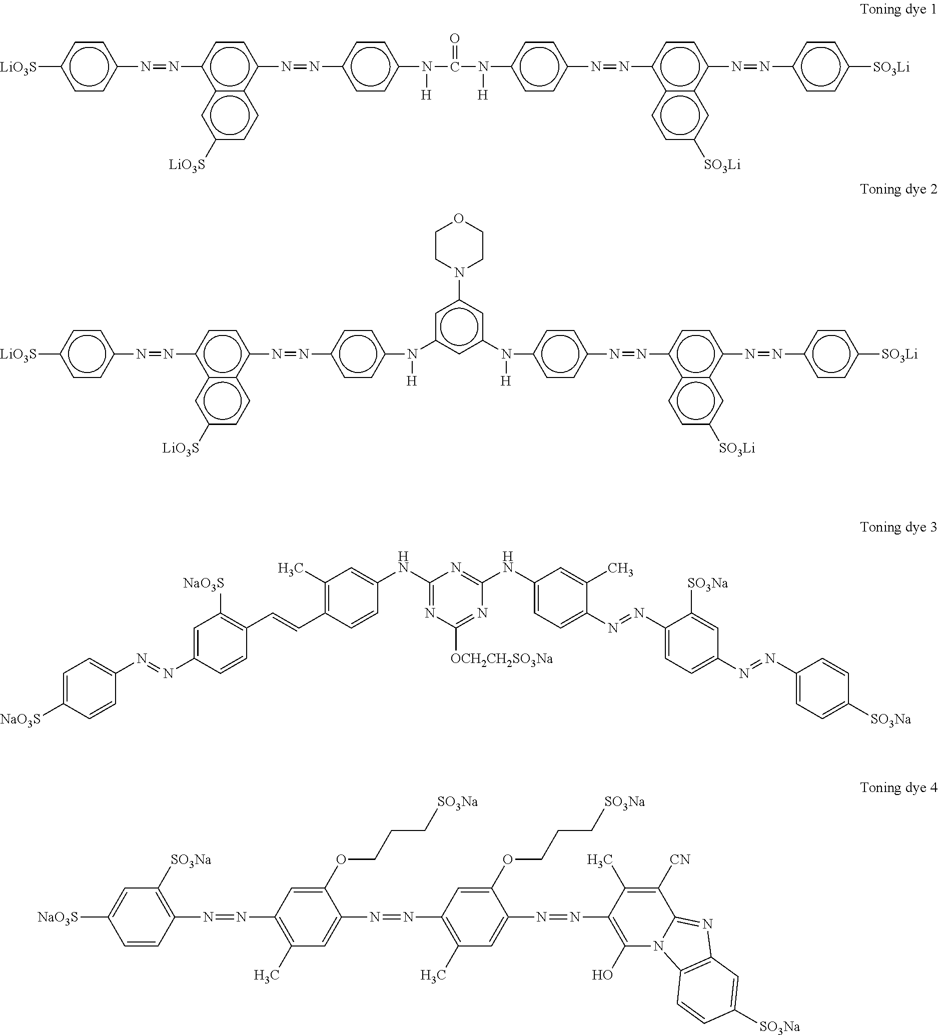

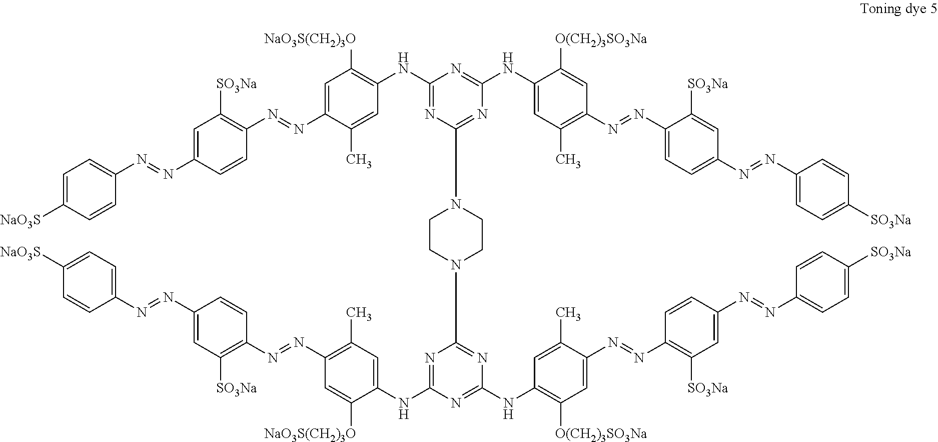

Toning dyes that can be used for the black ink composition in combination in addition to the toning dyes 1 to 5 are listed below as examples, but are not limited thereto.
C.I. Direct Yellow: 9, 11, 28, 29, 35, 39, 41, 53, 59, 68, 86, 87, 93, 95, 96, 106, 108, 109, 122, 130, 132, 142, 144, 161, 163
C.I. Acid Yellow: 19, 39, 49, 50, 61, 64, 79, 110, 127, 135, 143, 151, 159, 169, 174, 190, 195, 196, 197, 199, 218, 219, 222, 227
C.I. Reactive Yellow: 2, 3, 13, 14, 15, 17, 18, 23, 24, 25, 26, 27, 29, 35, 37, 41, 42
C.I. Basic Yellow: 1, 2, 4, 11, 13, 14, 15, 19, 21, 23, 24, 25, 28, 29, 32, 36, 39, 40

The content (mass %) of the compound selected from the group BK in the black ink composition is preferably 1.0 mass % or more and 10.0 mass % or less, more preferably 2.0 mass % or more and 7.0 mass % or less, further preferably 3.5 mass % or more and 6.0 mass % or less, and most preferably 4.0 mass % or more and 5.0 mass % or less with respect to the total mass of the black ink composition.

When the black ink composition further contains, in addition to the compound selected from the group BK, a colorant other than the compound selected from the group BK, the total content (mass %) of all colorants in the black ink composition is preferably 1.0 mass % or more and 10.0 mass % or less, more preferably 3.0 mass % or more and 7.0 mass % or less, further preferably 3.5 mass % or more and 6.0 mass % or less, and most preferably 4.0 mass % or more and 6.0 mass % or less with respect to the total mass of the black ink composition.

The ink set according to an embodiment of the present invention may be used for an ink jet recording method by combining the magenta ink composition, the cyan ink composition, the yellow ink composition, and the black ink composition with another ink composition. Such an ink composition can be used by combining ink compositions (light ink compositions) having the same hue as each ink constituting the ink set according to an embodiment of the present invention and having a relatively low colorant content, such as a light cyan ink composition, a light magenta ink composition, and a light yellow ink composition. By using light ink compositions in combination, the image granularity can be suppressed.

### Aqueous Medium

Each ink composition constituting the ink set according to an embodiment of the present invention may contain an aqueous medium that is a mixed solvent of water and a water-soluble organic solvent. Water is preferably deionized water (ion-exchanged water). The content (mass %) of the water in each ink composition is preferably 10.0 mass % or more and 90.0 mass % or less with respect to the total mass of the corresponding ink composition. The content (mass %) of the water-soluble organic solvent in each ink composition is preferably 3.0 mass % or more and 50.0 mass % or less and more preferably 15.0 mass % or more and 40.0 mass % or less with respect to the total mass of the corresponding ink composition. Any publicly known water-soluble organic solvent may be used as long as the water-soluble organic solvent can be typically used for ink jet inks. The ink composition may contain one or more water-soluble organic solvents in combination. Specific examples of the water-soluble organic solvent include monohydric or polyhydric alcohols, alkylene glycols having an alkylene group with about 1 to 4 carbon atoms, polyethylene glycols having an average molecular weight of about 200 to 2,000, glycol ethers, and nitrogen-containing compounds.

### Other Additives

Each of the ink compositions constituting the ink set according to an embodiment of the present invention may contain water-soluble organic compounds that are solid at room temperature, for example, polyhydric alcohols such as trimethylolpropane and trimethylolethane, urea derivatives such as urea and ethylene urea, and saccharides and derivatives thereof. Each of the ink compositions constituting the ink set according to an embodiment of the present invention may further optionally contain various additives such as a surfactant, a pH adjuster, an anticorrosive, a preservative, a fungicide, an antioxidant, a reducing inhibitor, an evaporation accelerator, a chelating agent, an anti-foaming agent, and a water-soluble polymer. In the present invention, an acetylene glycol surfactant is preferably used. In particular, an ethylene oxide adduct of acetylene glycol is suitable because of its high solubility in an aqueous medium.

The ink set according to an embodiment of the present invention can be particularly suitably used for ink jet printing. The form of the ink set according to an embodiment of the present invention includes a set of ink cartridges each independently contain the corresponding ink composition and an integrated ink cartridge including a plurality of ink containers that each contain the corresponding ink composition. The ink set according to an embodiment of the present invention is not limited to the above form, and may have any form as long as the magenta ink composition, the cyan ink composition, the yellow ink composition, and the black ink composition can be used in combination.

When an image (in particular, a photographic image) is printed using the ink set according to an embodiment of the present invention, a gray to black image can be formed by mixing colors of the yellow ink composition, the magenta ink composition, and the cyan ink composition instead of the black ink composition.

### Physical Properties of Ink Composition

The surface tension at 25° C. of each ink composition constituting the ink set according to an embodiment of the present invention is preferably 10 mN/m or more and 60 mN/m or less, more preferably 20 mN/m or more and 60 mN/m or less, and further preferably 30 mN/m or more and 40 mN/m or less. When each ink composition constituting the ink set according to an embodiment of the present invention has a surface tension within the above range, the occurrence of, for example, irregular ejection (missed landing of ink) due to wetting near ejection ports caused when the ink set is used for ink jet printing can be effectively suppressed. The surface tension of ink can be adjusted by appropriately determining the content of a surfactant or the like in the ink composition. Each ink composition constituting the ink set according to an embodiment of the present invention preferably has a desired pH such that good ejection characteristics are achieved when the ink composition is used for ink jet recording apparatuses. The viscosity at 25° C. of each ink composition constituting the ink set according to an embodiment of the present invention is preferably 1.0 mPa·s or more and 5.0 mPa·s or less.

### Ink Cartridge and Ink Jet Printer

The ink set according to an embodiment of the present invention can be used in the form of ink cartridges that integrally or independently contain the ink set. This is also preferred from the viewpoint of ease of handling. Such an ink cartridge including an ink set is publicly known in this technical field, and an ink cartridge can be made by appropriately using a publicly known method.

An ink jet printer according to an embodiment of the present invention includes the above ink cartridge.

The ink set or ink cartridge according to an embodiment of the present invention can be used for, for example, typical writing instruments, recorders, and pen plotters, but is particularly preferably used for an ink jet recording method.

### Ink Jet Recording Method and Ink Jet Recording Apparatus

The ink jet recording method according to an embodiment of the present invention includes an image recording step of ejecting each ink composition constituting the above-described ink set according to an embodiment of the present invention using an ink jet recording head to record an image on a recording medium. In the image recording step, the cyan ink composition, the magenta ink composition, the yellow ink composition, and the black ink composition constituting the above-described ink set according to an embodiment of the present invention are used. The ink jet recording apparatus according to an embodiment of the present invention includes an ink container that contains ink and a recording head configured to eject the ink. The ink contained in the ink container corresponds to the cyan ink composition, the magenta ink composition, the yellow ink composition, and the black ink composition constituting the above-described ink set according to an embodiment of the present invention. Except for use of the ink set according to an embodiment of the present invention, it suffices that the ink jet recording method includes publicly known steps and the recording apparatus has a publicly known configuration.

Any recording medium can be used for recording an image using each ink composition constituting the ink set according to an embodiment of the present invention as long as the recording medium can be used for typical ink jet recording. Examples of such a recording medium include ink jet recording media having a porous layer on a support, such as glossy paper, coated paper, and glossy films; and plain paper in which fibers are exposed on at least part of the surface, such as so-called copy paper. In the present invention, a recording medium including a porous layer to which a colorant is adsorbed (e.g., glossy recording medium) is preferably used to achieve high quality of recorded images.

### Recorded Article

A recorded article obtained by using the ink set according to an embodiment of the present invention has high optical density, reduced bronze luster, high ozone resistance, high light resistance, and high moisture resistance for single-color images and also has high optical density, reduced bronze luster, high ozone resistance, high light resistance, high moisture resistance, and high contrast for mixed-color images.

### EXAMPLES

### Example 1

### Preparation of Magenta Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous sodium hydroxide solution, and filtration was performed under reduced pressure using a microfilter having an average pore size of 0.20 μm to prepare a magenta ink composition. The magenta dye (M-1) used is the above-described compound.

| | | |
|---|---|---|
| Magenta dye (M-1) | 3.0 | g |
| Proxel XLII (preservative, manufactured by LONZA) | 0.11 | g |
| Glycerol | 7.0 | g |
| Ethylene urea | 7.0 | g |
| 1,5-Pentanediol | 7.0 | g |
| 2-Pyrrolidone | 5.0 | g |
| Surfynol (manufactured by Air Products and Chemicals, Inc.) | 0.50 | g |

### Preparation of Cyan Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous lithium hydroxide solution, and filtration was performed under reduced pressure using a microfilter having an average pore size of 0.25 μm to prepare a cyan ink composition. The cyan dye (C-1) used is the above-described compound.

| | | |
|---|---|---|
| Cyan dye (C-1) | 4.0 | g |
| Proxel XLII (preservative, manufactured by LONZA) | 0.11 | g |
| Glycerol | 7.0 | g |
| Ethylene urea | 7.0 | g |
| 1,5-Pentanediol | 7.0 | g |
| 2-Pyrrolidone | 5.0 | g |
| Surfynol (manufactured by Air Products and Chemicals, Inc.) | 0.50 | g |

### Preparation of Yellow Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous potassium hydroxide solution, and filtration was performed under reduced pressure using a microfilter having an average pore size of 0.25 μm to prepare a yellow ink composition. The yellow dye (YA9-1) used is the above-described compound.

| | | |
|---|---|---|
| Yellow dye (YA9-1) | 5.0 | g |
| Proxel XLII (preservative, manufactured by LONZA) | 0.11 | g |
| Glycerol | 7.0 | g |
| Ethylene urea | 7.0 | g |
| 1,5-Pentanediol | 7.0 | g |
| 2-Pyrrolidone | 5.0 | g |
| Surfynol (manufactured by Air Products and Chemicals, Inc.) | 0.50 | g |

### Preparation of Black Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous lithium hydroxide solution, and filtration was performed under reduced pressure using a microfilter having an average pore size of 0.25 μm to prepare a black ink composition 1. The black dye (BKA1) used and the toning dye 1 used are above-described compounds.

| | | |
|---|---|---|
| Black dye (BKA1) | 3.5 | g |
| Toning dye 1 | 1.5 | g |
| Proxel XLII (preservative, manufactured by LONZA) | 0.11 | g |
| Glycerol | 7.0 | g |
| Ethylene urea | 7.0 | g |
| 1,5-Pentanediol | 7.0 | g |
| 2-Pyrrolidone | 5.0 | g |
| Surfynol (manufactured by Air Products and Chemicals, Inc.) | 0.50 | g |

### Production of Ink Set

An ink set in Example 1 was produced that was constituted by the prepared magenta ink composition, cyan ink composition, yellow ink composition, and black ink composition.

### Examples 2 to 30 and Comparative Examples 1 to 10

Each ink composition was prepared and an ink set was produced in the same manner as in Example 1, except that in the preparation of the magenta ink composition, the cyan ink composition, the yellow ink composition, and the black ink composition, the dyes used and the amounts of dyes added were changed to those listed in Tables 1 to 3.

The aqueous alkali solution (aqueous MOH solution) used when the pH of each ink composition was adjusted was selected so as to correspond to the countercation M (e.g., lithium cation, sodium cation, and potassium cation) of an ionic hydrophilic group in the dye used.

In Examples and Comparative Examples, the compounds (M-1), (M-2), (M-3), (M-5), (M-6), (M-7), and (M-8), the magenta dye 1, the magenta dye 2, the magenta dye 3, the magenta dye 4, the magenta dye 5, the magenta dye 6, the magenta dye 7, the magenta dye 8, the magenta dye 9, the magenta dye 10, the magenta dye 11, and the magenta dye 12 that were used as magenta dyes; the compounds (C-1), (C-2), (C-3), (C-12), (C-21), and (C-22), the cyan dye 4, the cyan dye 9, the cyan dye 10, and the cyan dye 11 that were used as cyan dyes; the compounds (YA1), (YA2), (YA3), (YA5), (YA8), (YA9-1), and (YA9-2), and the yellow dye 1 that were used as yellow dyes; the compounds (BKA1), (BKA2), (BKA5), (BKA6), (BKA7), (BKA8), and (BKA9) that were used as black dyes; and the toning dye 1, the toning dye 2, and the toning dye 3 that were used as toning dyes are the above-described compounds.

TABLE 1

| | Magenta ink | Cyan ink | Yellow ink | | |
|---|---|---|---|---|---|
| | composition | composition | composition | Black ink composition | |
| | Magenta dye | Cyan dye | Yellow dye | Black dye | Toning dye |
| | (amount) | (amount) | (amount) | (amount) | (amount) |
| Example 1 | (M-1) (3.0 g) | (C-1) (4.0 g) | (YA9-1) (5.0 g) | (BKA1) (3.5 g) | Toning dye 1 |
| | | | | | (1.5 g) |
| Example 2 | (M-1) (3.0 g) | (C-2) (4.0 g) | (YA9-1) (5.0 g) | (BKA1) (3.5 g) | Toning dye 1 |
| | | | | | (1.5 g) |
| Example 3 | (M-1) (3.0 g) | (C-3) (3.6 g) | (YA9-1) (5.0 g) | (BKA1) (3.5 g) | Toning dye 1 |
| | | (C-22) (0.4 g) | | | (1.5 g) |
| Example 4 | (M-2) (3.0 g) | (C-1) (4.0 g) | (YA9-1) (5.0 g) | (BKA1) (3.5 g) | Toning dye 1 |
| | | | | | (1.5 g) |
| Example 5 | (M-2) (3.0 g) | (C-2) (4.0 g) | (YA9-1) (5.0 g) | (BKA1) (3.5 g) | Toning dye 1 |
| | | | | | (1.5 g) |
| Example 6 | (M-2) (3.0 g) | (C-3) (3.6 g) | (YA9-1) (5.0 g) | (BKA1) (3.5 g) | Toning dye 1 |
| | | (C-22) (0.4 g) | | | (1.5 g) |
| Example 7 | (M-2) (3.0 g) | (C-1) (3.6 g) | (YA9-1) (5.0 g) | (BKA1) (3.5 g) | Toning dye 1 |
| | | Cyan dye 9 | | | (1.5 g) |
| | | (0.4 g) | | | |
| Example 8 | (M-2) (3.0 g) | (C-1) (3.6 g) | (YA9-1) (5.0 g) | (BKA1) (3.5 g) | Toning dye 1 |
| | | Cyan dye 10 | | | (1.5 g) |
| | | (0.4 g) | | | |
| Example 9 | (M-2) (3.0 g) | (C-1) (3.6 g) | (YA9-1) (5.0 g) | (BKA1) (3.5 g) | Toning dye 1 |
| | | Cyan dye 11 | | | (1.5 g) |
| | | (0.4 g) | | | |
| Example 10 | (M-2) (3.0 g) | (C-1) (3.6 g) | (YA9-1) (5.0 g) | (BKA1) (3.5 g) | Toning dye 1 |
| | | C.I. Acid Blue 9 | | | (1.5 g) |
| | | (0.4 g) | | | |
| Example 11 | (M-2) (3.0 g) | (C-2) (3.6 g) | (YA9-1) (5.0 g) | (BKA1) (3.5 g) | Toning dye 1 |
| | | C.I. Acid Blue 9 | | | (1.5 g) |
| | | (0.4 g) | | | |
| Example 12 | (M-2) (3.0 g) | (C-3) (3.6 g) | (YA9-1) (5.0 g) | (BKA1) (3.5 g) | Toning dye 1 |
| | | (C-22) (0.2 g) | | | (1.5 g) |
| | | C.I. Acid Blue 9 | | | |
| | | (0.2 g) | | | |
| Example 13 | (M-2) (3.0 g) | (C-1) (4.0 g) | (YA9-1) (5.0 g) | (BKA2) (3.5 g) | Toning dye 1 |
| | | | | | (1.5 g) |
| Example 14 | (M-2) (3.0 g) | (C-1) (4.0 g) | (YA8) (1.0 g) | (BKA1) (3.5 g) | Toning dye 1 |
| | | | (YA9-1) (4.0 g) | | (1.5 g) |
| Example 15 | (M-2) (3.0 g) | (C-1) (4.0 g) | (YA8) (1.0 g) | (BKA2) (3.5 g) | Toning dye 1 |
| | | | (YA9-1) (4.0 g) | | (1.5 g) |

TABLE 2

| | Magenta ink | Cyan ink | Yellow ink | | |
|---|---|---|---|---|---|
| | composition | composition | composition | Black ink composition | |
| | Magenta dye | Cyan dye | Yellow dye | Black dye | Toning dye |
| | (amount) | (amount) | (amount) | (amount) | (amount) |
| Example 16 | (M-2) (3.0 g) | (C-1) (4.0 g) | (YA8) (1.0 g) | (BKA2) (3.5 g) | Toning dye 2 |
| | | | (YA9-1) (4.0 g) | | (1.5 g) |
| Example 17 | (M-2) (3.0 g) | (C-1) (4.0 g) | (YA9-1) (4.0 g) | (BKA1) (3.5 g) | Toning dye 1 |
| | | | (YA1) (1.0 g) | | (1.5 g) |
| Example 18 | (M-2) (3.0 g) | (C-1) (4.0 g) | (YA9-1) (4.0 g) | (BKA1) (3.5 g) | Toning dye 1 |
| | | | (YA2) (1.0 g) | | (1.5 g) |
| Example 19 | (M-2) (3.0 g) | (C-1) (4.0 g) | (YA9-1) (4.0 g) | (BKA1) (3.5 g) | Toning dye 1 |
| | | | (YA3) (1.0 g) | | (1.5 g) |
| Example 20 | (M-2) (3.0 g) | (C-1) (4.0 g) | (YA9-1) (4.0 g) | (BKA1) (3.5 g) | Toning dye 1 |
| | | | (YA5) (1.0 g) | | (1.5 g) |
| Example 21 | (M-3) (3.0 g) | (C-1) (4.0 g) | (YA9-1) (5.0 g) | (BKA1) (3.5 g) | Toning dye 1 |
| | | | | | (1.5 g) |
| Example 22 | (M-3) (3.0 g) | (C-2) (4.0 g) | (YA9-1) (5.0 g) | (BKA1) (3.5 g) | Toning dye 1 |
| | | | | | (1.5 g) |
| Example 23 | (M-3) (3.0 g) | (C-3) (3.6 g) | (YA9-1) (5.0 g) | (BKA1) (3.5 g) | Toning dye 1 |
| | | (C-22) (0.4 g) | | | (1.5 g) |
| Example 24 | (M-3) (3.0 g) | (C-1) (4.0 g) | (YA8) (1.0 g) | (BKA1) (3.5 g) | Toning dye 1 |
| | | | (YA9-1) (4.0 g) | | (1.5 g) |
| Example 25 | (M-5) (3.0 g) | (C-1) (4.0 g) | (YA9-2) (5.0 g) | (BKA1) (3.5 g) | Toning dye 1 |
| | | | | | (1.5 g) |
| Example 26 | (M-5) (3.0 g) | (C-2) (4.0 g) | (YA9-2) (5.0 g) | (BKA1) (3.5 g) | Toning dye 1 |
| | | | | | (1.5 g) |
| Example 27 | (M-5) (3.0 g) | (C-3) (3.6 g) | (YA9-2) (5.0 g) | (BKA1) (3.5 g) | Toning dye 1 |
| | | (C-21) (0.4 g) | | | (1.5 g) |
| Example 28 | (M-6) (3.0 g) | (C-1) (4.0 g) | (YA9-1) (5.0 g) | (BKA1) (3.5 g) | Toning dye 1 |
| | | | | | (1.5 g) |
| Example 29 | (M-7) (3.0 g) | (C-1) (4.0 g) | (YA9-1) (5.0 g) | (BKA1) (3.5 g) | Toning dye 1 |
| | | | | | (1.5 g) |
| Example 30 | (M-8) (3.0 g) | (C-1) (4.0 g) | (YA9-1) (5.0 g) | (BKA1) (3.5 g) | Toning dye 1 |
| | | | | | (1.5 g) |

TABLE 3

| | Magenta ink | Cyan ink | Yellow ink | | |
|---|---|---|---|---|---|
| | composition | composition | composition | Black ink composition | |
| | Magenta dye | Cyan dye | Yellow dye | Black dye | Toning dye |
| | (amount) | (amount) | (amount) | (amount) | (amount) |
| Comparative | Magenta dye 1 | (C-1) (4.0 g) | (YA9-1) (5.0 g) | (BKA1) (3.5 g) | Toning dye 1 |
| Example 1 | (3.0 g) | | | | (1.5 g) |
| Comparative | Magenta dye 2 | (C-1) (4.0 g) | (YA9-1) (5.0 g) | (BKA1) (3.5 g) | Toning dye 1 |
| Example 2 | (3.0 g) | | | | (1.5 g) |
| Comparative | Magenta dye 3 | (C-1) (4.0 g) | (YA9-1) (5.0 g) | (BKA1) (3.5 g) | Toning dye 1 |
| Example 3 | (3.0 g) | | | | (1.5 g) |
| Comparative | Magenta dye 6 | (C-1) (4.0 g) | (YA9-1) (5.0 g) | (BKA1) (3.5 g) | Toning dye 1 |
| Example 4 | (3.0 g) | | | | (1.5 g) |
| Comparative | Magenta dye 7 | (C-1) (4.0 g) | (YA9-1) (5.0 g) | (BKA1) (3.5 g) | Toning dye 1 |
| Example 5 | (3.0 g) | | | | (1.5 g) |
| Comparative | Magenta dye 8 | (C-1) (4.0 g) | (YA9-1) (5.0 g) | (BKA1) (3.5 g) | Toning dye 1 |
| Example 6 | (3.0 g) | | | | (1.5 g) |
| Comparative | Magenta dye 9 | (C-1) (4.0 g) | (YA9-1) (5.0 g) | (BKA1) (3.5 g) | Toning dye 1 |
| Example 7 | (3.0 g) | | | | (1.5 g) |
| Comparative | Magenta dye 10 | (C-1) (4.0 g) | (YA9-1) (5.0 g) | (BKA1) (3.5 g) | Toning dye 1 |
| Example 8 | (3.0 g) | | | | (1.5 g) |
| Comparative | Magenta dye 11 | (C-1) (4.0 g) | (YA9-1) (5.0 g) | (BKA1) (3.5 g) | Toning dye 1 |
| Example 9 | (3.0 g) | | | | (1.5 g) |
| Comparative | Magenta dye 12 | (C-1) (4.0 g) | (YA9-1) (5.0 g) | (BKA1) (3.5 g) | Toning dye 1 |
| Example 10 | (3.0 g) | | | | (1.5 g) |

### Example 31

### Preparation of Magenta Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous sodium hydroxide solution, and filtration was performed under reduced pressure using a microfilter having an average pore size of 0.25 m to prepare a magenta ink composition.

| | | |
|---|---|---|
| Magenta dye (M-1) | 3.0 | g |
| Proxel XLII (preservative, manufactured by LONZA) | 0.11 | g |
| Glycerol | 10 | g |
| Triethylene glycol | 2.0 | g |
| Triethylene glycol monobutyl ether | 10 | g |
| 2-Pyrrolidone | 2.0 | g |
| Surfynol (manufactured by Air Products and Chemicals, Inc.) | 1.0 | g |
| 20 mass % aqueous solution of compound W | 10 | g |

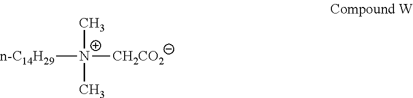

### Preparation of Cyan Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous lithium hydroxide solution, and filtration was performed under reduced pressure using a microfilter having an average pore size of 0.25 m to prepare a cyan ink composition.

| | | |
|---|---|---|
| Cyan dye (C-1) | 4.0 | g |
| Proxel XLII (preservative, manufactured by LONZA) | 0.11 | g |
| Glycerol | 10 | g |
| Triethylene glycol | 2.0 | g |
| Triethylene glycol monobutyl ether | 10 | g |
| 2-Pyrrolidone | 2.0 | g |
| Surfynol (manufactured by Air Products and Chemicals, Inc.) | 1.0 | g |

### Preparation of Yellow Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous potassium hydroxide solution, and filtration was performed under reduced pressure using a microfilter having an average pore size of 0.25 μm to prepare a yellow ink composition.

| | | |
|---|---|---|
| Yellow dye (YA9-1) | 5.0 | g |
| Proxel XLII (preservative, manufactured by LONZA) | 0.11 | g |
| Glycerol | 10 | g |
| Triethylene glycol | 2.0 | g |
| Triethylene glycol monobutyl ether | 10 | g |
| 2-Pyrrolidone | 2.0 | g |
| Surfynol (manufactured by Air Products and Chemicals, Inc.) | 1.0 | g |

### Preparation of Black Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous lithium hydroxide solution, and filtration was performed under reduced pressure using a microfilter having an average pore size of 0.25 m to prepare a black ink composition.

| | | |
|---|---|---|
| Black dye (BKA1) | 3.5 | g |
| Toning dye 1 | 1.5 | g |
| Proxel XLII (preservative, manufactured by LONZA) | 0.11 | g |
| Glycerol | 10 | g |
| Triethylene glycol | 2.0 | g |
| Triethylene glycol monobutyl ether | 10 | g |
| 2-Pyrrolidone | 2.0 | g |
| Surfynol (manufactured by Air Products and Chemicals, Inc.) | 1.0 | g |

### Production of Ink Set

An ink set in Example 31 was produced that was constituted by the prepared magenta ink composition, cyan ink composition, yellow ink composition, and black ink composition.

### Examples 32 to 60, Comparative Examples 11 to 20, and Comparative Examples 2X and 2Y

Each ink composition was prepared and an ink set was produced in the same manner as in Example 31, except that in the preparation of the magenta ink composition, the cyan ink composition, the yellow ink composition, and the black ink composition, the dyes used and the amounts of dyes added were changed to those listed in Tables 4 to 6.

The aqueous alkali solution (aqueous MOH solution) used when the pH of each ink composition was adjusted was selected so as to correspond to the countercation M (e.g., lithium cation, sodium cation, and potassium cation) of an ionic hydrophilic group in the dye used.

In Table 4, the “aqueous solution W” refers to the above-described “20 mass % aqueous solution of compound W”. Furthermore, “-” in the “amount of aqueous solution W added” indicates “the aqueous solution W was not added”.

TABLE 4

| | Magenta ink composition | | | | | |
|---|---|---|---|---|---|---|
| | | Amount of | Cyan ink | Yellow ink | | |
| | | aqueous | composition | composition | Black ink composition | |
| | Magenta dye | solution W | Cyan dye | Yellow dye | Black dye | Toning dye |
| | (amount) | added | (amount) | (amount) | (amount) | (amount) |
| Example 31 | (M-1) (3.0 g) | 10 g | (C-1) (4.0 g) | (YA9-1) (5.0 g) | (BKA1) (3.5 g) | Toning |
| | | | | | | dye 1 (1.5 g) |
| Example 32 | (M-1) (3.0 g) | — | (C-1) (4.0 g) | (YA9-1) (5.0 g) | (BKA1) (3.5 g) | Toning |
| | | | | | | dye 1 (1.5 g) |
| Example 33 | (M-1) (3.0 g) | 10 g | (C-3) (3.6 g) | (YA9-1) (5.0 g) | (BKA1) (3.5 g) | Toning |
| | | | (C-22) (0.4 g) | | | dye 1 (1.5 g) |
| Example 34 | (M-2) (3.0 g) | — | (C-1) (4.0 g) | (YA9-1) (5.0 g) | (BKA1) (3.5 g) | Toning |
| | | | | | | dye 1 (1.5 g) |
| Example 35 | (M-2) (3.0 g) | — | (C-2) (4.0 g) | (YA9-1) (5.0 g) | (BKA1) (3.5 g) | Toning |
| | | | | | | dye 1 (1.5 g) |
| Example 36 | (M-2) (3.0 g) | — | (C-3) (3.6 g) | (YA9-1) (5.0 g) | (BKA1) (3.5 g) | Toning |
| | | | (C-22) (0.4 g) | | | dye 1 (1.5 g) |
| Example 37 | (M-2) (3.0 g) | — | (C-1) (3.6 g) | (YA9-1) (5.0 g) | (BKA1) (3.5 g) | Toning |
| | | | Cyan dye 9 (0.4 g) | | | dye 1 (1.5 g) |
| Example 38 | (M-2) (3.0 g) | — | (C-1) (3.6 g) | (YA9-1) (5.0 g) | (BKA1) (3.5 g) | Toning |
| | | | Cyan dye 10 (0.4 g) | | | dye 1 (1.5 g) |
| Example 39 | (M-2) (3.0 g) | — | (C-1) (3.6 g) | (YA9-1) (5.0 g) | (BKA1) (3.5 g) | Toning |
| | | | Cyan dye 11 (0.4 g) | | | dye 1 (1.5 g) |
| Example 40 | (M-2) (3.0 g) | — | (C-1) (3.6 g) | (YA9-1) (5.0 g) | (BKA1) (3.5 g) | Toning |
| | | | C.I. Acid | | | dye 1 (1.5 g) |
| | | | Blue 9 (0.4 g) | | | |
| Example 41 | (M-2) (3.0 g) | — | (C-2) (3.6 g) | (YA9-1) (5.0 g) | (BKA1) (3.5 g) | Toning |
| | | | C.I. Acid | | | dye 1 (1.5 g) |
| | | | Blue 9 (0.4 g) | | | |
| Example 42 | (M-2) (3.0 g) | — | (C-3) (3.2 g) | (YA9-1) (5.0 g) | (BKA1) (3.5 g) | Toning |
| | | | (C-22) (0.4 g) | | | dye 1 (1.5 g) |
| | | | C.I. Acid | | | |
| | | | Blue 9 (0.4 g) | | | |
| Example 43 | (M-2) (3.0 g) | — | (C-1) (4.0 g) | (YA9-1) (5.0 g) | (BKA2) (3.5 g) | Toning |
| | | | | | | dye 1 (1.5 g) |
| Example 44 | (M-2) (3.0 g) | — | (C-1) (4.0 g) | (YA8) (1.0 g) | (BKA1) (3.5 g) | Toning |
| | | | | (YA9-1) (4.0 g) | | dye 1 (1.5 g) |
| Example 45 | (M-2) (3.0 g) | — | (C-1) (4.0 g) | (YA8) (1.0 g) | (BKA2) (3.5 g) | Toning |
| | | | | (YA9-1) (4.0 g) | | dye 1 (1.5 g) |

TABLE 5

| | Magenta ink | Cyan ink | Yellow ink | | |
|---|---|---|---|---|---|
| | composition | composition | composition | Black ink composition | |
| | Magenta dye | Cyan dye | Yellow dye | Black dye | Toning dye |
| | (amount) | (amount) | (amount) | (amount) | (amount) |
| Example | (M-2) (3.0 g) | (C-1) (4.0 g) | (YA8) (1.0 g) | (BKA2) (3.5 g) | Toning dye 2 |
| 46 | | | (YA9-1) (4.0 g) | | (1.5 g) |
| Example | (M-2) (3.0 g) | (C-1) (4.0 g) | (YA9-1) (4.5 g) | (BKA1) (3.5 g) | Toning dye 1 |
| 47 | | | (YA1) (0.5 g) | | (1.5 g) |
| Example | (M-2) (3.0 g) | (C-1) (4.0 g) | (YA9-1) (4.5 g) | (BKA1) (3.5 g) | Toning dye 1 |
| 48 | | | (YA2) (0.5 g) | | (1.5 g) |
| Example | (M-2) (3.0 g) | (C-1) (4.0 g) | (YA9-1) (4.5 g) | (BKA1) (3.5 g) | Toning dye 1 |
| 49 | | | (YA3) (0.5 g) | | (1.5 g) |
| Example | (M-2) (3.0 g) | (C-1) (4.0 g) | (YA9-1) (4.0 g) | (BKA1) (3.5 g) | Toning dye 1 |
| 50 | | | (YA5) (1.0 g) | | (1.5 g) |
| Example | (M-3) (3.0 g) | (C-1) (4.0 g) | (YA9-1) (5.0 g) | (BKA1) (3.5 g) | Toning dye 1 |
| 51 | | | | | (1.5 g) |
| Example | (M-3) (3.0 g) | (C-2) (4.0 g) | (YA9-1) (5.0 g) | (BKA1) (3.5 g) | Toning dye 1 |
| 52 | | | | | (1.5 g) |
| Example | (M-3) (3.0 g) | (C-3) (3.6 g) | (YA9-1) (5.0 g) | (BKA1) (3.5 g) | Toning dye 1 |
| 53 | | (C-22) (0.4 g) | | | (1.5 g) |
| Example | (M-3) (3.0 g) | (C-1) (4.0 g) | (YA8) (1.0 g) | (BKA1) (3.5 g) | Toning dye 1 |
| 54 | | | (YA9-1) (4.0 g) | | (1.5 g) |
| Example | (M-5) (3.0 g) | (C-1) (4.0 g) | (YA9-2) (5.0 g) | (BKA1) (3.5 g) | Toning dye 1 |
| 55 | | | | | (1.5 g) |
| Example | (M-5) (3.0 g) | (C-2) (4.0 g) | (YA9-2) (5.0 g) | (BKA1) (3.5 g) | Toning dye 1 |
| 56 | | | | | (1.5 g) |
| Example | (M-5) (3.0 g) | (C-3) (3.6 g) | (YA9-2) (5.0 g) | (BKA1) (3.5 g) | Toning dye 1 |
| 57 | | (C-21) (0.4 g) | | | (1.5 g) |
| Example | (M-6) (3.0 g) | (C-1) (4.0 g) | (YA9-1) (5.0 g) | (BKA1) (3.5 g) | Toning dye 1 |
| 58 | | | | | (1.5 g) |
| Example | (M-7) (3.0 g) | (C-1) (4.0 g) | (YA9-1) (5.0 g) | (BKA1) (3.5 g) | Toning dye 1 |
| 59 | | | | | (1.5 g) |
| Example | (M-8) (3.0 g) | (C-1) (4.0 g) | (YA9-1) (5.0 g) | (BKA1) (3.5 g) | Toning dye 1 |
| 60 | | | | | (1.5 g) |

TABLE 6

| | Magenta ink | Cyan ink | Yellow ink | | |
|---|---|---|---|---|---|
| | composition | composition | composition | Black ink composition | |
| | Magenta dye | Cyan dye | Yellow dye | Black dye | Toning dye |
| | (amount) | (amount) | (amount) | (amount) | (amount) |
| Comparative | Magenta dye 1 | (C-1) (4.0 g) | (YA9-1) (5.0 g) | (BKA1) (3.5 g) | Toning dye 1 |
| Example 11 | (3-0 g) | | | | (1.5 g) |
| Comparative | Magenta dye 2 | (C-1) (4.0 g) | (YA9-1) (5.0 g) | (BKA1) (3.5 g) | Toning dye 1 |
| Example 12 | (3.0 g) | | | | (1.5 g) |
| Comparative | Magenta dye 4 | (C-1) (4.0 g) | (YA9-1) (5.0 g) | (BKA1) (3.5 g) | Toning dye 1 |
| Example 13 | (3.0 g) | | | | (1.5 g) |
| Comparative | Magenta dye 5 | (C-1) (4.0 g) | (YA9-1) (5.0 g) | (BKA1) (3.5 g) | Toning dye 1 |
| Example 14 | (3.0 g) | | | | (1.5 g) |
| Comparative | Magenta dye 7 | (C-1) (4.0 g) | (YA9-1) (5.0 g) | (BKA1) (3.5 g) | Toning dye 1 |
| Example 15 | (3.0 g) | | | | (1.5 g) |
| Comparative | Magenta dye 8 | (C-1) (4.0 g) | (YA9-1) (5.0 g) | (BKA1) (3.5 g) | Toning dye 1 |
| Example 16 | (3.0 g) | | | | (1.5 g) |
| Comparative | Magenta dye 9 | (C-1) (4.0 g) | (YA9-1) (5.0 g) | (BKA1) (3.5 g) | Toning dye 1 |
| Example 17 | (3.0 g) | | | | (1.5 g) |
| Comparative | Magenta dye 10 | (C-1) (4.0 g) | (YA9-1) (5.0 g) | (BKA1) (3.5 g) | Toning dye 1 |
| Example 18 | (3.0 g) | | | | (1.5 g) |
| Comparative | Magenta dye 11 | (C-1) (4.0 g) | (YA9-1) (5.0 g) | (BKA1) (3.5 g) | Toning dye 1 |
| Example 19 | (3.0 g) | | | | (1.5 g) |
| Comparative | Magenta dye 12 | (C-1) (4.0 g) | (YA9-1) (5.0 g) | (BKA1) (3.5 g) | Toning dye 1 |
| Example 20 | (3.0 g) | | | | (1.5 g) |
| Comparative | (M-2) (3.0 g) | C.I. DB-199 | (YA9-1) (5.0 g) | (BKA1) (3.5 g) | Toning dye 1 |
| Example 2X | | (4.0 g) | | | (1.5 g) |
| Comparative | (M-2) (3.0 g) | (C-1) (4.0 g) | Yellow dye 1 | (BKA1) (3.5 g) | Toning dye 1 |
| Example 2Y | | | (5.0 g) | | (1.5 g) |

C.I. DB-199 is C.I. Direct Blue 199.

### Example 61

An ink set in Example 61 was produced in the same manner as in Example 25, except that the magenta dye used for the magenta ink composition in Example 25 was changed from 3.0 g of the compound (M-5) to 2.5 g of the compound (M-5) and 0.5 g of the magenta dye 4.

### Example 62

An ink set in Example 62 was produced in the same manner as in Example 21, except that the magenta dye used for the magenta ink composition in Example 21 was changed from 3.0 g of the compound (M-3) to 2.5 g of the compound (M-3) and 0.5 g of the magenta dye 3.

### Example 63

An ink set in Example 63 was produced in the same manner as in Example 21, except that the magenta dye used for the magenta ink composition in Example 21 was changed from 3.0 g of the compound (M-3) to 2.5 g of the compound (M-3) and 0.5 g of the magenta dye 4.

### Example 64

An ink set in Example 64 was produced in the same manner as in Example 4, except that the magenta dye used for the magenta ink composition in Example 4 was changed from 3.0 g of the compound (M-2) to 2.5 g of the compound (M-2) and 0.5 g of the magenta dye 4.

### Example 65

An ink set in Example 65 was produced in the same manner as in Example 4, except that the magenta dye used for the magenta ink composition in Example 4 was changed from 3.0 g of the compound (M-2) to 2.5 g of the compound (M-2) and 0.5 g of the magenta dye 3.

### Example 66

An ink set in Example 66 was produced in the same manner as in Example 4, except that the magenta dye used for the magenta ink composition in Example 4 was changed from 3.0 g of the compound (M-2) to 2.7 g of the compound (M-2) and 0.3 g of the magenta dye 7.

### Example 67

An ink set in Example 67 was produced in the same manner as in Example 4, except that the magenta dye used for the magenta ink composition in Example 4 was changed from 3.0 g of the compound (M-2) to 2.5 g of the compound (M-2) and 0.5 g of the magenta dye 8.

### Example 68

An ink set in Example 68 was produced in the same manner as in Example 1, except that the magenta dye used for the magenta ink composition in Example 1 was changed from 3.0 g of the compound (M-1) to 2.5 g of the compound (M-2) and 0.5 g of the magenta dye 9.

### Example 69

An ink set in Example 69 was produced in the same manner as in Example 1, except that the magenta dye used for the magenta ink composition in Example 1 was changed from 3.0 g of the compound (M-1) to 2.5 g of the compound (M-2) and 0.5 g of the magenta dye 10.

### Example 70

An ink set in Example 70 was produced in the same manner as in Example 1, except that the magenta dye used for the magenta ink composition in Example 1 was changed from 3.0 g of the compound (M-1) to 2.7 g of the compound (M-1) and 0.3 g of the magenta dye 11.

### Example 71

An ink set in Example 71 was produced in the same manner as in Example 34, except that the magenta dye used for the magenta ink composition in Example 34 was changed from 3.0 g of the compound (M-2) to 2.5 g of the compound (M-2).

### Example 72

An ink set in Example 72 was produced in the same manner as in Example 34, except that the magenta dye used for the magenta ink composition in Example 34 was changed from 3.0 g of the compound (M-2) to 2.0 g of the compound (M-2).

### Example 73

An ink set in Example 73 was produced in the same manner as in Example 51, except that the magenta dye used for the magenta ink composition in Example 51 was changed from 3.0 g of the compound (M-3) to 2.5 g of the compound (M-3).

### Example 74

An ink set in Example 74 was produced in the same manner as in Example 51, except that the magenta dye used for the magenta ink composition in Example 51 was changed from 3.0 g of the compound (M-3) to 2.0 g of the compound (M-3).

### Example 75

An ink set in Example 75 was produced in the same manner as in Example 34, except that the cyan dye used for the cyan ink composition in Example 34 was changed from 4.0 g of the compound (C-1) to 3.5 g of the compound (C-1).

### Example 76

An ink set in Example 76 was produced in the same manner as in Example 34, except that the cyan dye used for the cyan ink composition in Example 34 was changed from 4.0 g of the compound (C-1) to 3.0 g of the compound (C-1).

### Example 77

An ink set in Example 77 was produced in the same manner as in Example 51, except that the cyan dye used for the cyan ink composition in Example 51 was changed from 4.0 g of the compound (C-1) to 3.5 g of the compound (C-1).

### Example 78

An ink set in Example 78 was produced in the same manner as in Example 51, except that the cyan dye used for the cyan ink composition in Example 51 was changed from 4.0 g of the compound (C-1) to 3.0 g of the compound (C-1).

### Example 79

An ink set in Example 79 was produced in the same manner as in Example 34, except that the yellow dye used for the yellow ink composition in Example 34 was changed from 5.0 g of the compound (YA9-1) to 4.5 g of the compound (YA9-1).

### Example 80

An ink set in Example 80 was produced in the same manner as in Example 34, except that the yellow dye used for the yellow ink composition in Example 34 was changed from 5.0 g of the compound (YA9-1) to 4.0 g of the compound (YA9-1).

### Comparative Example 21

An ink set in Comparative Example 21 was produced in the same manner as in Comparative Example 1, except that the magenta dye used for the magenta ink composition in Comparative Example 1 was changed from 3.0 g of the magenta dye 1 to 2.5 g of the magenta dye 1.

### Comparative Example 22

An ink set in Comparative Example 22 was produced in the same manner as in Comparative Example 1, except that the cyan dye used for the cyan ink composition in Comparative Example 1 was changed from 4.0 g of the compound (C-1) to 2.0 g of the compound (C-1).

### Comparative Example 23

An ink set in Comparative Example 23 was produced in the same manner as in Comparative Example 3, except that the magenta dye used for the magenta ink composition in Comparative Example 3 was changed from 3.0 g of the magenta dye 3 to 1.5 g of the magenta dye 3.

### Comparative Example 24

An ink set in Comparative Example 24 was produced in the same manner as in Comparative Example 4, except that the magenta dye used for the magenta ink composition in Comparative Example 4 was changed from 3.0 g of the magenta dye 6 to 2.5 g of the magenta dye 4.

### Comparative Example 25

An ink set in Comparative Example 25 was produced in the same manner as in Comparative Example 16, except that the magenta dye used for the magenta ink composition in Comparative Example 16 was changed from 3.0 g of the magenta dye 8 to 2.5 g of the magenta dye 8.

### Comparative Example 26

An ink set in Comparative Example 26 was produced in the same manner as in Comparative Example 19, except that the magenta dye used for the magenta ink composition in Comparative Example 19 was changed from 3.0 g of the magenta dye 11 to 2.5 g of the magenta dye 11.

### Comparative Example 27

An ink set in Comparative Example 27 was produced in the same manner as in Comparative Example 20, except that the magenta dye used for the magenta ink composition in Comparative Example 20 was changed from 3.0 g of the magenta dye 12 to 2.5 g of the magenta dye 12.

### Comparative Example 28

An ink set in Comparative Example 28 was produced in the same manner as in Comparative Example 9, except that the magenta dye used for the magenta ink composition in Comparative Example 9 was changed from 3.0 g of the magenta dye 11 to 4.0 g of the magenta dye 11.

### Comparative Example 29

An ink set in Comparative Example 29 was produced in the same manner as in Comparative Example 9, except that the magenta dye used for the magenta ink composition in Comparative Example 9 was changed from 3.0 g of the magenta dye 11 to 5.0 g of the magenta dye 11.

### Comparative Example 30

An ink set in Comparative Example 30 was produced in the same manner as in Comparative Example 10, except that the magenta dye used for the magenta ink composition in Comparative Example 10 was changed from 3.0 g of the magenta dye 12 to 4.0 g of the magenta dye 12.

### Example 81

### Preparation of Magenta Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous sodium hydroxide solution, and filtration was performed under reduced pressure using a microfilter having an average pore size of 0.25 m to prepare a magenta ink composition.

| | | |
|---|---|---|
| Magenta dye (M-2) | 2.50 | g |
| Proxel XLII (preservative, manufactured by LONZA) | 0.11 | g |
| Glycerol | 9.80 | g |
| Triethylene glycol | 9.60 | g |
| Triethylene glycol monobutyl ether | 10.10 | g |
| Propylene glycol | 0.16 | g |
| Surfynol (manufactured by Air Products and Chemicals, Inc.) | 1.00 | g |
| 20 mass % aqueous solution of compound W | 7.13 | g |

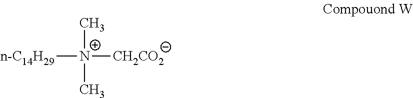

### Preparation of Cyan Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous lithium hydroxide solution, and filtration was performed under reduced pressure using a microfilter having an average pore size of 0.25 μm to prepare a cyan ink composition.

| | | |
|---|---|---|
| Cyan dye (C-12) | 4.00 | g |
| Proxel XLII (preservative, manufactured by LONZA) | 0.11 | g |
| Glycerol | 8.40 | g |
| Triethylene glycol | 4.00 | g |
| Triethylene glycol monobutyl ether | 7.30 | g |
| 2-Pyrrolidone | 2.60 | g |
| 1,2-Hexanediol | 1.20 | g |
| Propylene glycol | 0.10 | g |
| Surfynol (manufactured by Air Products and Chemicals, Inc.) | 1.00 | g |

### Preparation of Yellow Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous potassium hydroxide solution, and filtration was performed under reduced pressure using a microfilter having an average pore size of 0.25 μm to prepare a yellow ink composition.

| | | |
|---|---|---|
| Yellow dye (YA9-1) | 2.40 | g |
| Yellow dye (YA8) | 1.10 | g |
| Proxel XLII (preservative, manufactured by LONZA) | 0.11 | g |
| Glycerol | 8.70 | g |
| Triethylene glycol | 6.50 | g |
| Triethylene glycol monobutyl ether | 7.20 | g |
| 2-Pyrrolidone | 2.70 | g |
| Propylene glycol | 0.40 | g |
| Surfynol (manufactured by Air Products and Chemicals, Inc.) | 1.00 | g |

### Preparation of Black Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous lithium hydroxide solution, and filtration was performed under reduced pressure using a microfilter having an average pore size of 0.25 μm to prepare a black ink composition.

| | | |
|---|---|---|
| Black dye (BKA1) | 4.50 | g |
| Toning dye (toning dye 1) | 1.50 | g |
| Proxel XLII (preservative, manufactured by LONZA) | 0.11 | g |
| Glycerol | 8.90 | g |
| Triethylene glycol | 0.30 | g |
| Triethylene glycol monobutyl ether | 8.10 | g |
| 2-Pyrrolidone | 2.70 | g |
| Propylene glycol | 0.20 | g |
| Surfynol (manufactured by Air Products and Chemicals. Inc.) | 1.00 | g |

### Production of Ink Set

An ink set in Example 81 was produced that was constituted by the prepared magenta ink composition, cyan ink composition, yellow ink composition, and black ink composition.

### Examples 82 to 95 and Comparative Examples 31 to 40

Each ink composition was prepared and an ink set was produced in the same manner as in Example 81, except that in the preparation of the magenta ink composition, the cyan ink composition, and the yellow ink composition, the dyes used and the amounts of dyes added were changed to those listed in Tables 7 to 9.

The aqueous alkali solution (aqueous MOH solution) used when the pH of each ink composition was adjusted was selected so as to correspond to the countercation M (e.g., lithium cation, sodium cation, and potassium cation) of an ionic hydrophilic group in the dye used.

In Tables 7 to 9, the “aqueous solution W” refers to the above-described “20 mass % aqueous solution of compound W”. Furthermore, “-” in the “amount of aqueous solution W added” indicates “the aqueous solution W was not added”.

### Example 96

### Preparation of Magenta Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous sodium hydroxide solution, and filtration was performed under reduced pressure using a microfilter having an average pore size of 0.20 μm to prepare a magenta ink composition.

| | | |
|---|---|---|
| Magenta dye (M-2) g | 3.00 | g |
| Proxel XLII (preservative, manufactured by LONZA) | 0.11 | g |
| Glycerol | 8.84 | g |
| Ethylene urea | 9.37 | g |
| 1,5-Pentanediol | 1.97 | g |
| 2-Pyrrolidone | 2.32 | g |
| Surfynol (manufactured by Air Products and Chemicals, Inc.) | 0.50 | g |

### Preparation of Cyan Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous lithium hydroxide solution, and filtration was performed under reduced pressure using a microfilter having an average pore size of 0.25 μm to prepare a cyan ink composition.

| | | |
|---|---|---|
| Cyan dye (C-3) | 4.50 | g |
| Cyan dye (C-22) | 0.50 | g |
| Proxel XLII (preservative, manufactured by LONZA) | 0.11 | g |
| Glycerol | 4.65 | g |
| Ethylene urea | 9.86 | g |
| 1,5-Pentanediol | 4.93 | g |
| Surfynol (manufactured by Air Products and Chemicals, Inc.) | 0.50 | g |

### Preparation of Yellow Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous potassium hydroxide solution, and filtration was performed under reduced pressure using a microfilter having an average pore size of 0.25 μm to prepare a yellow ink composition.

| | | |
|---|---|---|
| Yellow dye (YA8) | 2.50 | g |
| Yellow dye (YA1) | 1.50 | g |
| Proxel XLII (preservative, manufactured by LONZA) | 0.11 | g |
| Glycerol | 4.66 | g |
| Ethylene urea | 9.68 | g |
| 1,5-Pentanediol | 3.43 | g |
| Surfynol (manufactured by Air Products and Chemicals, Inc.) | 0.50 | g |

### Preparation of Black Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous lithium hydroxide solution, and filtration was performed under reduced pressure using a microfilter having an average pore size of 0.25 m to prepare a black ink composition.

| | | |
|---|---|---|
| Black dye (BKA2) | 4.50 | g |
| Toning dye (toning dye 2) | 1.50 | g |
| Proxel XLII (preservative, manufactured by LONZA) | 0.11 | g |
| Glycerol | 6.50 | g |
| 1,5-Pentanediol | 2.90 | g |
| 2-Pyrrolidone | 3.70 | g |
| Triethylene glycol | 2.30 | g |
| Surfynol (manufactured by Air Products and Chemicals, Inc.) | 0.50 | g |

### Production of Ink Set

An ink set in Example 96 was produced that was constituted by the prepared magenta ink composition, cyan ink composition, yellow ink composition, and black ink composition.

### Examples 97 and 98 and Comparative Examples 41 to 43

Each ink composition was prepared and an ink set was produced in the same manner as in Example 96, except that in the preparation of the magenta ink composition, the cyan ink composition, and the yellow ink composition, the dyes used and the amounts of dyes added were changed to those listed in Tables 8 and 9.

The aqueous alkali solution (aqueous MOH solution) used when the pH of each ink composition was adjusted was selected so as to correspond to the countercation M (e.g., lithium cation, sodium cation, and potassium cation) of an ionic hydrophilic group in the dye used.

In Tables 8 and 9, the “aqueous solution W” refers to the above-described “20 mass % aqueous solution of compound W”. Furthermore, “-” in the “amount of aqueous solution W added” indicates “the aqueous solution W was not added”.

### Example 99

An ink set in Example 99 was produced in the same manner as in Example 96, except that the black ink composition in Example 96 was changed to a black ink composition below.

### Preparation of Black Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous lithium hydroxide solution, and filtration was performed under reduced pressure using a microfilter having an average pore size of 0.25 m to prepare a black ink composition.

| | | |
|---|---|---|
| Black dye (BKA7) | 4.00 | g |
| Toning dye 3 | 1.50 | g |
| Proxel XLII (preservative, manufactured by LONZA) | 0.11 | g |
| Glycerol | 6.50 | g |
| 1,5-Pentanediol | 2.90 | g |
| 2-Pyrrolidone | 3.70 | g |
| Triethylene glycol | 2.30 | g |
| Surfynol (manufactured by Air Products and Chemicals, Inc.) | 0.50 | g |

### Example 100

An ink set in Example 100 was produced in the same manner as in Example 96, except that the black ink composition in Example 96 was changed to a black ink composition below.

### Preparation of Black Ink Composition

Deionized water was added to a mixture including components below in the corresponding amounts below to weigh 100 g and then stirred for 1 hour under heating at 30° C. to 40° C. Subsequently, the pH was adjusted to 9.0 using a 10 mol/L aqueous lithium hydroxide solution, and filtration was performed under reduced pressure using a microfilter having an average pore size of 0.25 μm to prepare a black ink composition.

| | | |
|---|---|---|
| Black dye (BKA7) | 2.80 | g |
| Black dye (BKA8) | 0.20 | g |
| Black dye (BKA9) | 1.50 | g |
| Toning dye 3 | 1.50 | g |
| Proxel XLII (preservative, manufactured by LONZA) | 0.11 | g |
| Glycerol | 4.74 | g |
| Triethylene glycol | 5.21 | g |
| 1,5-Pentanediol | 2.98 | g |
| 2-Pyrrolidone | 2.94 | g |
| Surfynol (manufactured by Air Products and Chemicals, Inc.) | 0.50 | g |

TABLE 7

| | Magenta ink composition | | | | | |
|---|---|---|---|---|---|---|
| | | Amount of | Cyan ink | Yellow ink | | |
| | | aqueous | composition | composition | Black ink composition | |
| | Magenta dye | solution W | Cyan dye | Yellow dye | Black dye | Toning dye |
| | (amount) | added | (amount) | (amount) | (amount) | (amount) |
| Example 81 | (M-2) (2.50 g) | 7.13 g | (C-12) (4.00 g) | (YA9-1) (2.40 g) | (BKA1) (4.50 g) | Toning |
| | | | | (YA8) (1.10 g) | | dye 1 (1.50 g) |
| Example 82 | (M-2) (3.00 g) | 8.55 g | (C-12) (4.00 g) | (YA9-1) (2.40 g) | (BKA1) (4.50 g) | Toning |
| | | | | (YA8) (1.10 g) | | dye 1 (1.50 g) |
| Example 83 | (M-2) (3.50 g) | 9.98 g | (C-12) (4.00 g) | (YA9-1) (2.40 g) | (BKA1) (4.50 g) | Toning |
| | | | | (YA8) (1.10 g) | | dye 1 (1.50 g) |
| Example 84 | (M-2) (4.00 g) | 11.40 g | (C-12) (4.00 g) | (YA9-1) (2.40 g) | (BKA1) (4.50 g) | Toning |
| | | | | (YA8) (1.10 g) | | dye 1 (1.50 g) |
| Example 85 | (M-2) (3.00 g) | 8.55 g | (C-12) (3.50 g) | (YA9-1) (2.40 g) | (BKA1) (4.50 g) | Toning |
| | | | | (YA8) (1.10 g) | | dye 1 (1.50 g) |
| Example 86 | (M-2) (3.00 g) | 8.55 g | (C-12) (4.00 g) | (YA9-1) (2.40 g) | (BKA1) (4.50 g) | Toning |
| | | | | (YA8) (1.10 g) | | dye 1 (1.50 g) |
| Example 87 | (M-2) (3.00 g) | 8.55 g | (C-12) (4.50 g) | (YA9-1) (2.40 g) | (BKA1) (4.50 g) | Toning |
| | | | | (YA8) (1.10 g) | | dye 1 (1.50 g) |
| Example 88 | (M-2) (3.00 g) | 8.55 g | (C-12) (5.00 g) | (YA9-1) (2.40 g) | (BKA1) (4.50 g) | Toning |
| | | | | (YA8) (1.10 g) | | dye 1 (1.50 g) |
| Example 89 | (M-2) (3.00 g) | 8.55 g | (C-12) (5.50 g) | (YA9-1) (2.40 g) | (BKA1) (4.50 g) | Toning |
| | | | | (YA8) (1.10 g) | | dye 1 (1.50 g) |
| Example 90 | (M-3) (3.00 g) | — | (C-12) (4.00 g) | (YA9-1) (2.40 g) | (BKA1) (4.50 g) | Toning dye 1 |
| | | | | (YA8) (1.10 g) | | (1.50 g) |
| Example 91 | (M-2) (1.43 g) | 3.99 g | (C-3) (3.60 g) | (YA9-1) (2.40 g) | (BKA1) (2.30 g) | Toning |
| | Magenta | | (C-22) (0.40 g) | (YA8) (1.10 g) | (BKA5) (2.30 g) | dye 1 (0.70 g) |
| | dye 7 (0.90 g) | | | | | C.I. |
| | | | | | | DY-86 (0.70 g) |
| Example 92 | (M-2) (1.43 g) | 3.99 g | (C-12) (4.00 g) | (YA9-1) (2.40 g) | (BKA1) (2.30 g) | Toning |
| | Magenta | | | (YA8) (1.10 g) | (BKA5) (2.30 g) | dye 1 (0.70 g) |
| | dye 7 (0.90 g) | | | | | C.I. |
| | | | | | | DY-86 (0.70 g) |

C.I. DY-86 is C.I. Direct Yellow 86.

TABLE 8

| | Magenta ink composition | | | | | |
|---|---|---|---|---|---|---|
| | | Amount of | Cyan ink | Yellow ink | | |
| | | aqueous | composition | composition | Black ink composition | |
| | Magenta dye | solution W | Cyan dye | Yellow dye | Black dye | Toning dye |
| | (amount) | added | (amount) | (amount) | (amount) | (amount) |
| Example | (M-2) (2.50 g) | 7.13 g | (C-1) (4.00 g) | (YA9-1) (2.40 g) | BKA1 (2.30 g) | Toning dye 1 |
| 93 | Magenta dye 4 | | | (YA8) (1.10 g) | BKA5 (2.30 g) | (0.70 g) |
| | (0.50 g) | | | | | C.I. DY-86 |
| | | | | | | (0.70 g) |
| Example | (M-2) (2.50 g) | 7.13 g | (C-3) (3.60 g) | (YA9-1) (2.40 g) | BKA5 (1.90 g) | Toning dye 5 |
| 94 | Magenta dye 4 | | (C-22) (0.40 g) | (YA8) (1.10 g) | BKA6 (2.40 g) | (1.30 g) |
| | (0.50 g) | | | | | |
| Example | (M-2) (2.50 g) | 7.13 g | (C-12) (4.00 g) | (YA9-1) (2.40 g) | BKA5 (1.90 g) | Toning dye 5 |
| 95 | Magenta dye 4 | | | (YA8) (1.10 g) | BKA6 (2.40 g) | (1.30 g) |
| | (0.50 g) | | | | | |
| Example | (M-2) (3.0 g) | — | (C-3) (4.50 g) | (YA8) (2.50 g) | BKA2 (4.50 g) | Toning dye 2 |
| 96 | | | (C-22) (0.50 g) | (YA1) (1.50 g) | | (1.50 g) |
| Example | (M-2) (2.40 g) | — | (C-12) (3.50 g) | (YA8) (2.50 g) | BKA2 (4.50 g) | Toning dye 2 |
| 97 | Magenta dye 3 | | Cyan dye 4 | (YA1) (1.50 g) | | (1.50 g) |
| | (0.60 g) | | (0.50 g) | | | |
| Example | (M-2) (2.40 g) | — | (C-3) (4.50 g) | (YA8) (2.50 g) | BKA2 (4.50 g) | Toning dye 2 |
| 98 | Magenta dye 4 | | (C-22) (0.50 g) | (YA1) (1.50 g) | | (1.50 g) |
| | (0.60 g) | | | | | |
| Example | (M-2) (3.00 g) | — | (C-3) (4.50 g) | (YA8) (2.50 g) | BKA7 (4.00 g) | Toning dye 3 |
| 99 | | | (C-22) (0.50 g) | (YA1) (1.50 g) | | (1.50 g) |
| Example | (M-2) (3.00 g) | — | (C-3) (4.50 g) | (YA8) (2.50 g) | BKA7 (2.80 g) | Toning dye 3 |
| 100 | | | (C-22) (0.50 g) | (YA1) (1.50 g) | BKA8 (0.20 g) | (1.50 g) |
| | | | | | BKA9 (1.50 g) | |

C.I. DY-86 is C.I. Direct Yellow 86.

TABLE 9

| | Magenta ink composition | | | | | |
|---|---|---|---|---|---|---|
| | | Amount of | Cyan ink | Yellow ink | | |
| | | aqueous | composition | composition | Black ink composition | |
| | Magenta dye | solution W | Cyan dye | Yellow dye | Black dye | Toning dye |
| | (amount) | added | (amount) | (amount) | (amount) | (amount) |
| Comparative | Magenta dye 1 | 7.13 g | (C-12) (4.0 g) | (YA8) (2.50 g) | BKA1 (4.5 g) | Toning dye 1 |
| Example 31 | (2.5 g) | | | (YA1) (1.50 g) | | (1.5 g) |
| Comparative | Magenta dye 2 | 7.13 g | (C-12) (4.0 g) | (YA8) (2.50 g) | BKA1 (4.5 g) | Toning dye 1 |
| Example 32 | (2.5 g) | | | (YA1) (1.50 g) | | (1.5 g) |
| Comparative | Magenta dye 4 | 7.13 g | (C-12) (4.0 g) | (YA8) (2.50 g) | BKA1 (4.5 g) | Toning dye 1 |
| Example 33 | (2.5 g) | | | (YA1) (1.50 g) | | (1.5 g) |
| Comparative | Magenta dye 5 | 7.13 g | (C-12) (4.0 g) | (YA8) (2.50 g) | BKA1 (4.5 g) | Toning dye 1 |
| Example 34 | (2.5 g) | | | (YA1) (1.50 g) | | (1.5 g) |
| Comparative | Magenta dye 7 | 7.13 g | (C-12) (4.0 g) | (YA8) (2.50 g) | BKA1 (4.5 g) | Toning dye 1 |
| Example 35 | (2.5 g) | | | (YA1) (1.50 g) | | (1.5 g) |
| Comparative | Magenta dye 8 | 7.13 g | (C-12) (4.0 g) | (YA8) (2.50 g) | BKA1 (4.5 g) | Toning dye 1 |
| Example 36 | (2.5 g) | | | (YA1) (1.50 g) | | (1.5 g) |
| Comparative | Magenta dye 9 | 7.13 g | (C-12) (4.0 g) | (YA8) (2.50 g) | BKA1 (4.5 g) | Toning dye 1 |
| Example 37 | (2.5 g) | | | (YA1) (1.50 g) | | (1.5 g) |
| Comparative | Magenta dye 10 | 7.13 g | (C-12) (4.0 g) | (YA8) (2.50 g) | BKA1 (4.5 g) | Toning dye 1 |
| Example 38 | (2.5 g) | | | (YA1) (1.50 g) | | (1.5 g) |
| Comparative | Magenta dye 11 | 7.13 g | (C-12) (4.0 g) | (YA8) (2.50 g) | BKA1 (4.5 g) | Toning dye 1 |
| Example 39 | (2.5 g) | | | (YA1) (1.50 g) | | (1.5 g) |
| Comparative | Magenta dye 12 | 7.13 g | (C-12) (4.0 g) | (YA8) (2.50 g) | BKA1 (4.5 g) | Toning dye 1 |
| Example 40 | (2.5 g) | | | (YA1) (1.50 g) | | (1.5 g) |
| Comparative | (M-2) (2.5 g) | 7.13 g | C.I. DB-199 | (YA8) (2.50 g) | BKA1 (4.5 g) | Toning dye 1 |
| Example 41 | | | (4.0 g) | (YA1) (1.50 g) | | (1.5 g) |
| Comparative | (M-2) (2.5 g) | 7.13 g | (C-1) (4.0 g) | C.I. DY-86 | BKA1 (4.5 g) | Toning dye 1 |
| Example 42 | | | | (2.5 g) | | (1.5 g) |
| Comparative | (M-2) (2.5 g) | 7.13 g | (C-12) (4.0 g) | (YA8) (2.50 g) | none | none |
| Example 43 | | | | (YA1) (1.50 g) | | |

C.I. DB-199 is C.I. Direct Blue 199.
In Comparative Example 43, a black ink composition is not used.

Image recording and evaluation

Image recording was performed using the produced ink set as follows and the evaluation was performed. In each of Examples and Comparative Examples, the image recording was performed with a combination of the following ink jet printer and recording paper, and the evaluation was performed.

In each of Examples and Comparative Examples, single-color images of yellow, magenta, cyan, and black were formed by using individual ink compositions included in the ink set. Furthermore, mixed-color images of red (a mixed color obtained by using the magenta ink composition and the yellow ink composition), green (a mixed color obtained by using the yellow ink composition and the cyan ink composition), blue (a mixed color obtained by using the cyan ink composition and the magenta ink composition), and black (a mixed color obtained by using the yellow ink composition, the magenta ink composition, the cyan ink composition, and the black ink composition) were formed by using a plurality of ink compositions. The black image below is also referred to as “black (single color)” in the case of single color or “black (mixed color)” in the case of mixed color.

For the ink sets in Examples 1 to 30, Examples 61 to 70, Examples 96 to 100, Comparative Examples 1 to 10, Comparative Examples 21 to 24, Comparative Examples 28 to 30, and Comparative Examples 41 to 43, each ink composition was loaded into an ink cartridge, and an image recorded on ink jet paper (manufactured by Canon Inc., Photo Glossy Paper PT-201) using an ink jet printer (manufactured by Canon Inc., PIXUS Pro9000 MkII) was evaluated.

For the ink sets in Examples 31 to 60, Examples 71 to 95, Comparative Examples 11 to 20, Comparative Examples 2X and 2Y, Comparative Examples 25 to 27, and Comparative Examples 31 to 40, each ink composition was loaded into an ink cartridge, and an image recorded on photo paper (manufactured by SEIKO EPSON Corporation, Photo Paper <gloss>) using an ink jet printer (manufactured by SEIKO EPSON Corporation, PM-700C) was evaluated.

### Optical Density (Coloring Power)

A solid image (an image printed at an applied voltage of 100%) was recorded using each ink set with a combination of the above-described ink jet printer and recording paper.

The optical density of the formed solid image was measured with a reflection densitometer (trade name: X-Rite 310TR, manufactured by X-Rite Inc.). For the yellow, magenta, and cyan images, red, green, and blue filters were respectively used. For the black image, a visual filter was used. The optical density was evaluated with four ranks of A: 2.0 or more, B: 1.8 or more and less than 2.0, C: 1.7 or more and less than 1.8, and D: less than 1.7. For the red, green, and blue images, the reflection spectrum in the visual range was measured and the optical density was visually observed. Evaluation was performed with three ranks of A: sufficient coloring power, B: slightly insufficient coloring power in high-density portion, and C: insufficient coloring power.

### Bronze Luster

Cyan, black (single color), blue, and green solid patterns were printed using the ink set in each of Examples and Comparative Examples with a combination of the above-described ink jet printer and recording paper such that the amount of ink landed was 1.5 to 2.2 mg per square inch. The glossiness of the printed matter was determined using a gloss meter (PG-1M, manufactured by NIPPON DENSHOKU INDUSTRIES Co., Ltd.) at a measurement angle of 60°. The printing was performed in two environments of 20° C./40% RH and 35° C./60% RH. An increment calculated from the obtained glossiness on the basis of the following formula was used as criteria for the degree of occurrence of bronze luster. The criteria are as follows. In the following formula, the glossiness of printed matter is referred to as “Glossiness (printed matter)”, and the glossiness of recording paper before printing is referred to as “Glossiness (recording paper)”.

Note that 1 inch is 25.4 mm.

Increment=Glossiness (printed matter)−Glossiness (recording paper)

### Criteria

In printing, the evaluation was performed based on the following criteria using the increments in the two environments having different temperatures and humidities.

A: less than 15 in both the environments
B: 15 or more and less than 35 in at least one of the environments
C: 35 or more and less than 55 in at least one of the environments
D: 55 or more in at least one of the environments

### Moisture Resistance

First, a method for evaluating the moisture resistance of a magenta image will be described.

For the moisture resistance (bleeding of an image under high-humidity conditions), a 3 cm×3 cm printing pattern in which 1 mm×1 mm square magenta images were arranged such that 0.5 mm white gaps were formed between the square images was formed. This image sample was stored in an environment of 45° C. and 80% RH for 7 days, and then bleeding of the magenta dye in the white gaps was observed.

Specifically, the optical density (OD) of the printed matter was measured using a reflection densitometer (trade name: X-Rite 310TR, manufactured by X-Rite Inc.) before exposure to the above conditions (45° C. and 80% RH) (immediately after printing) and after storage for 7 days under the above conditions. An increase in the magenta density in the white gaps after the storage for 7 days under the above conditions from the magenta density immediately after printing was determined using a green filter. When the increase was less than 0.02, an evaluation result of A was given. When the increase was 0.02 or more and less than 0.05, an evaluation result of B was given. When the increase was 0.05 or more and less than 0.10, an evaluation result of C was given. When the increase was 0.10 or more, an evaluation result of D was given.

For images other than the magenta image, bleeding of a dye used for forming the image was also observed by the same method as above, and an increase in density was measured. A blue filter was used when the yellow density was measured. A red filter was used when the cyan density was measured. A visual filter was used when the black density was measured. For the red density, an average of the density (residual percentage) measured using a blue filter and the density (residual percentage) measured using a green filter was used. For the blue density, an average of the density (residual percentage) measured using a green filter and the density (residual percentage) measured using a red filter was used. For the green density, an average of the density (residual percentage) measured using a blue filter and the density (residual percentage) measured using a red filter was used.

### Light Resistance

The image density Ci immediately after recording was measured. Subsequently, the image was irradiated with xenon light (100,000 lx) for 28 days using a weather meter (Atlas C. 165). Then, the image density Cfl was measured again. The colorant residual percentage was calculated for evaluation from the image densities before and after the irradiation with xenon light. The image density was measured using a reflection densitometer (trade name: X-Rite 310TR, manufactured by X-Rite Inc.). The colorant residual percentage was measured in an image portion having an initial image density of 1.0±0.2.

A filter used when the image density of the image of each color was measured was the same as the filter described in “Moisture resistance”.

The colorant residual percentage was determined from the following formula, and the light resistance was evaluated on the basis of the criteria below.

Colorant residual percentage (%)=(Cfl/Ci)×100

A: The colorant residual percentage is 90% or more and less than 95%.
B: The colorant residual percentage is 80% or more and less than 90%.
C: The colorant residual percentage is less than 80%.

### Ozone Resistance

Paper on which an image was formed was left to stand for 3 days in a box that served as a dark place, had a room temperatures of 20° C., and had an ozone gas concentration of 5±0.1 ppm, which was achieved by applying an alternating voltage of 5 kV while dry air was passed through two coaxial glass tubes of a Siemens ozonizer. The image density of the image left to stand in an ozone gas atmosphere was measured using a reflection densitometer (trade name: X-Rite 310TR, manufactured by X-Rite Inc.). The colorant residual percentage was calculated for evaluation from the initial image density Ci and the image density Cf2 after being left to stand in an ozone gas atmosphere. The colorant residual percentage was measured in an image portion having an initial image density of 1.0±0.2. The ozone gas concentration in the box was controlled using an ozone gas monitor (model: OZG-EM-01) manufactured by Applics Corporation.

A filter used when the image density of the image of each color was measured was the same as the filter described in “Moisture resistance”.

The colorant residual percentage was determined from the following formula, and the ozone resistance was evaluated on the basis of the criteria below.

Colorant residual percentage (%)=(Cf2/Ci)×100

A: The colorant residual percentage is 85% or more and less than 90%.
B: The colorant residual percentage is 80% or more and less than 85%.
C: The colorant residual percentage is less than 80%.

### Contrast

A color matrix having a 3 cm×3 cm printing pattern (the optical density with ten grades of low density→middle density→high density: an image printed at an applied voltage of 100%) in which 10 mm×10 mm square yellow, magenta, cyan, red, green, and blue images were arranged such that 10 mm black (an image printed at an applied voltage of 100%) gaps were formed between the square images was formed on an image receiving sheet. For contrast (difference in light and shade, difference in density), the difference in brightness between bright portions (highlight) and dark portions (shadow) of the image was visually evaluated. The contrast was evaluated with two ranks of A: high contrast (a clear appearance with a large difference in light and shade) and B: low contrast (an obscure appearance with a small difference in light and shade).

### Ejection Stability

Immediately after the yellow, magenta, cyan, and black ink compositions were prepared, with a combination of the above-described ink jet printer and recording paper, ejection of inks from all nozzles of the ink jet printer was checked. Then, printing was performed on 100 sheets of each recording paper and evaluation was performed on the basis of the criteria below. The evaluation result was “A” in all Examples and Comparative Examples. The recording paper had an A4 size.

Subsequently, each of the ink compositions was stored at 40° C. and 80% RH for 2 weeks. Then, for each of the ink compositions, ejection of inks from all nozzles of the ink jet printer was checked with the same combination of the ink jet printer and recording paper (recording paper with an A4 size) as above. Printing was then performed on 100 sheets of each recording paper and the ejection stability was evaluated on the basis of the criteria below.

A: Substantially no irregular printing from start to end of printing
B: Output with irregular printing
C: Irregular printing from start to end of printing

As a result, the evaluation result was “A” for each of the ink compositions in all Examples and Comparative Examples.

Storage Stability: Ink Ejection Stability and Printing Quality/Performance after Long-Term Storage Mandatory Test

The yellow, magenta, cyan, and black ink compositions after the ink storage stability mandatory test under conditions of 60° C. and 14 days were evaluated. Evaluation was performed with two ranks. An evaluation result of A was given when the ink composition immediately after preparation was maintained. An evaluation result of B was given when the quality or performance of at least one of the evaluation items (optical density, light resistance, ozone resistance, moisture resistance, and ejection stability) deteriorated after the mandatory test.

As a result, the evaluation result was “A” for each of the ink compositions in all Examples and Comparative Examples.

TABLE 10
Evaluation of single-color image

| | Optical density (coloring power) | | | | Bronze luster | |
|---|---|---|---|---|---|---|
| | | | | Black | | Black |
| | | | | (single | | (single |
| | Yellow | Magenta | Cyan | color) | Cyan | color) |
| Example 1 | A | A | A | A | A | A |
| Example 2 | A | A | A | A | A | A |
| Example 3 | A | A | B | A | A | A |
| Example 4 | A | A | A | A | A | A |
| Example 5 | A | A | A | A | A | A |
| Example 6 | A | A | B | A | A | A |
| Example 7 | A | A | B | A | A | A |
| Example 8 | A | A | B | A | A | A |
| Example 9 | A | A | B | A | A | A |
| Example 10 | A | A | A | A | A | A |
| Example 11 | A | A | A | A | A | A |
| Example 12 | A | A | A | A | A | A |
| Example 13 | A | A | A | A | A | A |
| Example 14 | A | A | A | A | A | A |
| Example 15 | A | A | A | A | A | A |
| Example 16 | A | A | A | A | A | A |
| Example 17 | A | A | A | A | A | A |
| Example 18 | A | A | A | A | A | A |
| Example 19 | A | A | A | A | A | A |
| Example 20 | A | A | A | A | A | A |
| Example 21 | A | A | A | A | A | A |
| Example 22 | A | A | A | A | A | A |
| Example 23 | A | A | B | A | A | A |
| Example 24 | A | A | A | A | A | A |
| Example 25 | A | A | A | A | A | A |
| Example 26 | A | A | A | A | A | A |
| Example 27 | A | A | B | A | A | A |
| Example 28 | A | A | A | A | A | A |
| Example 29 | A | A | A | A | A | A |
| Example 30 | A | A | A | A | A | A |

TABLE 11
Evaluation of single-color image

| | Optical density (coloring power) | | | | Bronze luster | |
|---|---|---|---|---|---|---|
| | | | | Black | | Black |
| | | | | (single | | (single |
| | Yellow | Magenta | Cyan | color) | Cyan | color) |
| Comparative | A | A | A | A | A | A |
| Example 1 | | | | | | |
| Comparative | A | A | A | A | A | A |
| Example 2 | | | | | | |
| Comparative | A | A | A | A | A | A |
| Example 3 | | | | | | |
| Comparative | A | B | A | A | A | A |
| Example 4 | | | | | | |
| Comparative | A | B | A | A | A | A |
| Example 5 | | | | | | |
| Comparative | A | C | A | A | A | A |
| Example 6 | | | | | | |
| Comparative | A | C | A | A | A | A |
| Example 7 | | | | | | |
| Comparative | A | C | A | A | A | A |
| Example 8 | | | | | | |
| Comparative | A | C | A | A | A | A |
| Example 9 | | | | | | |
| Comparative | A | C | A | A | A | A |
| Example 10 | | | | | | |

TABLE 12
Evaluation of mixed-color image

| | Optical density (coloring power) | | | | | | |
|---|---|---|---|---|---|---|---|
| | | | | Black | | | |
| | | | | (mixed | Bronze luster | | |
| | Red | Green | Blue | color) | Blue | Green | Contrast |
| Example 1 | A | A | A | A | A | A | A |
| Example 2 | A | A | A | A | A | A | A |
| Example 3 | A | B | B | A | A | A | A |
| Example 4 | A | A | A | A | A | A | A |
| Example 5 | A | A | A | A | A | A | A |
| Example 6 | A | B | B | A | A | A | A |
| Example 7 | A | B | B | A | A | A | A |
| Example 8 | A | B | B | A | A | A | A |
| Example 9 | A | B | B | A | A | A | A |
| Example 10 | A | A | A | A | A | A | A |
| Example 11 | A | A | A | A | A | A | A |
| Example 12 | A | A | A | A | A | A | A |
| Example 13 | A | A | A | A | A | A | A |
| Example 14 | A | A | A | A | A | A | A |
| Example 15 | A | A | A | A | A | A | A |
| Example 16 | A | A | A | A | A | A | A |
| Example 17 | A | A | A | A | A | A | A |
| Example 18 | A | A | A | A | A | A | A |
| Example 19 | A | A | A | A | A | A | A |
| Example 20 | A | A | A | A | A | A | A |
| Example 21 | A | A | A | A | A | A | A |
| Example 22 | A | A | A | A | A | A | A |
| Example 23 | A | B | B | A | A | A | A |
| Example 24 | A | A | A | A | A | A | A |
| Example 25 | A | A | A | A | A | A | A |
| Example 26 | A | A | A | A | A | A | A |
| Example 27 | A | B | B | A | A | A | A |
| Example 28 | A | A | A | A | A | A | A |
| Example 29 | A | A | A | A | A | A | A |
| Example 30 | A | A | A | A | A | A | A |

TABLE 13
Evaluation of mixed-color image

| | Optical density (coloring power) | | | | | | |
|---|---|---|---|---|---|---|---|
| | | | | Black | | | |
| | | | | (mixed | Bronze luster | | |
| | Red | Green | Blue | color) | Blue | Green | Contrast |
| Comparative | A | A | A | A | A | A | A |
| Example 1 | | | | | | | |
| Comparative | A | A | A | A | A | A | A |
| Example 2 | | | | | | | |
| Comparative | A | A | A | A | A | A | A |
| Example 3 | | | | | | | |
| Comparative | B | A | B | A | A | A | A |
| Example 4 | | | | | | | |
| Comparative | B | A | B | A | A | A | A |
| Example 5 | | | | | | | |
| Comparative | C | A | C | A | A | A | B |
| Example 6 | | | | | | | |
| Comparative | C | A | C | A | A | A | B |
| Example 7 | | | | | | | |
| Comparative | C | A | C | A | A | A | B |
| Example 8 | | | | | | | |
| Comparative | C | A | C | A | A | A | B |
| Example 9 | | | | | | | |
| Comparative | C | A | C | A | A | A | B |
| Example 10 | | | | | | | |

TABLE 14
Evaluation of single-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (single | | | | (single | | | | (single |
| | Yellow | Magenta | Cyan | color) | Yellow | Magenta | Cyan | color) | Yellow | Magenta | Cyan | color) |
| Example | A | A | A | A | A | A | A | A | A | A | A | A |
| 1 | | | | | | | | | | | | |
| Example | A | A | A | A | A | A | A | A | A | A | A | A |
| 2 | | | | | | | | | | | | |
| Example | A | A | A | A | A | A | A | A | A | A | A | A |
| 3 | | | | | | | | | | | | |
| Example | A | A | A | A | A | A | A | A | A | A | A | A |
| 4 | | | | | | | | | | | | |
| Example | A | A | A | A | A | A | A | A | A | A | A | A |
| 5 | | | | | | | | | | | | |
| Example | A | A | A | A | A | A | A | A | A | A | A | A |
| 6 | | | | | | | | | | | | |
| Example | A | A | A | A | A | A | A | A | A | A | A | A |
| 7 | | | | | | | | | | | | |
| Example | A | A | A | A | A | A | A | A | A | A | A | A |
| 8 | | | | | | | | | | | | |
| Example | A | A | A | A | A | A | A | A | A | A | A | A |
| 9 | | | | | | | | | | | | |
| Example | A | A | A | A | A | A | A | A | A | A | A | A |
| 10 | | | | | | | | | | | | |
| Example | A | A | A | A | A | A | A | A | A | A | A | A |
| 11 | | | | | | | | | | | | |
| Example | A | A | A | A | A | A | A | A | A | A | A | A |
| 12 | | | | | | | | | | | | |
| Example | A | A | A | A | A | A | A | A | A | A | A | A |
| 13 | | | | | | | | | | | | |
| Example | A | A | A | A | A | A | A | A | A | A | A | A |
| 14 | | | | | | | | | | | | |
| Example | A | A | A | A | A | A | A | A | A | A | A | A |
| 15 | | | | | | | | | | | | |

TABLE 15
Evaluation of single-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (single | | | | (single | | | | (single |
| | Yellow | Magenta | Cyan | color) | Yellow | Magenta | Cyan | color) | Yellow | Magenta | Cyan | color) |
| Example | A | A | A | A | A | A | A | A | A | A | A | A |
| 16 | | | | | | | | | | | | |
| Example | A | A | A | A | A | A | A | A | A | A | A | A |
| 17 | | | | | | | | | | | | |
| Example | A | A | A | A | A | A | A | A | A | A | A | A |
| 18 | | | | | | | | | | | | |
| Example | A | A | A | A | A | A | A | A | A | A | A | A |
| 19 | | | | | | | | | | | | |
| Example | A | A | A | A | A | A | A | A | A | A | A | A |
| 20 | | | | | | | | | | | | |
| Example | A | A | A | A | A | A | A | A | A | A | A | A |
| 21 | | | | | | | | | | | | |
| Example | A | A | A | A | A | A | A | A | A | A | A | A |
| 22 | | | | | | | | | | | | |
| Example | A | A | A | A | A | A | A | A | A | A | A | A |
| 23 | | | | | | | | | | | | |
| Example | A | A | A | A | A | A | A | A | A | A | A | A |
| 24 | | | | | | | | | | | | |
| Example | A | A | A | A | A | A | A | A | A | A | A | A |
| 25 | | | | | | | | | | | | |
| Example | A | A | A | A | A | A | A | A | A | A | A | A |
| 26 | | | | | | | | | | | | |
| Example | A | A | A | A | A | A | A | A | A | A | A | A |
| 27 | | | | | | | | | | | | |
| Example | A | A | A | A | A | A | A | A | A | A | A | A |
| 28 | | | | | | | | | | | | |
| Example | A | A | A | A | A | A | A | A | A | A | A | A |
| 29 | | | | | | | | | | | | |
| Example | A | A | A | A | A | A | A | A | A | A | A | A |
| 30 | | | | | | | | | | | | |

TABLE 16
Evaluation of single-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (single | | | | (single | | | | (single |
| | Yellow | Magenta | Cyan | color) | Yellow | Magenta | Cyan | color) | Yellow | Magenta | Cyan | color) |
| Comparative | A | C | A | A | A | C | A | A | A | C | A | A |
| Example 1 | | | | | | | | | | | | |
| Comparative | A | C | A | A | A | C | A | A | A | C | A | A |
| Example 2 | | | | | | | | | | | | |
| Comparative | A | A | A | A | A | A | A | A | A | C | A | A |
| Example 3 | | | | | | | | | | | | |
| Comparative | A | C | A | A | A | C | A | A | A | C | A | A |
| Example 4 | | | | | | | | | | | | |
| Comparative | A | C | A | A | A | C | A | A | A | B | A | A |
| Example 5 | | | | | | | | | | | | |
| Comparative | A | B | A | A | A | B | A | A | A | B | A | A |
| Example 6 | | | | | | | | | | | | |
| Comparative | A | B | A | A | A | B | A | A | A | B | A | A |
| Example 7 | | | | | | | | | | | | |
| Comparative | A | B | A | A | A | B | A | A | A | B | A | A |
| Example 8 | | | | | | | | | | | | |
| Comparative | A | B | A | A | A | B | A | A | A | B | A | A |
| Example 9 | | | | | | | | | | | | |
| Comparative | A | C | A | A | A | C | A | A | A | C | A | A |
| Example 10 | | | | | | | | | | | | |

TABLE 17
Evaluation of mixed-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (mixed | | | | (mixed | | | | (mixed |
| | Red | Green | Blue | color) | Red | Green | Blue | color) | Red | Green | Blue | color) |
| Example | A | A | A | A | A | A | A | A | A | A | A | A |
| 1 | | | | | | | | | | | | |
| Example | A | A | A | A | A | A | A | A | A | A | A | A |
| 2 | | | | | | | | | | | | |
| Example | A | A | A | A | A | A | A | A | A | A | A | A |
| 3 | | | | | | | | | | | | |
| Example | A | A | A | A | A | A | A | A | A | A | A | A |
| 4 | | | | | | | | | | | | |
| Example | A | A | A | A | A | A | A | A | A | A | A | A |
| 5 | | | | | | | | | | | | |
| Example | A | A | A | A | A | A | A | A | A | A | A | A |
| 6 | | | | | | | | | | | | |
| Example | A | A | A | A | A | A | A | A | A | A | A | A |
| 7 | | | | | | | | | | | | |
| Example | A | A | A | A | A | A | A | A | A | A | A | A |
| 8 | | | | | | | | | | | | |
| Example | A | A | A | A | A | A | A | A | A | A | A | A |
| 9 | | | | | | | | | | | | |
| Example | A | A | A | A | A | A | A | A | A | A | A | A |
| 10 | | | | | | | | | | | | |
| Example | A | A | A | A | A | A | A | A | A | A | A | A |
| 11 | | | | | | | | | | | | |
| Example | A | A | A | A | A | A | A | A | A | A | A | A |
| 12 | | | | | | | | | | | | |
| Example | A | A | A | A | A | A | A | A | A | A | A | A |
| 13 | | | | | | | | | | | | |
| Example | A | A | A | A | A | A | A | A | A | A | A | A |
| 14 | | | | | | | | | | | | |
| Example | A | A | A | A | A | A | A | A | A | A | A | A |
| 15 | | | | | | | | | | | | |

TABLE 18
Evaluation of mixed-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (mixed | | | | (mixed | | | | (mixed |
| | Red | Green | Blue | color) | Red | Green | Blue | color) | Red | Green | Blue | color) |
| Example | A | A | A | A | A | A | A | A | A | A | A | A |
| 16 | | | | | | | | | | | | |
| Example | A | A | A | A | A | A | A | A | A | A | A | A |
| 17 | | | | | | | | | | | | |
| Example | A | A | A | A | A | A | A | A | A | A | A | A |
| 18 | | | | | | | | | | | | |
| Example | A | A | A | A | A | A | A | A | A | A | A | A |
| 19 | | | | | | | | | | | | |
| Example | A | A | A | A | A | A | A | A | A | A | A | A |
| 20 | | | | | | | | | | | | |
| Example | A | A | A | A | A | A | A | A | A | A | A | A |
| 21 | | | | | | | | | | | | |
| Example | A | A | A | A | A | A | A | A | A | A | A | A |
| 22 | | | | | | | | | | | | |
| Example | A | A | A | A | A | A | A | A | A | A | A | A |
| 23 | | | | | | | | | | | | |
| Example | A | A | A | A | A | A | A | A | A | A | A | A |
| 24 | | | | | | | | | | | | |
| Example | A | A | A | A | A | A | A | A | A | A | A | A |
| 25 | | | | | | | | | | | | |
| Example | A | A | A | A | A | A | A | A | A | A | A | A |
| 26 | | | | | | | | | | | | |
| Example | A | A | A | A | A | A | A | A | A | A | A | A |
| 27 | | | | | | | | | | | | |
| Example | A | A | A | A | A | A | A | A | A | A | A | A |
| 28 | | | | | | | | | | | | |
| Example | A | A | A | A | A | A | A | A | A | A | A | A |
| 29 | | | | | | | | | | | | |
| Example | A | A | A | A | A | A | A | A | A | A | A | A |
| 30 | | | | | | | | | | | | |

TABLE 19
Evaluation of mixed-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (mixed | | | | (mixed | | | | (mixed |
| | Red | Green | Blue | color) | Red | Green | Blue | color) | Red | Green | Blue | color) |
| Comparative | C | A | C | A | C | A | C | A | C | A | C | A |
| Example 1 | | | | | | | | | | | | |
| Comparative | C | A | C | A | C | A | C | A | C | A | C | A |
| Example 2 | | | | | | | | | | | | |
| Comparative | A | A | A | A | A | A | A | A | C | A | C | A |
| Example 3 | | | | | | | | | | | | |
| Comparative | C | A | C | A | C | A | C | A | C | A | C | A |
| Example 4 | | | | | | | | | | | | |
| Comparative | C | A | C | A | C | A | C | A | B | A | B | A |
| Example 5 | | | | | | | | | | | | |
| Comparative | B | A | B | A | B | A | B | A | B | A | B | A |
| Example 6 | | | | | | | | | | | | |
| Comparative | B | A | B | A | B | A | B | A | B | A | B | A |
| Example 7 | | | | | | | | | | | | |
| Comparative | B | A | B | A | B | A | B | A | B | A | B | A |
| Example 8 | | | | | | | | | | | | |
| Comparative | B | A | B | A | B | A | B | A | B | A | B | A |
| Example 9 | | | | | | | | | | | | |
| Comparative | C | A | C | A | C | A | C | A | C | A | C | A |
| Example 10 | | | | | | | | | | | | |

TABLE 20
Evaluation of single-color image

| | Optical density (coloring power) | | | | Bronze luster | |
|---|---|---|---|---|---|---|
| | | | | Black | | Black |
| | | | | (single | | (single |
| | Yellow | Magenta | Cyan | color) | Cyan | color) |
| Example 31 | A | A | A | A | A | A |
| Example 32 | A | A | A | A | A | A |
| Example 33 | A | A | B | A | A | A |
| Example 34 | A | A | A | A | A | A |
| Example 35 | A | A | A | A | A | A |
| Example 36 | A | A | B | A | A | A |
| Example 37 | A | A | B | A | A | A |
| Example 38 | A | A | B | A | A | A |
| Example 39 | A | A | B | A | A | A |
| Example 40 | A | A | A | A | A | A |
| Example 41 | A | A | A | A | A | A |
| Example 42 | A | A | A | A | A | A |
| Example 43 | A | A | A | A | A | A |
| Example 44 | A | A | A | A | A | A |
| Example 45 | A | A | A | A | A | A |
| Example 46 | A | A | A | A | A | A |
| Example 47 | A | A | A | A | A | A |
| Example 48 | A | A | A | A | A | A |
| Example 49 | A | A | A | A | A | A |
| Example 50 | A | A | A | A | A | A |
| Example 51 | A | A | A | A | A | A |
| Example 52 | A | A | A | A | A | A |
| Example 53 | A | A | B | A | A | A |
| Example 54 | A | A | A | A | A | A |
| Example 55 | A | A | A | A | A | A |
| Example 56 | A | A | A | A | A | A |
| Example 57 | A | A | B | A | A | A |
| Example 58 | A | A | A | A | A | A |
| Example 59 | A | A | A | A | A | A |
| Example 60 | A | A | A | A | A | A |

TABLE 21
Evaluation of single-color image

| | Optical density (coloring power) | | | | Bronze luster | |
|---|---|---|---|---|---|---|
| | | | | Black | | Black |
| | | | | (single | | (single |
| | Yellow | Magenta | Cyan | color) | Cyan | color) |
| Comparative | A | A | A | A | A | A |
| Example 11 | | | | | | |
| Comparative | A | A | A | A | A | A |
| Example 12 | | | | | | |
| Comparative | A | A | A | A | A | A |
| Example 13 | | | | | | |
| Comparative | A | B | A | A | A | A |
| Example 14 | | | | | | |
| Comparative | A | B | A | A | A | A |
| Example 15 | | | | | | |
| Comparative | A | C | A | A | A | A |
| Example 16 | | | | | | |
| Comparative | A | C | A | A | A | A |
| Example 17 | | | | | | |
| Comparative | A | C | A | A | A | A |
| Example 18 | | | | | | |
| Comparative | A | C | A | A | A | A |
| Example 19 | | | | | | |
| Comparative | A | C | A | A | A | A |
| Example 20 | | | | | | |
| Comparative | A | A | B | A | A | A |
| Example 2X | | | | | | |
| Comparative | B | A | A | A | A | A |
| Example 2Y | | | | | | |

TABLE 22
Evaluation of mixed-color image

| | Optical density (coloring power) | | | | | | |
|---|---|---|---|---|---|---|---|
| | | | | Black | | | |
| | | | | (mixed | Bronze luster | | |
| | Red | Green | Blue | color) | Blue | Green | Contrast |
| Example 31 | A | A | A | A | A | A | A |
| Example 32 | A | A | A | A | A | A | A |
| Example 33 | A | B | B | A | A | A | A |
| Example 34 | A | A | A | A | A | A | A |
| Example 35 | A | A | A | A | A | A | A |
| Example 36 | A | B | B | A | A | A | A |
| Example 37 | A | B | B | A | A | A | A |
| Example 38 | A | B | B | A | A | A | A |
| Example 39 | A | B | B | A | A | A | A |
| Example 40 | A | A | A | A | A | A | A |
| Example 41 | A | A | A | A | A | A | A |
| Example 42 | A | A | A | A | A | A | A |
| Example 43 | A | A | A | A | A | A | A |
| Example 44 | A | A | A | A | A | A | A |
| Example 45 | A | A | A | A | A | A | A |
| Example 46 | A | A | A | A | A | A | A |
| Example 47 | A | A | A | A | A | A | A |
| Example 48 | A | A | A | A | A | A | A |
| Example 49 | A | A | A | A | A | A | A |
| Example 50 | A | A | A | A | A | A | A |
| Example 51 | A | A | A | A | A | A | A |
| Example 52 | A | A | A | A | A | A | A |
| Example 53 | A | B | B | A | A | A | A |
| Example 54 | A | A | A | A | A | A | A |
| Example 55 | A | A | A | A | A | A | A |
| Example 56 | A | A | A | A | A | A | A |
| Example 57 | A | B | B | A | A | A | A |
| Example 58 | A | A | A | A | A | A | A |
| Example 59 | A | A | A | A | A | A | A |
| Example 60 | A | A | A | A | A | A | A |

TABLE 23
Evaluation of mixed-color image

| | Optical density (coloring power) | | | | | | |
|---|---|---|---|---|---|---|---|
| | | | | Black | Bronze luster | | |
| | Red | Green | Blue | (mixed color) | Blue | Green | Contrast |
| Comparative | A | A | A | A | A | A | A |
| Example 11 | | | | | | | |
| Comparative | A | A | A | A | A | A | A |
| Example 12 | | | | | | | |
| Comparative | A | A | A | A | A | A | A |
| Example 13 | | | | | | | |
| Comparative | B | A | B | A | A | A | A |
| Example 14 | | | | | | | |
| Comparative | B | A | B | A | A | A | A |
| Example 15 | | | | | | | |
| Comparative | C | A | C | A | A | A | B |
| Example 16 | | | | | | | |
| Comparative | C | A | C | A | A | A | B |
| Example 17 | | | | | | | |
| Comparative | C | A | C | A | A | A | B |
| Example 18 | | | | | | | |
| Comparative | C | A | C | A | A | A | B |
| Example 19 | | | | | | | |
| Comparative | C | A | C | A | A | A | B |
| Example 20 | | | | | | | |
| Comparative | A | B | B | A | A | A | B |
| Example 2X | | | | | | | |
| Comparative | B | B | A | A | A | A | B |
| Example 2Y | | | | | | | |

TABLE 24
Evaluation of single-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (single | | | | (single | | | | (single |
| | Yellow | Magenta | Cyan | color) | Yellow | Magenta | Cyan | color) | Yellow | Magenta | Cyan | color) |
| Example 31 | A | A | A | A | A | A | A | A | A | A | A | A |
| Example 32 | A | A | A | A | A | A | A | A | A | B | A | A |
| Example 33 | A | A | A | A | A | A | A | A | A | A | A | A |
| Example 34 | A | A | A | A | A | A | A | A | A | A | A | A |
| Example 35 | A | A | A | A | A | A | A | A | A | A | A | A |
| Example 36 | A | A | A | A | A | A | A | A | A | A | A | A |
| Example 37 | A | A | A | A | A | A | A | A | A | A | A | A |
| Example 38 | A | A | A | A | A | A | A | A | A | A | A | A |
| Example 39 | A | A | A | A | A | A | A | A | A | A | A | A |
| Example 40 | A | A | A | A | A | A | A | A | A | A | A | A |
| Example 41 | A | A | A | A | A | A | A | A | A | A | A | A |
| Example 42 | A | A | A | A | A | A | A | A | A | A | A | A |
| Example 43 | A | A | A | A | A | A | A | A | A | A | A | A |
| Example 44 | A | A | A | A | A | A | A | A | A | A | A | A |
| Example 45 | A | A | A | A | A | A | A | A | A | A | A | A |
| Example 46 | A | A | A | A | A | A | A | A | A | A | A | A |
| Example 47 | A | A | A | A | A | A | A | A | A | A | A | A |
| Example 48 | A | A | A | A | A | A | A | A | A | A | A | A |
| Example 49 | A | A | A | A | A | A | A | A | A | A | A | A |
| Example 50 | A | A | A | A | A | A | A | A | A | A | A | A |
| Example 51 | A | A | A | A | A | A | A | A | A | A | A | A |
| Example 52 | A | A | A | A | A | A | A | A | A | A | A | A |
| Example 53 | A | A | A | A | A | A | A | A | A | A | A | A |
| Example 54 | A | A | A | A | A | A | A | A | A | A | A | A |
| Example 55 | A | A | A | A | A | A | A | A | A | A | A | A |
| Example 56 | A | A | A | A | A | A | A | A | A | A | A | A |
| Example 57 | A | A | A | A | A | A | A | A | A | A | A | A |
| Example 58 | A | A | A | A | A | A | A | A | A | A | A | A |
| Example 59 | A | A | A | A | A | A | A | A | A | A | A | A |
| Example 60 | A | A | A | A | A | A | A | A | A | A | A | A |

TABLE 25
Evaluation of single-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (single | | | | (single | | | | (single |
| | Yellow | Magenta | Cyan | color) | Yellow | Magenta | Cyan | color) | Yellow | Magenta | Cyan | color) |
| Comparative | A | C | A | A | A | C | A | A | A | C | A | A |
| Example 11 | | | | | | | | | | | | |
| Comparative | A | C | A | A | A | C | A | A | A | C | A | A |
| Example 12 | | | | | | | | | | | | |
| Comparative | A | A | A | A | A | A | A | A | A | C | A | A |
| Example 13 | | | | | | | | | | | | |
| Comparative | A | C | A | A | A | C | A | A | A | C | A | A |
| Example 14 | | | | | | | | | | | | |
| Comparative | A | C | A | A | A | C | A | A | A | B | A | A |
| Example 15 | | | | | | | | | | | | |
| Comparative | A | B | A | A | A | B | A | A | A | B | A | A |
| Example 16 | | | | | | | | | | | | |
| Comparative | A | B | A | A | A | B | A | A | A | B | A | A |
| Example 17 | | | | | | | | | | | | |
| Comparative | A | B | A | A | A | B | A | A | A | B | A | A |
| Example 18 | | | | | | | | | | | | |
| Comparative | A | B | A | A | A | B | A | A | A | B | A | A |
| Example 19 | | | | | | | | | | | | |
| Comparative | A | C | A | A | A | C | A | A | A | C | A | A |
| Example 20 | | | | | | | | | | | | |
| Comparative | A | A | C | A | A | A | B | A | A | A | A | A |
| Example 2X | | | | | | | | | | | | |
| Comparative | C | A | A | A | C | A | A | A | C | A | A | A |
| Example 2Y | | | | | | | | | | | | |

TABLE 26
Evaluation of mixed-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (mixed | | | | (mixed | | | | (mixed |
| | Red | Green | Blue | color) | Red | Green | Blue | color) | Red | Green | Blue | color) |
| Example 31 | A | A | A | A | A | A | A | A | A | A | A | A |
| Example 32 | A | A | A | A | A | A | A | A | B | A | B | A |
| Example 33 | A | A | A | A | A | A | A | A | A | A | A | A |
| Example 34 | A | A | A | A | A | A | A | A | A | A | A | A |
| Example 35 | A | A | A | A | A | A | A | A | A | A | A | A |
| Example 36 | A | A | A | A | A | A | A | A | A | A | A | A |
| Example 37 | A | A | A | A | A | A | A | A | A | A | A | A |
| Example 38 | A | A | A | A | A | A | A | A | A | A | A | A |
| Example 39 | A | A | A | A | A | A | A | A | A | A | A | A |
| Example 40 | A | A | A | A | A | A | A | A | A | A | A | A |
| Example 41 | A | A | A | A | A | A | A | A | A | A | A | A |
| Example 42 | A | A | A | A | A | A | A | A | A | A | A | A |
| Example 43 | A | A | A | A | A | A | A | A | A | A | A | A |
| Example 44 | A | A | A | A | A | A | A | A | A | A | A | A |
| Example 45 | A | A | A | A | A | A | A | A | A | A | A | A |
| Example 46 | A | A | A | A | A | A | A | A | A | A | A | A |
| Example 47 | A | A | A | A | A | A | A | A | A | A | A | A |
| Example 48 | A | A | A | A | A | A | A | A | A | A | A | A |
| Example 49 | A | A | A | A | A | A | A | A | A | A | A | A |
| Example 50 | A | A | A | A | A | A | A | A | A | A | A | A |
| Example 51 | A | A | A | A | A | A | A | A | A | A | A | A |
| Example 52 | A | A | A | A | A | A | A | A | A | A | A | A |
| Example 53 | A | A | A | A | A | A | A | A | A | A | A | A |
| Example 54 | A | A | A | A | A | A | A | A | A | A | A | A |
| Example 55 | A | A | A | A | A | A | A | A | A | A | A | A |
| Example 56 | A | A | A | A | A | A | A | A | A | A | A | A |
| Example 57 | A | A | A | A | A | A | A | A | A | A | A | A |
| Example 58 | A | A | A | A | A | A | A | A | A | A | A | A |
| Example 59 | A | A | A | A | A | A | A | A | A | A | A | A |
| Example 60 | A | A | A | A | A | A | A | A | A | A | A | A |

TABLE 27
Evaluation of mixed-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (mixed | | | | (mixed | | | | (mixed |
| | Red | Green | Blue | color) | Red | Green | Blue | color) | Red | Green | Blue | color) |
| Comparative | C | A | C | A | C | A | C | A | C | A | C | A |
| Example 11 | | | | | | | | | | | | |
| Comparative | C | A | C | A | C | A | C | A | C | A | C | A |
| Example 12 | | | | | | | | | | | | |
| Comparative | A | A | A | A | A | A | A | A | C | A | C | A |
| Example 13 | | | | | | | | | | | | |
| Comparative | C | A | C | A | C | A | C | A | C | A | C | A |
| Example 14 | | | | | | | | | | | | |
| Comparative | C | A | C | A | C | A | C | A | B | A | B | A |
| Example 15 | | | | | | | | | | | | |
| Comparative | B | A | B | A | B | A | B | A | B | A | B | A |
| Example 16 | | | | | | | | | | | | |
| Comparative | B | A | B | A | B | A | B | A | B | A | B | A |
| Example 17 | | | | | | | | | | | | |
| Comparative | B | A | B | A | B | A | B | A | B | A | B | A |
| Example 18 | | | | | | | | | | | | |
| Comparative | B | A | B | A | B | A | B | A | B | A | B | A |
| Example 19 | | | | | | | | | | | | |
| Comparative | C | A | C | A | C | A | C | A | C | A | C | A |
| Example 20 | | | | | | | | | | | | |
| Comparative | A | C | C | B | B | B | B | B | A | A | A | A |
| Example 2X | | | | | | | | | | | | |
| Comparative | C | C | A | B | C | C | A | B | C | C | A | C |
| Example 2Y | | | | | | | | | | | | |

TABLE 28
Evaluation of single-color image

| | Optical density (coloring power) | | | | Bronze luster | |
|---|---|---|---|---|---|---|
| | | | | Black | | Black |
| | | | | (single | | (single |
| | Yellow | Magenta | Cyan | color) | Cyan | color) |
| Example 61 | A | A | A | A | A | A |
| Example 62 | A | A | A | A | A | A |
| Example 63 | A | A | A | A | A | A |
| Example 64 | A | A | A | A | A | A |
| Example 65 | A | A | A | A | A | A |
| Example 66 | A | A | A | A | A | A |
| Example 67 | A | A | A | A | A | A |
| Example 68 | A | A | A | A | A | A |
| Example 69 | A | A | A | A | A | A |
| Example 70 | A | A | A | A | A | A |
| Example 71 | A | B | A | A | A | A |
| Example 72 | A | B | A | A | A | A |
| Example 73 | A | B | A | A | A | A |
| Example 74 | A | B | A | A | A | A |
| Example 75 | A | A | A | A | A | A |
| Example 76 | A | A | B | A | A | A |
| Example 77 | A | A | A | A | A | A |
| Example 78 | A | A | B | A | A | A |
| Example 79 | A | A | A | A | A | A |
| Example 80 | A | A | A | A | A | A |
| Comparative | A | A | A | A | A | A |
| Example 21 | | | | | | |
| Comparative | A | A | C | A | A | A |
| Example 22 | | | | | | |
| Comparative | A | A | A | A | A | A |
| Example 23 | | | | | | |
| Comparative | A | B | A | A | A | A |
| Example 24 | | | | | | |
| Comparative | A | C | A | A | A | A |
| Example 25 | | | | | | |
| Comparative | A | C | A | A | A | A |
| Example 26 | | | | | | |
| Comparative | A | C | A | A | A | A |
| Example 27 | | | | | | |
| Comparative | A | C | A | A | A | A |
| Example 28 | | | | | | |
| Comparative | A | C | A | A | A | A |
| Example 29 | | | | | | |
| Comparative | A | C | A | A | A | A |
| Example 30 | | | | | | |

TABLE 29
Evaluation of mixed-color image

| | Optical density (coloring power) | | | | | | |
|---|---|---|---|---|---|---|---|
| | | | | Black | | | |
| | | | | (mixed | Bronze luster | | |
| | Red | Green | Blue | color) | Blue | Green | Contrast |
| Example 61 | A | A | A | A | A | A | A |
| Example 62 | A | A | A | A | A | A | A |
| Example 63 | A | A | A | A | A | A | A |
| Example 64 | A | A | A | A | A | A | A |
| Example 65 | A | A | A | A | A | A | A |
| Example 66 | A | A | A | A | A | A | A |
| Example 67 | A | A | A | A | A | A | A |
| Example 68 | A | A | A | A | A | A | A |
| Example 69 | A | A | A | A | A | A | A |
| Example 70 | A | A | A | A | A | A | A |
| Example 71 | B | A | B | A | A | A | A |
| Example 72 | B | A | B | A | A | A | A |
| Example 73 | B | A | B | A | A | A | A |
| Example 74 | B | A | B | A | A | A | A |
| Example 75 | A | A | A | A | A | A | A |
| Example 76 | A | B | B | A | A | A | A |
| Example 77 | A | A | A | A | A | A | A |
| Example 78 | A | B | B | A | A | A | A |
| Example 79 | A | A | A | A | A | A | A |
| Example 80 | A | A | A | A | A | A | A |
| Comparative | A | A | A | A | A | A | A |
| Example 21 | | | | | | | |
| Comparative | A | C | C | A | A | A | B |
| Example 22 | | | | | | | |
| Comparative | A | A | A | A | A | A | A |
| Example 23 | | | | | | | |
| Comparative | B | A | B | A | A | A | A |
| Example 24 | | | | | | | |
| Comparative | C | A | C | A | A | A | B |
| Example 25 | | | | | | | |
| Comparative | C | A | C | A | A | A | B |
| Example 26 | | | | | | | |
| Comparative | C | A | C | A | A | A | B |
| Example 27 | | | | | | | |
| Comparative | C | A | C | A | A | A | B |
| Example 28 | | | | | | | |
| Comparative | C | A | C | A | A | A | B |
| Example 29 | | | | | | | |
| Comparative | C | A | C | A | A | A | B |
| Example 30 | | | | | | | |

TABLE 30
Evaluation of single-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (single | | | | (single | | | | (single |
| | Yellow | Magenta | Cyan | color) | Yellow | Magenta | Cyan | color) | Yellow | Magenta | Cyan | color) |
| Example 61 | A | A | A | A | A | A | A | A | A | A | A | A |
| Example 62 | A | A | A | A | A | A | A | A | A | B | A | A |
| Example 63 | A | A | A | A | A | A | A | A | A | B | A | A |
| Example 64 | A | A | A | A | A | A | A | A | A | A | A | A |
| Example 65 | A | A | A | A | A | A | A | A | A | A | A | A |
| Example 66 | A | A | A | A | A | A | A | A | A | A | A | A |
| Example 67 | A | A | A | A | A | A | A | A | A | A | A | A |
| Example 68 | A | A | A | A | A | A | A | A | A | A | A | A |
| Example 69 | A | A | A | A | A | A | A | A | A | A | A | A |
| Example 70 | A | A | A | A | A | A | A | A | A | A | A | A |
| Example 71 | A | A | A | A | A | A | A | A | A | A | A | A |
| Example 72 | A | A | A | A | A | A | A | A | A | A | A | A |
| Example 73 | A | A | A | A | A | A | A | A | A | A | A | A |
| Example 74 | A | A | A | A | A | A | A | A | A | A | A | A |
| Example 75 | A | A | A | A | A | A | A | A | A | A | A | A |
| Example 76 | A | A | A | A | A | A | A | A | A | A | A | A |
| Example 77 | A | A | A | A | A | A | A | A | A | A | A | A |
| Example 78 | A | A | A | A | A | A | A | A | A | A | A | A |
| Example 79 | A | A | A | A | A | A | A | A | A | A | A | A |
| Example 80 | A | A | A | A | A | A | A | A | A | A | A | A |
| Comparative | A | C | A | A | A | C | A | A | A | C | A | A |
| Example 21 | | | | | | | | | | | | |
| Comparative | A | A | A | A | A | A | A | A | A | A | A | A |
| Example 22 | | | | | | | | | | | | |
| Comparative | A | A | A | A | A | A | A | A | A | C | A | A |
| Example 23 | | | | | | | | | | | | |
| Comparative | A | A | A | A | A | A | A | A | A | C | A | A |
| Example 24 | | | | | | | | | | | | |
| Comparative | A | B | A | A | A | B | A | A | A | B | A | A |
| Example 25 | | | | | | | | | | | | |
| Comparative | A | B | A | A | A | B | A | A | A | B | A | A |
| Example 26 | | | | | | | | | | | | |
| Comparative | A | C | A | A | A | C | A | A | A | C | A | A |
| Example 27 | | | | | | | | | | | | |
| Comparative | A | B | A | A | A | B | A | A | A | B | A | A |
| Example 28 | | | | | | | | | | | | |
| Comparative | A | B | A | A | A | B | A | A | A | B | A | A |
| Example 29 | | | | | | | | | | | | |
| Comparative | A | C | A | A | A | C | A | A | A | C | A | A |
| Example 30 | | | | | | | | | | | | |

TABLE 31
Evaluation of mixed-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (mixed | | | | (mixed | | | | (mixed |
| | Red | Green | Blue | color) | Red | Green | Blue | color) | Red | Green | Blue | color) |
| Example 61 | A | A | A | A | A | A | A | A | A | A | A | A |
| Example 62 | A | A | A | A | A | A | A | A | A | A | A | A |
| Example 63 | A | A | A | A | A | A | A | A | A | A | A | A |
| Example 64 | A | A | A | A | A | A | A | A | A | A | A | A |
| Example 65 | A | A | A | A | A | A | A | A | A | A | A | A |
| Example 66 | A | A | A | A | A | A | A | A | A | A | A | A |
| Example 67 | A | A | A | A | A | A | A | A | A | A | A | A |
| Example 68 | A | A | A | A | A | A | A | A | A | A | A | A |
| Example 69 | A | A | A | A | A | A | A | A | A | A | A | A |
| Example 70 | A | A | A | A | A | A | A | A | A | A | A | A |
| Example 71 | A | A | A | A | A | A | A | A | A | A | A | A |
| Example 72 | A | A | A | A | A | A | A | A | A | A | A | A |
| Example 73 | A | A | A | A | A | A | A | A | A | A | A | A |
| Example 74 | A | A | A | A | A | A | A | A | A | A | A | A |
| Example 75 | A | A | A | A | A | A | A | A | A | A | A | A |
| Example 76 | A | A | A | A | A | A | A | A | A | A | A | A |
| Example 77 | A | A | A | A | A | A | A | A | A | A | A | A |
| Example 78 | A | A | A | A | A | A | A | A | A | A | A | A |
| Example 79 | A | A | A | A | A | A | A | A | A | A | A | A |
| Example 80 | A | A | A | A | A | A | A | A | A | A | A | A |
| Comparative | C | A | C | A | C | A | C | A | C | A | C | A |
| Example 21 | | | | | | | | | | | | |
| Comparative | A | A | A | A | A | A | A | A | A | A | A | A |
| Example 22 | | | | | | | | | | | | |
| Comparative | A | A | A | A | A | A | A | A | C | A | C | A |
| Example 23 | | | | | | | | | | | | |
| Comparative | A | A | A | A | A | A | A | A | C | A | C | A |
| Example 24 | | | | | | | | | | | | |
| Comparative | B | A | B | A | B | A | B | A | B | A | B | A |
| Example 25 | | | | | | | | | | | | |
| Comparative | B | A | B | A | B | A | B | A | B | A | B | A |
| Example 26 | | | | | | | | | | | | |
| Comparative | C | A | C | A | C | A | C | A | C | A | C | A |
| Example 27 | | | | | | | | | | | | |
| Comparative | B | A | B | A | B | A | B | A | B | A | B | A |
| Example 28 | | | | | | | | | | | | |
| Comparative | B | A | B | A | B | A | B | A | B | A | B | A |
| Example 29 | | | | | | | | | | | | |
| Comparative | C | A | C | A | C | A | C | A | C | A | C | A |
| Example 30 | | | | | | | | | | | | |

TABLE 32
Evaluation of single-color image

| | Optical density (coloring power) | | | | Bronze luster | |
|---|---|---|---|---|---|---|
| | | | | Black | | Black |
| | | | | (single | | (single |
| | Yellow | Magenta | Cyan | color) | Cyan | color) |
| Example 81 | A | B | A | A | A | A |
| Example 82 | A | A | A | A | A | A |
| Example 83 | A | A | A | A | A | A |
| Example 84 | A | A | A | A | A | A |
| Example 85 | A | A | A | A | A | A |
| Example 86 | A | A | B | A | A | A |
| Example 87 | A | A | A | A | A | A |
| Example 88 | A | A | A | A | A | A |
| Example 89 | A | A | A | A | A | A |
| Example 90 | A | A | A | A | A | A |
| Example 91 | A | B | A | A | A | A |
| Example 92 | A | B | A | A | A | A |
| Example 93 | A | B | A | A | A | A |
| Example 94 | A | A | A | A | A | A |
| Example 95 | A | A | A | A | A | A |
| Example 96 | A | A | A | A | A | A |
| Example 97 | A | A | A | A | A | A |
| Example 98 | A | A | A | A | A | A |
| Example 99 | A | A | A | A | A | A |
| Example 100 | A | A | A | A | A | A |
| Comparative Example 31 | B | B | A | A | A | A |
| Comparative Example 32 | B | B | A | A | A | A |
| Comparative Example 33 | B | B | A | A | A | A |
| Comparative Example 34 | B | B | A | A | A | A |
| Comparative Example 35 | B | C | A | A | A | A |
| Comparative Example 36 | B | C | A | A | A | A |
| Comparative Example 37 | B | C | A | A | A | A |
| Comparative Example 38 | B | C | A | A | A | A |
| Comparative Example 39 | B | D | A | A | A | A |
| Comparative Example 40 | B | D | A | A | A | A |
| Comparative Example 41 | B | B | A | A | A | A |
| Comparative Example 42 | C | B | A | A | A | A |
| Comparative Example 43 | B | B | A | — | A | — |

“—” in Comparative Example 43 indicates no evaluation result of optical density.

TABLE 33
Evaluation of mixed-color image

| | Optical density (coloring power) | | | | | | |
|---|---|---|---|---|---|---|---|
| | | | | Black | | | |
| | | | | (mixed | Bronze luster | | |
| | Red | Green | Blue | color) | Blue | Green | Contrast |
| Example 81 | B | A | B | A | A | A | A |
| Example 82 | A | A | A | A | A | A | A |
| Example 83 | A | A | A | A | A | A | A |
| Example 84 | A | A | A | A | A | A | A |
| Example 85 | A | A | A | A | A | A | A |
| Example 86 | A | B | B | A | A | A | A |
| Example 87 | A | A | A | A | A | A | A |
| Example 88 | A | A | A | A | A | A | A |
| Example 89 | A | A | A | A | A | A | A |
| Example 90 | A | A | A | A | A | A | A |
| Example 91 | B | A | B | A | A | A | A |
| Example 92 | B | A | B | A | A | A | A |
| Example 93 | B | A | B | A | A | A | A |
| Example 94 | A | A | A | A | A | A | A |
| Example 95 | A | A | A | A | A | A | A |
| Example 96 | A | A | A | A | A | A | A |
| Example 97 | A | A | A | A | A | A | A |
| Example 98 | A | A | A | A | A | A | A |
| Example 99 | A | A | A | A | A | A | A |
| Example 100 | A | A | A | A | A | A | A |
| Comparative Example 31 | B | B | B | A | A | A | A |
| Comparative Example 32 | B | B | B | A | A | A | A |
| Comparative Example 33 | B | B | B | A | A | A | A |
| Comparative Example 34 | B | B | B | A | A | A | A |
| Comparative Example 35 | C | B | C | A | A | A | B |
| Comparative Example 36 | C | B | C | A | A | A | B |
| Comparative Example 37 | C | B | C | A | A | A | B |
| Comparative Example 38 | C | B | C | A | A | A | B |
| Comparative Example 39 | C | B | C | A | A | A | B |
| Comparative Example 40 | C | B | C | A | A | A | B |
| Comparative Example 41 | B | B | B | A | A | A | A |
| Comparative Example 42 | C | C | B | A | A | A | B |
| Comparative Example 43 | B | B | B | B | A | A | B |

“Black (mixed color)” in Comparative Example 43 is a black image formed by mixing a yellow ink, a cyan ink, and a magenta ink.

TABLE 34
Evaluation of single-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (single | | | | (single | | | | (single |
| | Yellow | Magenta | Cyan | color) | Yellow | Magenta | Cyan | color) | Yellow | Magenta | Cyan | color) |
| Example | B | A | A | A | B | A | A | A | A | A | A | A |
| 81 | | | | | | | | | | | | |
| Example | B | A | A | A | B | A | A | A | A | A | A | A |
| 82 | | | | | | | | | | | | |
| Example | B | A | A | A | B | A | A | A | A | A | A | A |
| 83 | | | | | | | | | | | | |
| Example | B | A | A | A | B | A | A | A | A | A | A | A |
| 84 | | | | | | | | | | | | |
| Example | B | A | A | A | B | A | A | A | A | A | A | A |
| 85 | | | | | | | | | | | | |
| Example | B | A | A | A | B | A | A | A | A | A | A | A |
| 86 | | | | | | | | | | | | |
| Example | B | A | A | A | B | A | A | A | A | A | A | A |
| 87 | | | | | | | | | | | | |
| Example | B | A | A | A | B | A | A | A | A | A | A | A |
| 88 | | | | | | | | | | | | |
| Example | B | A | A | A | B | A | A | A | A | A | A | A |
| 89 | | | | | | | | | | | | |
| Example | B | A | A | A | B | A | A | A | A | A | A | A |
| 90 | | | | | | | | | | | | |
| Example | B | B | A | A | B | B | A | A | A | A | A | A |
| 91 | | | | | | | | | | | | |
| Example | B | B | A | A | B | B | A | A | A | A | A | A |
| 92 | | | | | | | | | | | | |
| Example | B | A | A | A | B | A | A | A | A | B | A | A |
| 93 | | | | | | | | | | | | |
| Example | B | A | A | A | B | A | A | A | A | B | A | A |
| 94 | | | | | | | | | | | | |
| Example | B | A | A | A | B | A | A | A | A | B | A | A |
| 95 | | | | | | | | | | | | |
| Example | B | A | A | A | B | A | A | A | B | A | A | A |
| 96 | | | | | | | | | | | | |
| Example | B | A | B | A | B | A | A | A | B | B | A | A |
| 97 | | | | | | | | | | | | |
| Example | B | A | A | A | B | A | A | A | B | B | A | A |
| 98 | | | | | | | | | | | | |
| Example | B | A | A | A | B | A | A | A | B | A | A | A |
| 99 | | | | | | | | | | | | |
| Example | B | A | A | A | B | A | A | A | B | A | A | A |
| 100 | | | | | | | | | | | | |

TABLE 35
Evaluation of single-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (single | | | | (single | | | | (single |
| | Yellow | Magenta | Cyan | color) | Yellow | Magenta | Cyan | color) | Yellow | Magenta | Cyan | color) |
| Comparative | B | C | A | A | B | C | A | A | B | C | A | A |
| Example 31 | | | | | | | | | | | | |
| Comparative | B | B | A | A | B | C | A | A | B | C | A | A |
| Example 32 | | | | | | | | | | | | |
| Comparative | B | A | A | A | B | A | A | A | B | c | A | A |
| Example 33 | | | | | | | | | | | | |
| Comparative | B | C | A | A | B | C | A | A | B | c | A | A |
| Example 34 | | | | | | | | | | | | |
| Comparative | B | C | A | A | B | c | A | A | B | B | A | A |
| Example 35 | | | | | | | | | | | | |
| Comparative | B | B | A | A | B | B | A | A | B | A | A | A |
| Example 36 | | | | | | | | | | | | |
| Comparative | B | B | A | A | B | B | A | A | B | A | A | A |
| Example 37 | | | | | | | | | | | | |
| Comparative | B | B | A | A | B | B | A | A | B | A | A | A |
| Example 38 | | | | | | | | | | | | |
| Comparative | B | B | A | A | B | B | A | A | B | B | A | A |
| Example 39 | | | | | | | | | | | | |
| Comparative | B | C | A | A | B | C | A | A | B | C | A | A |
| Example 40 | | | | | | | | | | | | |
| Comparative | B | A | C | A | B | A | A | A | B | A | A | A |
| Example 41 | | | | | | | | | | | | |
| Comparative | B | A | A | A | B | A | A | A | C | A | A | A |
| Example 42 | | | | | | | | | | | | |
| Comparative | B | A | A | — | B | A | A | — | B | A | A | — |
| Example 43 | | | | | | | | | | | | |

“—” in Comparative Example 43 indicates no evaluation result.

TABLE 36
Evaluation of mixed-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (mixed | | | | (mixed | | | | (mixed |
| | Red | Green | Blue | color) | Red | Green | Blue | color) | Red | Green | Blue | color) |
| Example 81 | B | B | A | B | B | B | A | B | A | A | A | A |
| Example 82 | B | B | A | B | B | B | A | B | A | A | A | A |
| Example 83 | B | B | A | B | B | B | A | B | A | A | A | A |
| Example 84 | B | B | A | B | B | B | A | B | A | A | A | A |
| Example 85 | B | B | A | B | B | B | A | B | A | A | A | A |
| Example 86 | B | B | A | B | B | B | A | B | A | A | A | A |
| Example 87 | B | B | A | B | B | B | A | B | A | A | A | A |
| Example 88 | B | B | A | B | B | B | A | B | A | A | A | A |
| Example 89 | B | B | A | B | B | B | A | B | A | A | A | A |
| Example 90 | B | B | A | B | B | B | A | B | A | A | A | A |
| Example 91 | B | B | B | B | B | B | B | B | A | A | A | A |
| Example 92 | B | B | B | B | B | B | B | B | A | A | A | A |
| Example 93 | B | B | A | B | B | B | A | B | B | A | B | B |
| Example 94 | B | B | A | B | B | B | A | B | B | A | B | B |
| Example 95 | B | B | A | B | B | B | A | B | B | A | B | B |
| Example 96 | B | B | A | B | B | B | A | B | B | B | A | B |
| Example 97 | B | B | B | B | B | B | A | B | B | B | B | B |
| Example 98 | B | B | A | B | B | B | A | B | B | B | B | B |
| Example 99 | B | B | A | B | B | B | A | B | B | B | A | B |
| Example 100 | B | B | A | B | B | B | A | B | B | B | A | B |

TABLE 37
Evaluation of mixed-color image

| | Ozone resistance | | | | Light resistance | | | | Moisture resistance | | | |
|---|---|---|---|---|---|---|---|---|---|---|---|---|
| | | | | Black | | | | Black | | | | Black |
| | | | | (mixed | | | | (mixed | | | | (mixed |
| | Red | Green | Blue | color) | Red | Green | Blue | color) | Red | Green | Blue | color) |
| Comparative | C | B | C | C | C | B | C | C | C | B | C | C |
| Example 31 | | | | | | | | | | | | |
| Comparative | B | B | B | B | C | B | C | C | C | B | C | C |
| Example 32 | | | | | | | | | | | | |
| Comparative | B | B | A | B | B | B | A | B | C | B | C | C |
| Example 33 | | | | | | | | | | | | |
| Comparative | C | B | C | C | C | B | C | C | C | B | C | C |
| Example 34 | | | | | | | | | | | | |
| Comparative | C | B | C | C | C | B | C | C | B | B | A | B |
| Example 35 | | | | | | | | | | | | |
| Comparative | B | B | B | B | B | B | B | B | B | B | A | B |
| Example 36 | | | | | | | | | | | | |
| Comparative | B | B | B | B | B | B | B | B | B | B | A | B |
| Example 37 | | | | | | | | | | | | |
| Comparative | B | B | B | B | B | B | B | B | B | B | A | B |
| Example 38 | | | | | | | | | | | | |
| Comparative | B | B | B | B | B | B | B | B | B | B | B | B |
| Example 39 | | | | | | | | | | | | |
| Comparative | C | B | C | C | C | B | C | C | C | B | C | C |
| Example 40 | | | | | | | | | | | | |
| Comparative | B | C | C | C | B | B | A | B | B | B | A | B |
| Example 41 | | | | | | | | | | | | |
| Comparative | B | B | A | B | B | B | A | B | C | C | A | C |
| Example 42 | | | | | | | | | | | | |
| Comparative | B | B | A | B | B | B | A | B | B | B | A | B |
| Example 43 | | | | | | | | | | | | |

“Black (mixed color)” in Comparative Example 43 is a black image formed by mixing a yellow ink, a cyan ink, and a magenta ink.

The present invention can provide an ink set that includes a magenta ink composition, a cyan ink composition, a yellow ink composition, and a black ink composition, that achieves high optical density, reduced bronze luster, high ozone resistance, high light resistance, and high moisture resistance for single-color images, and that achieves high optical density, reduced bronze luster, high ozone resistance, high light resistance, high moisture resistance, and high contrast for mixed-color images, and an ink cartridge, an ink jet printer, and an ink jet recording method which use the ink set.

The present invention has been described in detail based on particular embodiments. It is obvious for those skilled in the art that various modifications and alterations can be made without departing from the spirit and scope of the present invention.

What is claimed is:

1. An ink set comprising:
a magenta ink composition;
a cyan ink composition;
a yellow ink composition; and
a black ink composition,
wherein the magenta ink composition contains at least one compound represented by the following general formula (1),
the cyan ink composition contains at least one compound represented by the following general formula (2),
the yellow ink composition contains at least one compound selected from the following group Y, and
the black ink composition contains at least one compound selected from the following group BK, 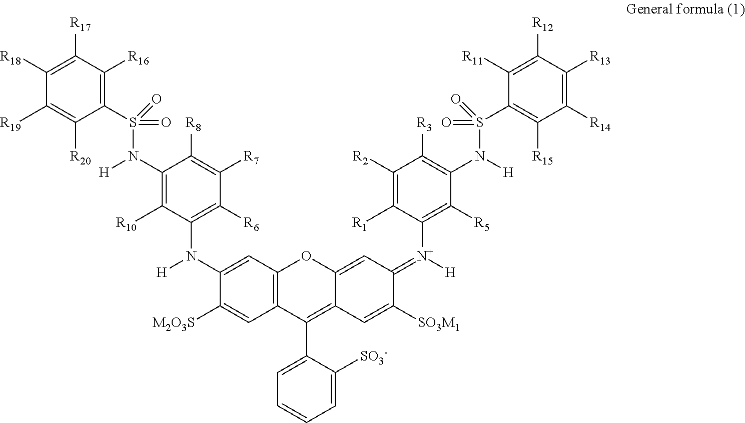
wherein, in the general formula (1), R₁, R₅, R₆, and R₁₀ each independently represent an alkyl group that may have a substituent, R₂, R₃, R₇, R₈, R₁₁, R₁₂, R₁₃, R₁₄, R₁₅, R₁₆, R₁₇, R₁₈, R₁₉, and R₂₀ each independently represent a hydrogen atom or a substituent, and M₁ and M₂ each independently represent a hydrogen atom, an alkali metal ion, or an ammonium ion, 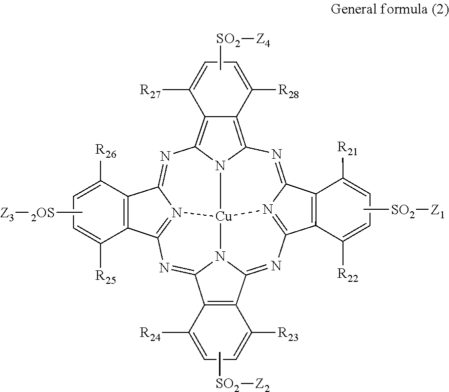
wherein, in the general formula (2), R₂₁, R₂₂, R₂₃, R₂₄, R₂₅, R₂₆, R₂₇, and R₂₈ each independently represent a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imide group, a heterocyclic thio group, a phosphoryl group, an acyl group, or an ionic hydrophilic group, which may further have a substituent, and Z₁, Z₂, Z₃, and Z₄ each independently represent a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group, where at least one of Z₁, Z₂, Z₃, or Z₄ has an ionic hydrophilic group as a substituent, 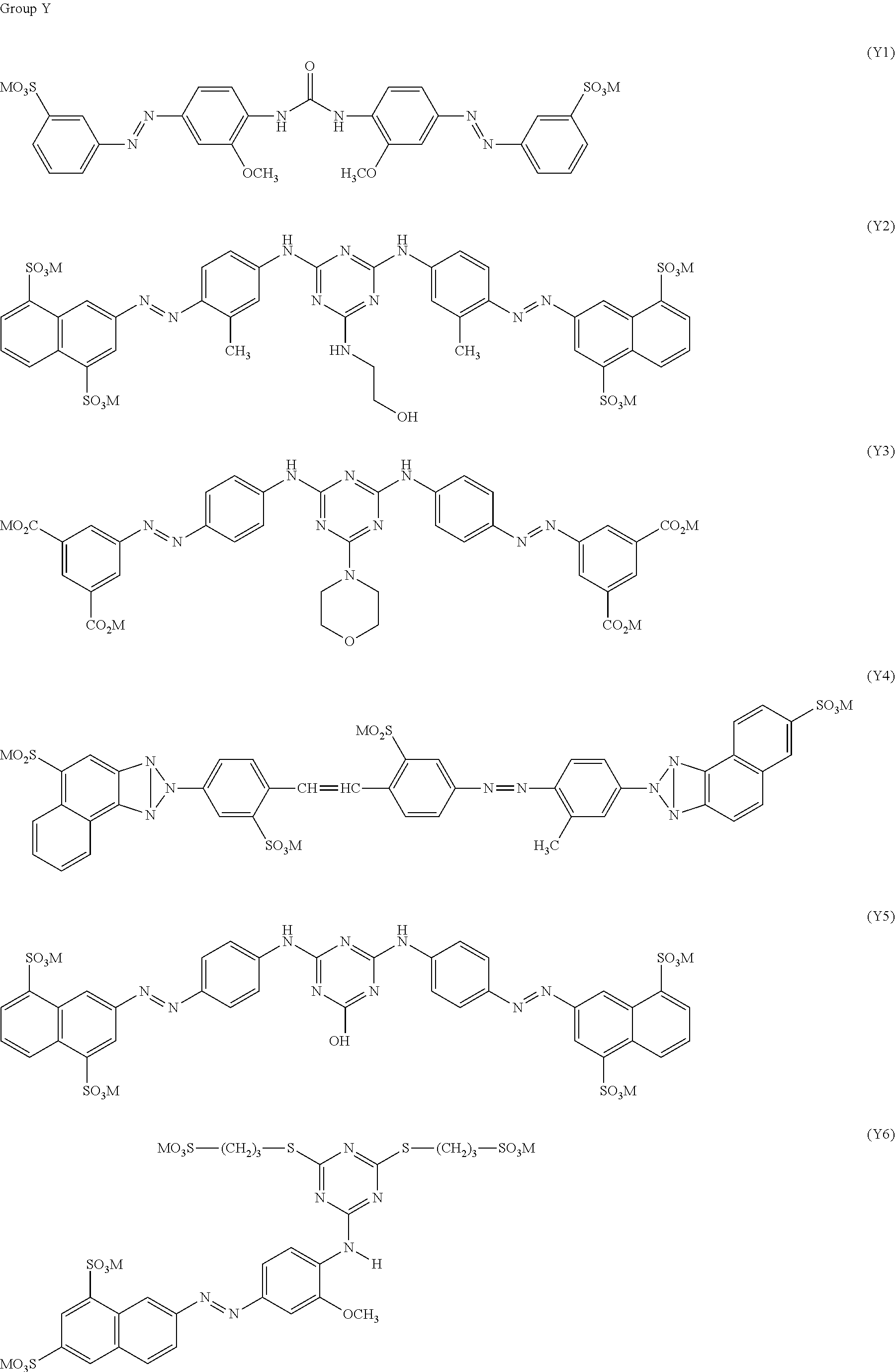 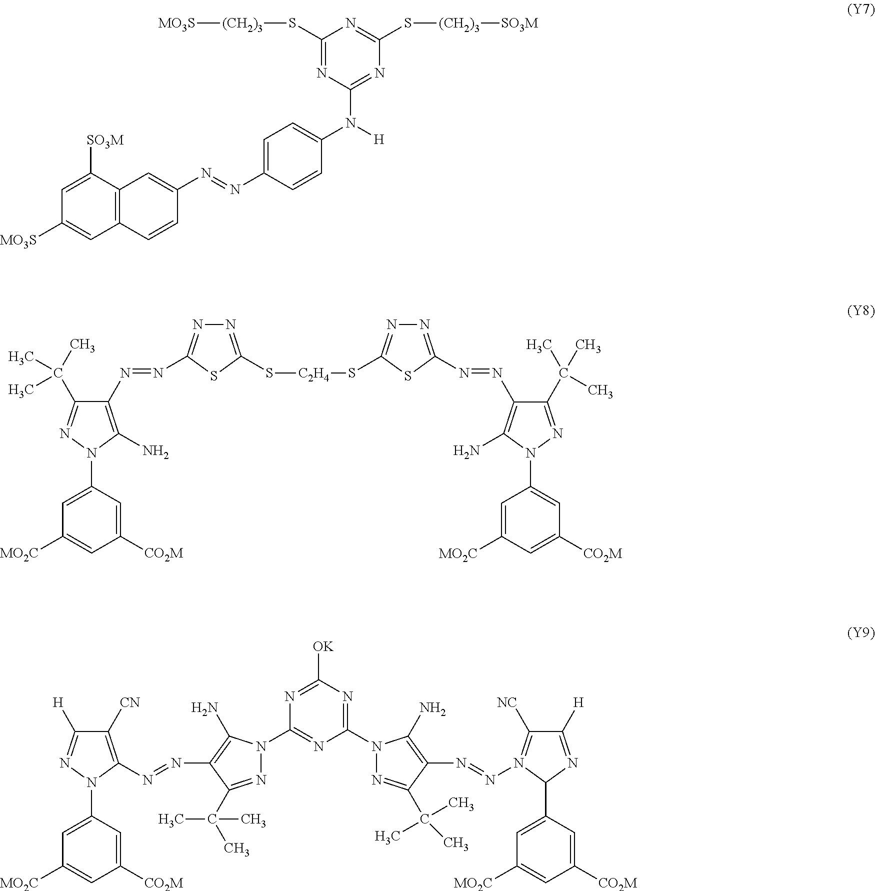
wherein, in the general formulae (Y1) to (Y9), each M independently represents a hydrogen atom, a lithium ion, a sodium ion, a potassium ion, or an ammonium ion, 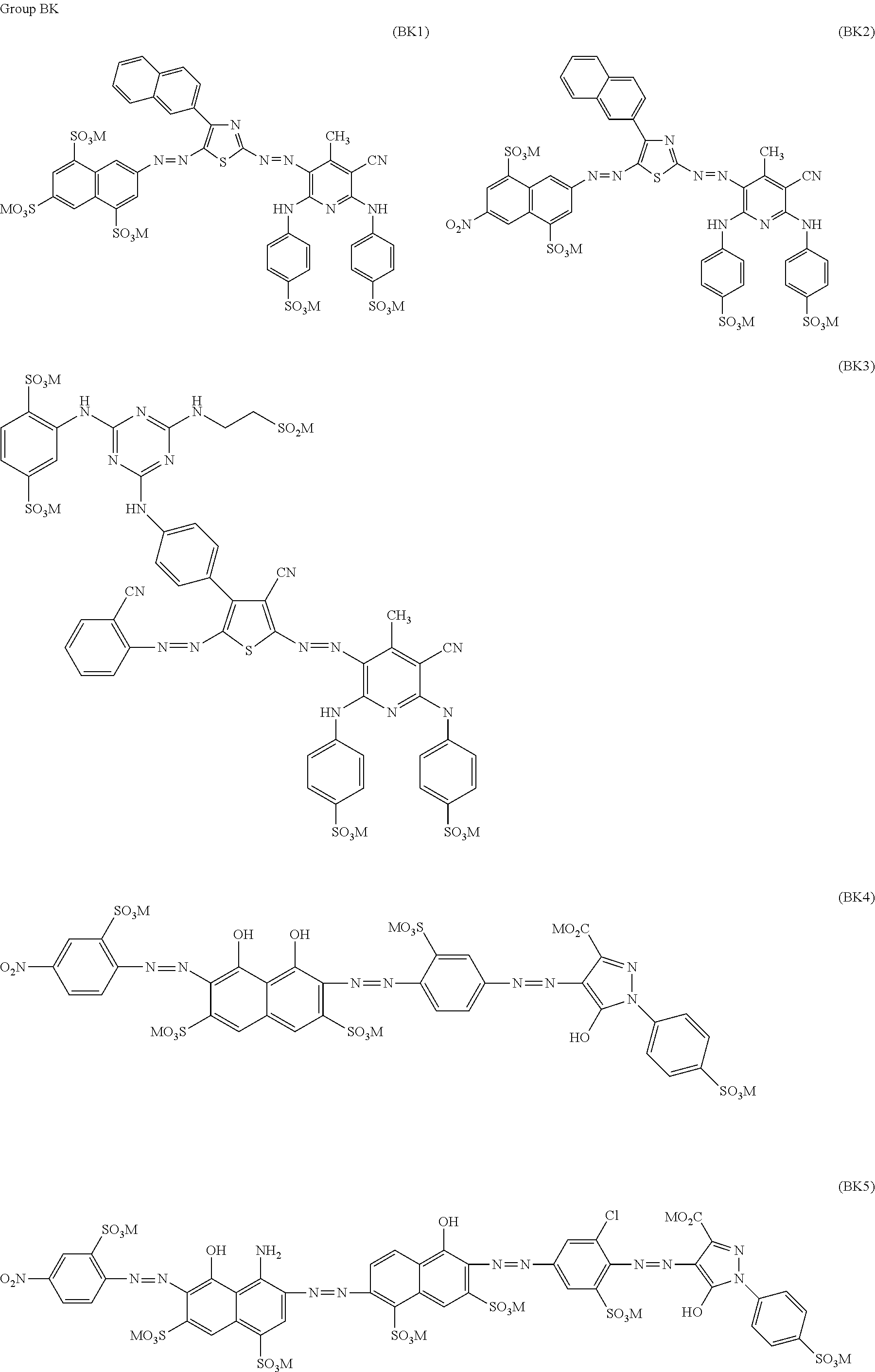 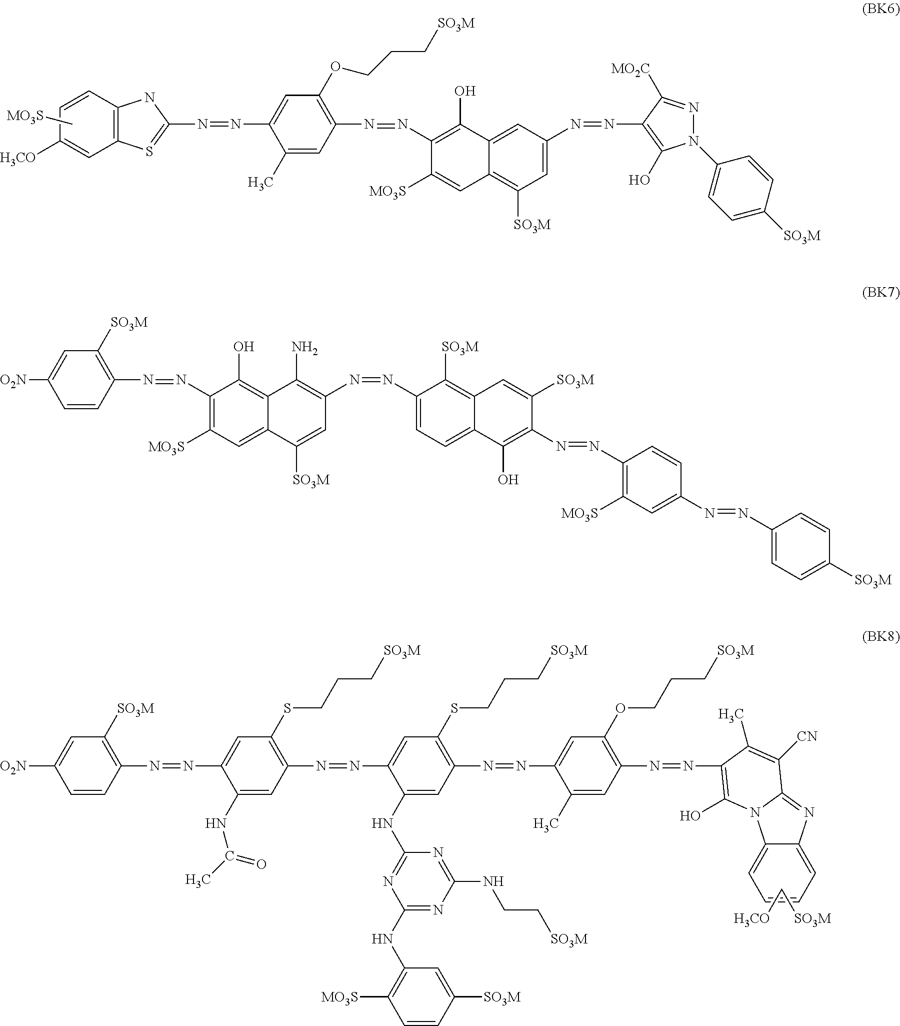 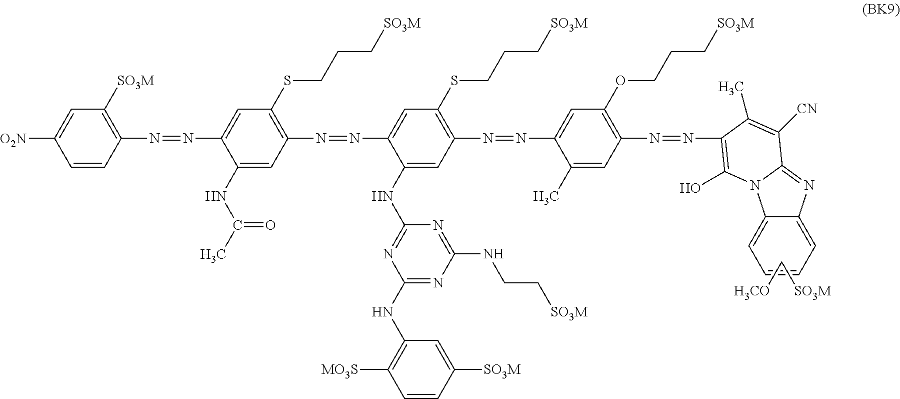
wherein, in the general formulae (BK1) to (BK9), each M independently represents a hydrogen atom, a lithium ion, a sodium ion, a potassium ion, or an ammonium ion.

2. The ink set according to claim 1, wherein a total content of all colorants in the magenta ink composition is 2.3 mass % or more and 4.0 mass % or less with respect to a total mass of the magenta ink composition.

3. The ink set according to claim 1, wherein a total content of all colorants in the cyan ink composition is 3.5 mass % or more and 5.5 mass % or less with respect to a total mass of the cyan ink composition.

4. The ink set according to claim 2, wherein a total content of all colorants in the cyan ink composition is 3.5 mass % or more and 5.5 mass % or less with respect to a total mass of the cyan ink composition.

5. The ink set according to claim 1, wherein a total content of all colorants in the yellow ink composition is 2.5 mass % or more and 4.5 mass % or less with respect to a total mass of the yellow ink composition.

6. The ink set according to claim 2, wherein a total content of all colorants in the yellow ink composition is 2.5 mass % or more and 4.5 mass % or less with respect to a total mass of the yellow ink composition.

7. The ink set according to claim 3, wherein a total content of all colorants in the yellow ink composition is 2.5 mass % or more and 4.5 mass % or less with respect to a total mass of the yellow ink composition.

8. The ink set according to claim 4, wherein a total content of all colorants in the yellow ink composition is 2.5 mass % or more and 4.5 mass % or less with respect to a total mass of the yellow ink composition.

9. The ink set according to claim 1, wherein a total content of all colorants in the black ink composition is 4.0 mass % or more and 6.0 mass % or less with respect to a total mass of the black ink composition.

10. The ink set according to claim 2, wherein a total content of all colorants in the black ink composition is 4.0 mass % or more and 6.0 mass % or less with respect to a total mass of the black ink composition.

11. The ink set according to claim 3, wherein a total content of all colorants in the black ink composition is 4.0 mass % or more and 6.0 mass % or less with respect to a total mass of the black ink composition.

12. The ink set according to claim 4, wherein a total content of all colorants in the black ink composition is 4.0 mass % or more and 6.0 mass % or less with respect to a total mass of the black ink composition.

13. The ink set according to claim 1, wherein a total content of all colorants in the magenta ink composition is 3.0 mass % or more and 4.0 mass % or less with respect to a total mass of the magenta ink composition.

14. The ink set according to claim 2, wherein a total content of all colorants in the magenta ink composition is 3.0 mass % or more and 4.0 mass % or less with respect to a total mass of the magenta ink composition.

15. The ink set according to claim 3, wherein a total content of all colorants in the magenta ink composition is 3.0 mass % or more and 4.0 mass % or less with respect to a total mass of the magenta ink composition.

16. The ink set according to claim 4, wherein a total content of all colorants in the magenta ink composition is 3.0 mass % or more and 4.0 mass % or less with respect to a total mass of the magenta ink composition.

17. An ink cartridge comprising the ink set according to claim 1.

18. An ink jet printer comprising the ink cartridge according to claim 17.

19. An ink jet recording method comprising performing recording by using the ink set according to claim 1.

20. An ink jet recording method comprising performing recording by using the ink cartridge according to claim 17.
